(19) United States
(12) Patent Application Publication
(10) Pub. No.: US 2026/0237402 A1
(43) Pub. Date: Aug. 13, 2026

(54) MAGNETIC RECORDING MEDIUM

(71) Applicant: SONY GROUP CORPORATION, Tokyo (JP)

(72) Inventors: Minoru YAMAGA, Tokyo (JP); Takahiro TAKAYAMA, Tokyo (JP)

(21) Appl. No.: 19/156,540

(22) PCT Filed: Feb. 15, 2024
(86) PCT No.: PCT/JP2024/005181

§ 371 Date: Aug. 14, 2025

(30) Foreign Application Priority Data
Mar. 2, 2023 (JP) 2023-031736

(51) Int. Cl. G11B 5/588; G11B 5/702

(52) U.S. Cl. CPC G11B 5/588; G11B 5/7023

(57) ABSTRACT

An object of the present technology is to provide a magnetic recording medium with enhanced reliability during traveling, the magnetic recording medium being configured to correct its width variations by adjusting the angle of a recording/reproducing head of a drive even in a case of storing or traveling in a high-temperature environment.

The present technology provides a magnetic recording medium including a magnetic layer, an underlayer, and a base layer in this order, in which the underlayer contains a chlorine-containing binder, a portion where a chlorine count is greater than or equal to the following threshold in the underlayer has a thickness of 130 nm or less, and an average width variation of the magnetic recording medium before and after the magnetic recording medium is left for 40 hours in an environment with a temperature of 50° C. and a relative humidity of 40% RH with a tension of 0.55 N applied in a longitudinal direction is less than or equal to 170 ppm.

[Threshhold]=[Average chlorine count in the underlayer]+6×[Standard deviation obtaind in calculating the average chlorine count]

### TECHNICAL FIELD

The present technology relates to a magnetic recording medium.

### BACKGROUND ART

For example, with the advancement of IoT, big data, artificial intelligence, and the like, the amount of data collected and stored is increasing significantly. In many cases, magnetic recording media are used to record a large amount of data.

Various technologies have been proposed for magnetic recording media. For example, the following Patent Document 1 discloses a magnetic recording medium including a magnetic layer with a thickness of 0.3 μm or less provided on one or both surfaces of a non-magnetic support, the magnetic layer containing at least iron atom-containing magnetic powder and a binder, in which, when an average iron element content in an outer layer relative to the center of the magnetic layer is denoted as S(Fe), and an average iron element content in a deep layer relative to the center of the magnetic layer is denoted as D(Fe), S(Fe)/D(Fe)≥1.1 is satisfied.

Furthermore, the following Patent Document 2 discloses a magnetic recording medium including a magnetic layer, the magnetic layer being formed by applying a magnetic coating material containing at least magnetic powder and a binder onto on a non-magnetic support, in which the magnetic layer is designed to have varying constituent elements along its depth, a content ratio of carbon constituting the binder to the constituent elements of the magnetic powder in an outer layer of the magnetic layer is greater than or equal to 90 [vol %], and a content ratio of carbon constituting the binder to the constituent elements of the magnetic powder at a depth of 50 Å or more relative to the surface of the magnetic layer is less than or equal to 70 [vol %].

Moreover, a tape-shaped magnetic recording medium undergoes off-track errors when the dimension in the width direction of the magnetic recording medium significantly varies due to environmental changes, which makes it difficult to ensure stable recording/reproducing characteristics. The following Patent Document 3 proposes that, even if the dimension in the width direction of the tape-shaped magnetic recording medium varies due to environmental changes, the data ride head is arranged at an angle relative to the width direction of the tape-shaped magnetic recording medium.

### CITATION LIST

### Patent Document

Patent Document 1: Japanese Patent Application Laid-Open No. 2002-279619
Patent Document 2: Japanese Patent Application Laid-Open No. 2002-100021
Patent Document 3: Japanese Patent Application Laid-Open No. 2005-259198

### SUMMARY OF THE INVENTION

### Problems to be Solved by the Invention

It is therefore an object of the present technology to provide a magnetic recording medium with enhanced reliability during traveling, the magnetic recording medium being configured to correct its width variations by adjusting the angle of a recording/reproducing head of a drive even in a case of storing or traveling in a high-temperature environment.

### Solutions to Problems

The present technology provides a magnetic recording medium including:
a magnetic layer; an underlayer; and a base layer in this order, in which
the underlayer contains a chlorine-containing binder,
a portion where a chlorine count is greater than or equal to the following threshold in the underlayer has a thickness of 130 nm or less, and
an average width variation of the magnetic recording medium before and after the magnetic recording medium is left for 40 hours in an environment with a temperature of 50° C. and a relative humidity of 40% RH with a tension of 0.55 N applied in a longitudinal direction is less than or equal to 170 ppm.

[Threshold]=[Average chlorine count in the underlayer]+6×[Standard deviation obtained in calculating the average chlorine count]

The portion greater than or equal to the threshold in the underlayer may be located adjacent to the base layer.

The portion greater than or equal to the threshold in the underlayer may be located within 200 nm of an interface between the underlayer and the base layer.

The portion greater than or equal to the threshold in the underlayer may be located within 130 nm of the interface between the underlayer and the base layer.

The magnetic layer and the underlayer may have a combined thickness of 1000 nm or less.

The magnetic layer may have a thickness of 80 nm or less.

The underlayer may contain non-magnetic powder.

The magnetic recording medium may have an average thickness t_{T} of 5.5 μm or less.

The magnetic layer may contain magnetic powder.

The magnetic powder may contain hexagonal ferrite, ε-iron oxide, or Co-containing spinel ferrite.

The present technology further provides a magnetic recording medium including:
a magnetic layer; an underlayer; and a base layer in this order, in which
the underlayer contains a chlorine-containing binder,
a portion where a chlorine count is greater than or equal to the following threshold in the underlayer has a thickness of 12% or less of a thickness of the underlayer, and
an average width variation of the magnetic recording medium before and after the magnetic recording medium is left for 40 hours in an environment with a temperature of 50° C. and a relative humidity of 40% RH with a tension of 0.55 N applied in a longitudinal direction is less than or equal to 170 ppm.

[Threshold]=[Average chlorine count in the underlayer]+6×[Standard deviation obtained in calculating the average chlorine count]

The average width variation may be less than or equal to 140 ppm.

The base layer may contain polyesters.

The polyesters may include at least one selected from the group consisting of polyethylene terephthalate and polyethylene naphthalate.

The base layer may have an average thickness of 4.4 μm or less.

The magnetic layer may have a squareness ratio of 35% or less in the longitudinal direction of the magnetic recording medium.

The magnetic layer may have five or more servo bands.

The magnetic layer may be configured to allow formation of a plurality of data tracks, and each of the data tracks may have a width of 1200 nm or less.

The present technology further provides a magnetic recording cartridge including the magnetic recording medium that is wound around a reel and contained in a case.

### BRIEF DESCRIPTION OF DRAWINGS

FIG. 1 is a cross-sectional view illustrating a configuration of a magnetic recording medium according to a first embodiment.

FIG. 2A is a diagram illustrating an example of a shape of magnetic powder particles.

FIG. 2B shows an example of a cross-sectional transmission electron microscope (TEM) image of a sample.

FIG. 2C shows another example of the cross-sectional TEM image of the sample.

FIG. 3A is a diagram illustrating an example of a high angle annular dark field scanning transmission electron microscopy (HAADF STEM) image.

FIG. 3B is a diagram for describing a Cl Kα line extraction area set in the HAADF STEM image.

FIG. 3C is a diagram illustrating an example of plot data where a net count is plotted against a pixel position in the thickness direction.

FIG. 3D is a diagram for describing the net count, specifically, a diagram for describing an example of a line where Kα lines are counted.

FIG. 3E is a diagram illustrating an example of plot data where a chlorine count after normalization processing is plotted against a position in the thickness direction.

FIG. 4 is a diagram schematically illustrating the magnetic recording medium according to the first embodiment as viewed from above (magnetic layer side).

FIG. 5 is an enlarged view of recording tracks in a data band of the magnetic recording medium.

FIG. 6 is an enlarged view of a part of a servo pattern written in a servo band of the magnetic recording medium.

FIG. 7 is a perspective view of a configuration of a measuring device.

FIG. 8 is a diagram schematically illustrating an example of a configuration of a tape drive device.

FIG. 9 is a diagram schematically illustrating a drive head in the tape drive device as viewed from below (tape traveling surface).

FIG. 10 is a diagram illustrating a state where a first drive head unit in the drive head records/reproduces data signals.

FIG. 11(A) is a schematic plan view illustrating an arrangement example of servo patterns, and FIG. 11(B) is a diagram illustrating reproduced waveforms of the servo patterns.

FIG. 12 is a diagram schematically illustrating configuration examples of a servo pattern (A) in which first servo band identification information is embedded and a servo pattern (B) in which second servo band identification information is embedded.

FIG. 13 is a diagram illustrating a reproduced waveform (A) of a first servo pattern and a reproduced waveform (B) of a second servo pattern.

FIG. 14 is a diagram for describing how a drive head tracks a data band.

FIG. 15 is a diagram for describing a method for measuring a servo trace line.

FIG. 16 is a schematic front view illustrating a servo pattern recording device according to an embodiment of the present technology.

FIG. 17 is a partially enlarged view illustrating a part of the servo pattern recording device.

FIG. 18 is an exploded perspective view illustrating an example of a configuration of a magnetic recording cartridge.

FIG. 19 is an exploded perspective view illustrating an example of a configuration of a modification of the magnetic recording cartridge.

FIG. 20 is a schematic diagram for describing a method for calculating a movement angle of a drive head arranged at an angle.

### MODE FOR CARRYING OUT THE INVENTION

Hereinafter, preferred modes for carrying out the present technology will be described. Note that embodiments described below are representative embodiments of the present technology, and the scope of the present technology is not limited to the embodiments.

The present technology will be described in the following order.
1. Description of present technology
2. First Embodiment
(1) Configuration of magnetic recording medium
(2) Description of each layer
(3) Physical properties
(4) Method for manufacturing magnetic recording medium
(5) Tape drive device
(6) Servo pattern recording device
3. Second Embodiment
(1) Embodiment of magnetic recording cartridge
(2) Modification of magnetic recording cartridge
4. Examples

In the present specification, in a case where a measurement method is described without specifying a measurement environment, the measurement is performed in an environment of 25° C.±2° C. and 50% RH±5% RH.

### 1. DESCRIPTION OF PRESENT TECHNOLOGY

As described above, to manufacture coating-type magnetic recording tape, an underlayer forming coating material is applied onto the base layer to form the underlayer, and then, a magnetic layer forming coating material is applied onto the underlayer to form the magnetic layer. It has been found that the application of the magnetic layer forming coating material makes the distribution of the binder contained in the underlayer uneven in the thickness direction.

It has also been found that the uneven distribution of the binder in the underlayer affects the reliability of the magnetic recording tape. The uneven distribution of the binder makes the ratio between the inorganic material and the binder in the underlayer non-uniform in the thickness direction. Depending on the state of the uneven distribution, the reliability of the magnetic recording tape deteriorates, and for example, the likelihood that defects requiring Rewrite occur during recording processing increases.

The present inventors has found that the reliability of the magnetic recording tape can be enhanced by controlling the distribution of the binder in the underlayer.

That is, the magnetic recording medium of the present technology includes a magnetic layer, an underlayer, and a base layer in this order. The underlayer contains a chlorine-containing binder, and the underlayer has a portion where a chlorine count is greater than or equal to the following threshold.

$$[ Threshold ] = [ Average chlorine count in the underlayer ] + 6 \times [ Standard deviation obtained in calculating the average chlorine count ]$$

The chlorine count corresponds to the amount of the chlorine-containing binder. The portion greater than or equal to the threshold has a higher chlorine count than the other portions of the underlayer, that is, contains more chlorine-containing binder than the other portions. That is, in the portion greater than or equal to the threshold, the chlorine-containing binder is unevenly distributed.

In the magnetic recording medium of the present technology, the width in the thickness direction of the portion greater than or equal to the threshold, that is, the uneven distribution width, is controlled. This enhances the reliability of the magnetic recording medium, specifically, the reliability during traveling for recording processing.

In an embodiment of the present technology, the thickness of the portion where the chlorine count is greater than or equal to the following threshold in the underly layer may be, for example, 130 nm or less, preferably 125 nm or less, and more preferably 120 nm or less, 115 nm or less, 110 nm or less, 105 nm or less, 100 nm or less, 95 nm or less, or 90 nm or less. The thickness of the portion greater than or equal to the threshold refers to a length of the portion greater than or equal to the threshold in the thickness direction of the magnetic recording medium.

Furthermore, the thickness of the portion may be, for example, 30 nm or more, 40 nm or more, or 50 nm or more.

By maintaining the thickness of the portion greater than or equal to the threshold within the above numerical range, that is, by ensuring that the uneven distribution width is as small as described above, the reliability of the magnetic recording medium can be enhanced. For example, the occurrence of Rewrite during recording processing can be prevented.

In another embodiment of the present technology, the thickness of the portion where the chlorine count is greater than or equal to the threshold in the underlayer may be, for example, 12% or less, preferably 11% or less, more preferably 10% or less, or 9% or less of the thickness of the underlayer. In this embodiment as well, the thickness of the portion greater than or equal to the threshold refers to a length of the portion greater than or equal to the threshold in the thickness direction of the magnetic recording medium.

Furthermore, the thickness of the portion may be, for example, 4% or more or 5% or more.

By maintaining the thickness of the portion greater than or equal to the threshold within the above numerical range, that is, by ensuring that the uneven distribution width is as small as described above, the reliability of the magnetic recording medium can be enhanced. For example, the occurrence of Rewrite during recording processing can be prevented.

The portion greater than or equal to the threshold in the underlayer is preferably located adjacent to the base layer. For example, in a case where the underlayer is divided into a magnetic layer side region and a base layer side region in the thickness direction of the magnetic recording medium, the portion greater than or equal to the threshold may be located in the base layer side region.

More preferably, the portion greater than or equal to the threshold in the underlayer may be located within 200 nm, preferably within 150 nm, and particularly preferably within 130 nm, 120 nm, 110 nm, or 100 nm of the interface between the underlayer and the base layer. In a particularly preferred embodiment, the portion greater than or equal to the threshold may be located in contact with the interface between the underlayer and the base layer.

Controlling the position of the portion greater than or equal to the threshold, that is, the position of the portion where the chlorine-containing binder is unevenly distributed as described above also contributes to enhancing the reliability of the magnetic recording medium.

In the underlayer, some of the chlorine-containing binder is adsorbed onto the inorganic material contained in the underlayer, while some exists without being adsorbed onto the inorganic material. It is considered that the uneven distribution of the chlorine-containing binder described above is mainly caused by the chlorine-containing binder that is not adsorbed onto the inorganic material. It is considered that the reliability of the magnetic recording medium can be enhanced by controlling the uneven distribution of the chlorine-containing binder. This will be described in more detail below.

When the magnetic layer forming coating material is applied, a solvent in the coating material affects the distribution state of the binder contained in the already formed underlayer, and particularly affects the distribution state of the binder existing without being adsorbed onto the inorganic material.

Depending on the uneven distribution state of the binder, the likelihood of powder shedding in the early stage of the magnetic recording medium usage increases, which may reduce the reliability of the magnetic recording medium. For example, the reliability of the magnetic recording tape may be adversely affected in a case where magnetic recording tape with multiple windings is made to travel for a single round trip or in a case where full-scale recording is performed on the magnetic recording tape with multiple windings.

The reliability of the magnetic recording medium can be enhanced by narrowing the width of the uneven distribution of the chlorine-containing binder according to the present technology, particularly, by narrowing the width of the uneven distribution of the chlorine-containing binder and causing the uneven distribution of the chlorine-containing binder to be located adjacent to the base layer. For example, it is possible to reduce the likelihood that defects requiring Rewrite occur during the recording processing.

It is considered that the enhancement of reliability results from the uneven distribution control by which a lubricant contained in the underlayer is appropriately supplied to the surface of the magnetic recording medium. As described above, the uneven distribution is caused by the chlorine-containing binder that is not adsorbed onto the inorganic material. The chlorine-containing binder that is not adsorbed onto the inorganic material blocks pores through which the lubricant is supplied to the surface, which may obstruct the supply of the lubricant to the surface of the magnetic recording medium.

It is considered that, by further reducing the width of the uneven distribution to narrow a range where the chlorine-containing binder that is not adsorbed onto the inorganic material is located, the lubricant can be appropriately supplied to the surface of the magnetic recording medium.

Furthermore, by reducing the width of the uneven distribution and causing the uneven distribution to be located in the base layer, it is possible to more effectively prevent the obstruction of lubricant supply caused by the blockage of pores by the chlorine-containing binder.

Furthermore, in a case where the amount of the chlorine-containing binder unevenly distributed on the base side is small, a certain amount of the chlorine-containing binder that is not adsorbed onto the inorganic material may also be located on the interface side between the magnetic layer and the underlayer. In this case as well, the likelihood that the pores are blocked by the chlorine-containing binder that is not adsorbed onto the inorganic material increases. Therefore, the thickness of the portion is preferably 1/25 or more, more preferably 1/20 or more of the thickness of the underlayer.

By controlling the uneven distribution state of the chlorine-containing binder to prevent excess chlorine-containing binder from remaining on the magnetic layer side, the reliability can be increased. However, the present inventors have found that, in a case of storing or traveling in a high-temperature environment, excessive creep deformation occurs, and the excessive creep deformation causes the width variation of the magnetic recording medium to exceed a range that can be corrected through the adjustment of the angle of the recording/reproducing head of the drive, which makes the correction of the width variation difficult and tends to cause an emerging problem due to the inability to ensure traveling reliability. It has been found that, to solve this problem, it is important to reduce the creep deformation of the magnetic recording medium while adjusting the flow of the chlorine-containing binder.

The present inventors have conducted a study on a technology to reduce the creep deformation of the magnetic recording medium. As a result, the present inventors have found that, by adjusting the average width variation of the magnetic recording medium to remain below a specific numerical range, creep deformation of the magnetic recording medium caused when the magnetic recording medium wound into a cartridge has been stored in a high-temperature environment for a long period of time and creep deformation of the magnetic recording medium caused when the magnetic recording medium has traveled in the high-temperature environment for a long period of time can be reduced. This allows the width variation of the magnetic recording medium wound into the cartridge that has been stored in the high-temperature environment for a long period of time and the width variation of the magnetic recording medium that has traveled in the high-temperature environment for a long period of time to remain within the range that can be corrected through the adjustment of the angle of the recording/reproducing head of the drive.

The average width variation of the magnetic recording medium according to the present technology before and after the magnetic recording medium is left for 40 hours in an environment with a temperature of 50° C. and a relative humidity of 40% RH with a tension of 0.55 N applied in the longitudinal direction is 170 ppm or less, preferably 140 ppm or less, more preferably 70 ppm or less, and still more preferably 30 ppm or less. When the average width variation ΔA of the magnetic recording medium exceeds 170 ppm, the creep deformation of the magnetic recording medium caused when the magnetic recording medium wound into the cartridge has been stored in the high-temperature environment for a long period of time and the creep deformation of the magnetic recording medium caused when the magnetic recording medium has traveled in the high-temperature environment for a long period of time increase. As a result, the width variation of the magnetic recording medium wound into the cartridge that has been stored in the high-temperature environment for a long period of time and the width variation of the magnetic recording medium that has traveled in the high-temperature environment for a long period of time exceed the range that can be corrected through the adjustment of the angle of the recording/reproducing head of the drive. Therefore, it is difficult to correct the width variation through the adjustment of the angle of the recording/reproducing head of the drive. Note that, in the present specification, the high-temperature environment refer to an environment with a temperate ranging from 35° C. to 50° C.

A known magnetic recording medium undergoes excessive deformation due to creep characteristics in high-temperature environments. Therefore, it is difficult to correct the width variation of the magnetic recording medium through the adjustment of the angle of the recording/reproducing head of the drive. On the other hand, since the magnetic recording medium according to the present technology has the average width variation ΔA of 170 ppm or less, not only the deformation of the magnetic recording medium due to environmental factors but also the creep deformation in the high-temperature environment can be reduced. Therefore, it is possible to correct the width variation of the magnetic recording medium through the adjustment of the angle of the recording/reproducing head of the drive.

The average width variation ΔA may be set to a desired value by selecting at least one of the base layer or the underlayer. For example, the average width variation ΔA may be set to the desired value by selecting at least one of the thickness of the base layer or the material of the base layer. Furthermore, the average width variation ΔA may be set to the desired value by adjusting the elongation strength in the width direction and longitudinal direction of the base layer. Furthermore, the average width variation ΔA may be set to the desired value by selecting the type of the magnetic layer from a coated film and a sputtered film.

Furthermore, the average width variation ΔA may be set to the desired value by adjusting an environmental temperature and a storage time (for example, storage in an environment with a temperature of 65° C. for 48 hours) in a strain relief process provided after a calendering process and before a cutting process. Furthermore, the average width variation ΔA may be set to the desired value by adjusting an environmental temperature and a storage time (for example, storage in an environment with a temperature of 55° C. for 48 hours) in the strain relief process provided after a demagnetizing process and before a servo pattern writing process.

Note that the average width variation ΔA may be set to the desired value by selecting one, two, or more from the plurality of options described above. A method for measuring the average width variation ΔA will be described in the following 2.(3).

The magnetic recording medium according to the present technology may conform to the linear tape-open (LTO) standard, or may conform to a standard different from the LTO standard. The width of the magnetic recording medium may be ½ inch, or may be wider than ½ inch. In a case where the magnetic recording medium conforms to the LTO standard, the width of the magnetic recording medium is 7 and ½ inch. The magnetic recording medium may be configured to keep its width constant or approximately constant by adjusting the angle of the recording/reproducing head of the drive during traveling.

The magnetic recording medium according to the present technology may be preferably an elongated magnetic recording medium, and may be, for example, a magnetic recording tape (particularly, an elongated magnetic recording tape). The magnetic recording medium is preferably used in a recording/reproducing device provided with a ring-type head as a recording head. The magnetic recording medium is preferably used in a recording/reproducing device configured to be able to record data with a data track width of 1100 nm or less or 900 nm or less.

The magnetic recording medium according to the present technology may include a magnetic layer, a non-magnetic layer (underlayer), a base layer, and a back layer in this order, and may include a different layer in addition to these layers. The different layer may be appropriately selected according to the type of the magnetic recording medium. The magnetic recording medium may be a coating-type magnetic recording medium, that is, a magnetic recording medium manufactured by applying materials (particularly, coating materials) for forming the other layers to the base layer and drying the materials.

For example, an average thickness (average total thickness) t_{T} of the magnetic recording medium according to the present technology may be preferably 5.5 μm or less, more preferably 5.4 μm or less, still more preferably 5.3 μm or less, 5.2 μm or less, 5.1 μm or less, 5.0 μm or less, 4.9 μm or less, or 4.8 μm or less, and still more preferably 4.6 μm or less or 4.4 μm or less. Since the magnetic recording medium is thin as described above, the length of tape wound into a single magnetic recording cartridge can be made longer, enabling an increase in the recording capacity for each magnetic recording cartridge, for example. The lower limit of the average thickness (average total thickness) t_{T} of the magnetic recording medium is not particularly limited, and is, for example, 3.5 μm t_{T}. A method for measuring the average thickness of the magnetic recording medium will be described in the following 2.(3).

An average thickness tₘ of the magnetic layer of the magnetic recording medium according to the present technology may be preferably 80 nm or less, more preferably 70 nm or less, still more preferably 60 nm or less, 50 nm or less, and still more preferably 40 nm or less. The lower limit of the average thickness tₘ of the magnetic layer is not particularly limited, and is preferably 30 nm or more. A method for measuring the average thickness of the magnetic layer will be described in the following 2.(3).

An average thickness of the underlayer (also referred to as a non-magnetic layer) of the magnetic recording medium according to the present technology may be preferably 1200 nm or less, preferably 1150 nm or less, 1120 nm or less, 1100 nm or less, more preferably 1000 nm or less, 900 nm or less, or 800 nm or less, or 700 nm or less, and still more preferably 600 nm or less. Furthermore, the lower limit of the average thickness of the underlayer is not particularly limited, and is preferably 200 nm or more, and more preferably 300 nm or more. A method for measuring the average thickness of the underlayer will be described in the following 2.(3).

An average thickness of the base layer (also referred to as a substrate layer) of the magnetic recording medium according to the present technology may be preferably 4.5 μm or less, more preferably 4.2 μm or less, 4.0 μm or less, 3.8 μm or less, or 3.6 μm or less, and still more preferably 3.4 μm or less, 3.2 μm or less, or 3.0 μm or less. Furthermore, the lower limit of the average thickness of the base layer is not particularly limited, and is preferably 2.0 μm or more, 2.2 μm or more, 2.4 μm or more, and more preferably 2.5 μm or more, for example. A method for measuring the average thickness of the base layer will be described in the following 2.(3).

An average thickness of the back layer of the magnetic recording medium according to the present technology may be preferably 0.6 μm or less, more preferably 0.5 μm or less, and still more preferably 0.4 μm or less, 0.3 μm or less, 0.25 μm or less, or 0.2 μm or less. Furthermore, the lower limit of the average thickness of the back layer is not particularly limited, and is preferably 0.1 μm or more, and more preferably 0.15 μm or more, for example. A method for measuring the average thickness of the back layer will be described in the following 2.(3).

The total thickness of the magnetic layer and the underlayer of the magnetic recording medium according to the present technology is preferably 1200 nm or less, and may be 1100 nm or less, 1000 nm or less, or 900 nm or less, for example. Furthermore, the total may be, for example, 300 nm or more, particularly 400 nm or more.

### 2. FIRST EMBODIMENT

### (1) Configuration of Magnetic Recording Medium

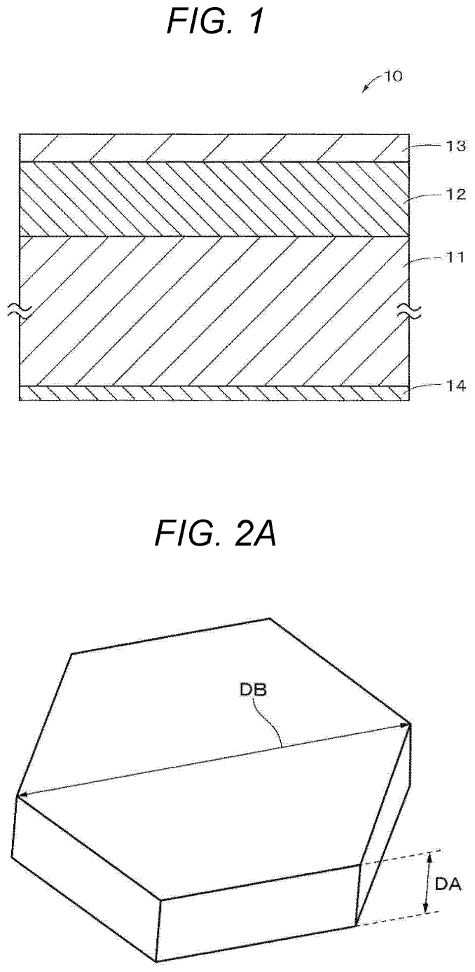

Hereinafter, an example of a configuration of a magnetic recording medium 10 according to the first embodiment will be described with reference to FIG. 1. The magnetic recording medium 10 is, for example, a magnetic recording medium subjected to vertical orientation treatment. As illustrated in FIG. 1, the magnetic recording medium 10 includes an elongated base layer (also referred to as a substrate) 11, an underlayer 12 provided on one of the primary surfaces of the base layer 11, a magnetic layer (also referred to as a recording layer) 13 provided on the underlayer 12, and a back layer 14 provided on the other primary surface of the base layer 11. Hereinafter, of both the primary surfaces of the magnetic recording medium 10, a surface where the magnetic layer 13 is provided is referred to as a magnetic surface, and a surface opposite to the magnetic surface (surface where the back layer 14 is provided) is referred to as a back surface.

The magnetic recording medium 10 has an elongated shape and is made to travel in the longitudinal direction during recording/reproducing. Furthermore, the magnetic recording medium 10 may be configured to be able to record signals at the shortest recording wavelength of preferably 60 nm or less, more preferably 50 nm or less, still more preferably 45 nm or less, and particularly preferably 40 nm or less, and may be used, for example, in a recording/reproducing device having the shortest recording wavelength within the above range.

### (2) Description of Each Layer

### (Base Layer)

The base layer 11 may act as a support of the magnetic recording medium 10, and may be, for example, an elongated, flexible, non-magnetic substrate, particularly, a non-magnetic film. The base layer 11 may contain, for example, at least one of polyester-based resin, polyolefin-based resin, a cellulose derivative, vinyl-based resin, aromatic polyether ketone resin, or different polymer resin. In a case where the base layer 11 contains two or more of these materials, the two or more materials may be mixed, copolymerized, or laminated.

The polyester-based resin contains, for example, at least one selected from the group consisting of polyethylene terephthalate (PET), polyethylene naphthalate (PEN), polybutylene terephthalate (PBT), polybutylene naphthalate (PBN), polycyclohexylene dimethylene terephthalate (PCT), polyethylene p-oxybenzoate (PEB), and polyethylene bisphenoxycarboxylate. According to a preferred embodiment of the present technology, the base layer 11 may include PET or PEN.

The polyolefin-based resin may be, for example, a mixture of one or more of polyethylene (PE) and polypropylene (PP).

The cellulose derivative may be, for example, a mixture of one or more of cellulose diacetate, cellulose triacetate, cellulose acetate butyrate (CAB), and cellulose acetate propionate (CAP).

The vinyl-based resin may be, for example, a mixture of one or more of polyvinyl chloride (PVC) and polyvinylidene chloride (PVDC).

The aromatic polyether ketone resin may be, for example, a mixture of one or more of polyether ketone (PEK), polyether ether ketone (PEEK), polyether ketone ketone (PEKK), and polyether ether ketone ketone (PEEKK). According to a preferred embodiment of the present technology, the base layer 11 may include PEEK.

The different polymer resin may be, for example, a mixture of one or more of polyamide, nylon (PA), aromatic polyamide, aramid (aromatic PA), polyimide (PI), aromatic polyimide (aromatic PI), polyamide-imide (PAI), aromatic polyamide-imide (aromatic PAI), polybenzoxazole (PBO), e.g., Zylon (registered trademark), polyether, polyether-ester, polyethersulfone (PES), polyetherimide (PEI), polysulfone (PSF), polyphenylene sulfide (PPS), polycarbonate (PC), polyarylate (PAR), and polyurethane (PU).

The base layer may include chlorine-free resin, particularly chlorine-free polyester-based resin. Note that the base layer may include chlorine-containing resin.

### (Magnetic Layer)

The magnetic layer 13 may be, for example, a vertical recording layer. The magnetic layer 13 contains magnetic powder. The magnetic layer 13 may further contain a binder. The magnetic layer 13 may further contain non-magnetic particles. The magnetic layer 13 may further contain additives such as a lubricant and a rust inhibitor as necessary.

The magnetic layer 13 is preferably a magnetic layer with vertical orientation. In the present specification, the vertical orientation is defined as a state in which a squareness ratio Si measured in the longitudinal direction (traveling direction) of the magnetic recording medium 10 is 35% or less.

### (Magnetic Powder)

Examples of magnetic particles constituting the magnetic powder contained in the magnetic layer 13 include hexagonal ferrite, epsilon-type iron oxide (s-iron oxide), Co-containing spinel ferrite, gamma hematite, magnetite, chromium dioxide, cobalt-coated iron oxide, metal, and the like, but are not limited to these. The magnetic powder may be one of these, or may be a combination of two or more of these. Preferably, the magnetic powder may contain hexagonal ferrite, ε-iron oxide, or Co-containing spinel ferrite. Particularly preferably, the magnetic powder is hexagonal ferrite. The hexagonal ferrite may particularly preferably contain at least one of Ba or Sr. The ε-iron oxide may particularly preferably contain at least one of Al or Ga. These magnetic particles may be appropriately selected by those skilled in the art on the basis of factors such as the method for manufacturing the magnetic layer 13, the tape standard, and the tape function.

The shape of the magnetic particles depends on their crystal structure. For example, barium ferrite (BaFe) and strontium ferrite may have a hexagonal plate shape. ε-iron oxide may have a spherical shape. Cobalt ferrite may have a cubic shape. Metal may have a spindle shape. These magnetic particles are oriented during the manufacturing process of the magnetic recording medium 10.

(Embodiment in which Magnetic Powder Contains Hexagonal Ferrite)

Hexagonal ferrite particles contain Fe and metal M1 other than Fe. The metal M1 contains alkaline earth metal. The alkaline earth metal may contain at least one or more of Sr, Ba, or Ca, and preferably contain Sr among these metals. The metal M1 may contain Pb in addition to the alkaline earth metal.

The hexagonal ferrite particles may further contain metal M2 in addition to Fe and the metal M1. The metal M2 contains, for example, at least one selected from the group consisting of rare-earth elements, transition metal elements other than Fe, and Group 13 metal elements of the periodic table, and among these, at least one selected from the group consisting of Ti, Al, and Nd is preferable.

Specifically, the hexagonal ferrite particles may be, for example, barium ferrite particles or strontium ferrite particles. In the present disclosure, the strontium ferrite particles refer to hexagonal ferrite particles having an atomic ratio of Sr to the metal M1 of 50 atomic % or more. Therefore, the hexagonal ferrite particles containing Sr and the metal M1 other than Sr are contained in the strontium ferrite particles in a case where the atomic ratio of Sr to the metal M1 is 50 atomic % or more. For example, in a case where the metal M1 contains Sr and Ba, hexagonal ferrite particles having an atomic ratio of Sr to the total amount of Sr and Ba of 50 atomic % or more refer to strontium ferrite particles.

More specifically, the hexagonal ferrite may have an average composition represented by the following general formula (1):

$${Sr}_{( 1 - x )} {α}_{x} F {e}_{( 12 - y )} {β}_{y} {O}_{19} \qquad ( 1 )$$

where α represents at least one selected from the group consisting of Ba, Ca, and Pb, β represents at least one selected from the group consisting of rare-earth elements, transition metal elements other than Fe, and Group 13 metal elements of the periodic table, x is within a range of 0≤x≤0.9, preferably 0≤x≤0.7, and still more preferably 0.3≤x≤0.7, and y represents 0≤y≤0.80, preferably 0.22≤y≤0.80, and more preferably 0.26≤y≤0.80.

In a case where the magnetic powder contains powder of hexagonal ferrite particles, the average particle size of the magnetic powder may be preferably 30 nm or less, more preferably 25 nm or less, and still more preferably 20 nm or less, 18 nm or less, 16 nm or less, 14 nm or less, or 12 nm or less. The average particle size may be, for example, 8 nm or more, preferably 9 nm or more, and more preferably 10 nm or more. For example, the average particle size of the magnetic powder may be 8 nm or more and 30 nm or less, 8 nm or more and 25 nm or less, 9 nm or more and 20 nm or less, 9 nm or more and 16 nm or less, or 9 nm or more and 14 nm or less. In a case where the average particle size of the magnetic powder is less than or equal to the above-described upper limit (for example, less than or equal to 30 nm, particularly less than or equal to 20 nm), the magnetic recording medium 10 with high recording density achieves excellent electromagnetic conversion characteristics (for example, SNR). In a case where the average particle size of the magnetic powder is greater than or equal to the above-described lower limit (for example, greater than or equal to 8 nm, preferably greater than or equal to 9 nm), the dispersibility of the magnetic powder is further improved, and better electromagnetic conversion characteristics (for example, SNR) are achieved.

In a case where the magnetic powder contains the powder of hexagonal ferrite particles, the average aspect ratio of the magnetic powder is preferably 1.0 or more and 3.0 or less, more preferably 1.0 or more and 2.8 or less, and still more preferably 1.5 or more and 2.5 or less. By maintaining the average aspect ratio of the magnetic powder within the above-described numerical range, the aggregation of the magnetic powder can be suppressed, and moreover, the resistance applied to the magnetic powder when the magnetic powder is vertically oriented during the process of forming the magnetic layer 13 can be reduced. This may lead to an improvement in the vertical orientation of the magnetic powder.

In a case where the magnetic power contains hexagonal ferrite particle powder, the average particle size and average aspect ratio of the magnetic powder are obtained as follows. First, a magnetic recording medium (hereinafter, also referred to as “magnetic tape”) contained in a magnetic recording cartridge is unwound, and approximately 50 mm of magnetic tape to be measured is cut out. For example, in a case of a magnetic recording cartridge 10A as illustrated in FIG. 18, the cutting position may be located 30 m in the longitudinal direction from a connection portion 221 between magnetic tape T and leader tape LT. Subsequently, the magnetic tape to be measured is thin-sectioned using the focused ion beam (FIB) method or the like. In a case of using the FIB method, as pre-treatment for observing a cross-sectional TEM image to be described below, a carbon layer and a tungsten layer are formed as protective films. The carbon layer is formed on the surfaces of the magnetic tape on the magnetic layer side and on the back layer side by vapor deposition, and then, the tungsten layer is further formed on the surface on the magnetic layer side by vapor deposition or sputtering. The thin sectioning is performed in the length direction (longitudinal direction) of the magnetic tape. That is, the thin sectioning forms a cross section parallel to both the longitudinal direction and thickness direction of the magnetic tape.

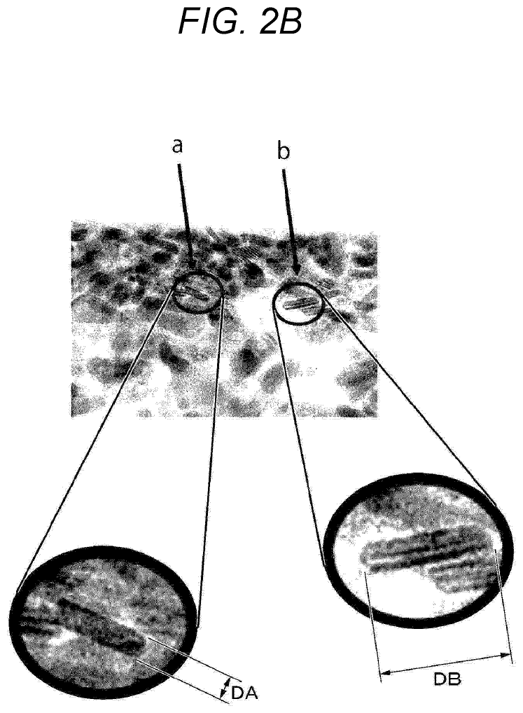

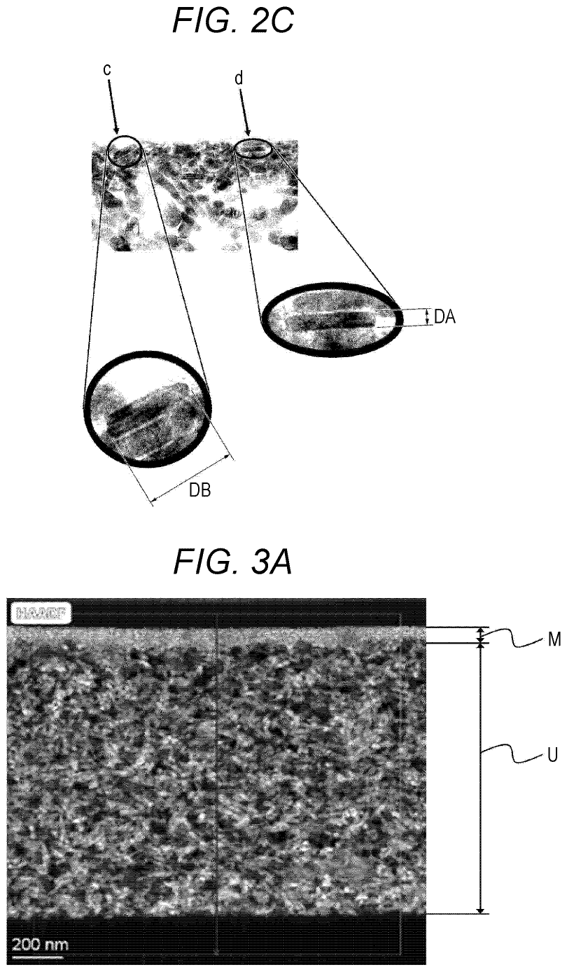

Using a transmission electron microscope (H-9500 manufactured by Hitachi High-Technologies Corporation), the cross section of the obtained thin-sectioned sample is observed at an acceleration voltage of 200 kV and a total magnification of 500,000 times such that the entire magnetic layer is included in the thickness direction of the magnetic layer, and a TEM image is captured. The TEM image is prepared in sufficient quantity to allow the extraction of 50 particles whose plate diameter DB and plate thickness DA (see FIG. 2A) can be measured as described below.

In the present specification, as for the size of the hexagonal ferrite particles (hereinafter, referred to as “particle size”), in a case where the particles observed in the TEM image described above have a plate shape or a columnar shape (however, the thickness or height is smaller than the major diameter of the plate surface or the bottom surface) as illustrated in FIG. 2A, the major diameter of the plate surface or the bottom surface is defined as the value of the plate diameter DB. The thickness or height of the particles observed in the TEM image described above is defined as the value of the plate thickness DA. In a case where the plate surface or bottom surface of the particles observed in the TEM image has a hexagonal shape, the major diameter refers to the longest diagonal distance. In a case where the thickness or height of a single particle is not uniform, the maximum thickness or height of the particle is defined as the plate thickness DA.

Next, 50 particles extracted from the captured TEM image are selected on the basis of the following criteria. A particle that is partially outside the field of view of the TEM image is not measured, and a particle that is well-defined and isolated is measured. In a case where particles overlap with each other, particles with clear boundaries and discernible overall shapes are each measured as a single particle, but particles with unclear boundaries and indiscernible overall shapes are not measured due to inability to determine their shapes.

FIGS. 2B and 2C show an example of the TEM image. In these drawings, for example, the particles indicated by arrows a and d are selected because their plate thicknesses (thicknesses or heights) DA are clearly visible. The plate thickness DA of each of the selected 50 particles is measured. The average (arithmetic mean) of the plate thicknesses DA thus obtained is simply calculated to obtain an average plate thickness DAₐᵥₑ. The average plate thickness DAₐᵥₑ is an average particle plate thickness. Subsequently, the plate diameter DB of each magnetic powder is measured. In order to measure the plate diameter DB of the particles, 50 particles whose plate diameters DB are clearly visible are selected from the captured TEM image. For example, in these drawings, for example, the particles indicated by arrows b and c are selected because their plate diameters DB are clearly visible. The plate diameter DB of each of the selected 50 particles is measured. The average (arithmetic mean) of the plate diameters DB thus obtained is simply calculated to obtain an average plate diameter DBₐᵥₑ. The average plate diameter DBₐᵥₑ is an average particle size.

In a case where the magnetic powder contains the powder of hexagonal ferrite particles, the average particle volume of the magnetic powder is preferably 1800 nm³ or less, more preferably 1600 nm³ or less, more preferably 1400 nm³ or less, and still more preferably 1200 nm³ or less, 1000 nm³ or less, or 900 nm³ or less. The average particle volume of the magnetic powder may be preferably 500 nm³ or more, and more preferably 700 nm³ or more.

In a case where the average particle volume of the magnetic powder is less than or equal to the above-described upper limit (for example, less than or equal to 2000 nm³), the magnetic recording medium 10 with high recording density achieves excellent electromagnetic conversion characteristics (for example, SNR). In a case where the average particle volume of the magnetic powder is greater than or equal to the above-described lower limit (for example, greater than or equal to 500 nm³), the dispersibility of the magnetic powder is further improved, and better electromagnetic conversion characteristics (for example, SNR) are achieved.

The average particle volume of the magnetic powder is obtained as follows. First, as described above regarding the method for calculating the average particle size of the magnetic powder, the average plate thickness DAₐᵥₑ and the average plate diameter DBₐᵥₑ are obtained. Next, the average particle volume V of the magnetic powder is obtained by the following equation.

$$V = \frac{3 \sqrt{3}}{8} \times {DA}_{ave} \times {DB}_{ave} \times {DB}_{ave} \qquad [ Math . 1 ]$$

Furthermore, coercive force Hc1 measured in the thickness direction (vertical direction) of the magnetic recording medium 10 is preferably 2010 [Oe] or more and 3520 [Oe] or less, more preferably 2070 [Oe] or more and 3460 [Oe] or less, and still more preferably 2140 [Oe] or more and 3390 [Oe] or less.

(Embodiment in which Magnetic Powder Contains ε-Iron Oxide)

According to another preferred embodiment of the present technology, the magnetic powder may preferably contain powder of nanoparticles containing ε-iron oxide (hereinafter, referred to as “ε-iron oxide particles”). The ε-iron oxide particles can exhibit high coercive force even with fine particles. It is preferable that the ε-iron oxide contained in the ε-iron oxide particles be preferentially crystal-oriented in the thickness direction (vertical direction) of the magnetic recording medium 10.

The ε-iron oxide particles may have a structure of composite particles. More specifically, the ε-iron oxide particles include an ε-iron oxide portion and a portion having soft magnetism or a portion exhibiting higher saturation magnetization as and lower coercive force Hc than the ε-iron oxide (hereinafter, referred to as a “portion having soft magnetism or the like”).

The ε-iron oxide portion contains ε-iron oxide. The ε-iron oxide contained in the ε-iron oxide portion preferably contains ε-Fe₂O₃ crystals as its primary phase, and more preferably contains single-phase ε-Fe₂O₃.

The portion having soft magnetism or the like is in contact with at least a part of the ε-iron oxide portion. Specifically, the portion having soft magnetism or the like may partially cover the ε-iron oxide portion, or may cover the entire ε-iron oxide portion.

The portion having soft magnetism (portion exhibiting higher saturation magnetization σs and lower coercive force Hc than the ε-iron oxide) contains, for example, a soft magnetic material such as α-Fe, a Ni—Fe alloy, or an Fe—Si—Al alloy. α-Fe may be obtained by reducing the ε-iron oxide contained in the ε-iron oxide portion.

Furthermore, the portion having soft magnetism may contain, for example, Fe₃O₄, γ-Fe₂O₃, spinel ferrite, or the like.

Since the ε-iron oxide particle includes the portion having soft magnetism or the like described above, the coercive force Hc of the entire ε-iron oxide particles (composite particles) can be adjusted to a coercive force Hc suitable for recording while maintaining the coercive force Hc of the ε-iron oxide portion alone at a large value in order to ensure thermal stability.

The ε-iron oxide particles may contain an additive instead of the structure of the composite particles described above, or may have the structure of the composite particles and contain an additive as well. In this case, a part of Fe of the ε-iron oxide particles is replaced with an additive. Since the coercive force Hc of the entire ε-iron oxide particles can be adjusted to the coercive force Hc suitable for recording also when the ε-iron oxide particle contains the additive, the ease of recording can be improved. The additive is a metal element other than iron, preferably a trivalent metal element, more preferably at least one type selected from the group consisting of Al, Ga, and In, and still more preferably at least one type selected from the group consisting of Al and Ga.

Specifically, the ε-iron oxide containing the additive is an ε-Fe₂₋ₓMₓO₃ crystal (where M represents a metal element other than iron, preferably a trivalent metal element, more preferably at least one type selected from the group consisting of Al, Ga, and In, and still more preferably at least one type selected from the group consisting of Al, Ga, and In, and x is, for example, 0<x<1).

The average particle size (average maximum particle size) of the magnetic powder is preferably 22 nm or less, more preferably 8 nm or more and 22 nm or less, and still more preferably 12 nm or more and 22 nm or less. In the magnetic recording medium 10, a region having a size of ½ of a recording wavelength is an actual magnetization region. Therefore, an excellent SNR can be obtained by setting the average particle size of the magnetic powder to half or less of the shortest recording wavelength. Accordingly, when the average particle size of the magnetic powder is 22 nm or less, in the magnetic recording medium 10 with high recording density (for example, the magnetic recording medium 10 configured to be able to record signals at the shortest recording wavelength of 44 nm or less), excellent electromagnetic conversion characteristics (for example, SNR) are achieved. On the other hand, when the average particle size of the magnetic powder is 8 nm or more, the dispersibility of the magnetic powder is further improved, and better electromagnetic conversion characteristics (for example, SNR) are achieved.

The average aspect ratio of the magnetic powder is preferably 1.0 or more and 3.0 or less, more preferably 1.0 or more and 2.9 or less, and still more preferably 1.0 or more and 2.5 or less. When the average aspect ratio of the magnetic powder is within the above-described numerical range, the aggregation of the magnetic powder can be suppressed, and the resistance applied to the magnetic powder when the magnetic powder is vertically oriented during the process of forming the magnetic layer 13 can be reduced. Therefore, the vertical orientation of the magnetic powder can be improved.

In a case where the magnetic power contains the ε-iron oxide particles, the average particle size and average aspect ratio of the magnetic powder are obtained as follows. First, as described regarding the case where the magnetic powder contains the hexagonal ferrite particle powder, the magnetic recording medium to be measured is cut out. Subsequently, the magnetic recording medium to be measured is thin-sectioned using the focused ion beam (FIB) method or the like. In a case of using the FIB method, as pre-treatment for observing a cross-sectional TEM image to be described below, a carbon film and a tungsten thin film are formed as protective films. The carbon film is formed on the surface of the magnetic recording medium on the magnetic layer side and the surface on the back layer side by vapor deposition, and then, the tungsten thin film is further formed on the surface on the magnetic layer side by vapor deposition or sputtering. The thin sectioning is performed in the length direction (longitudinal direction) of the magnetic recording medium. That is, the thin sectioning forms a cross section parallel to both the longitudinal direction and thickness direction of the magnetic recording medium.

Using a transmission electron microscope (H-9500 manufactured by Hitachi High-Technologies Corporation), the cross section of the obtained thin-sectioned sample is observed at an acceleration voltage of 200 kV and a total magnification of 500,000 times such that the entire magnetic layer 13 is included in the thickness direction of the magnetic layer 13, and a TEM image is captured.

Next, 50 particles whose shapes are clearly visible are selected from the captured TEM image, and a major axis length DL and minor axis length DS of each particle are measured. Here, the major axis length DL refers to the largest distance between two parallel lines drawn from all angles to come into contact with the contour of each particle (so-called maximum Feret's diameter). Meanwhile, the minor axis length DS refers to the largest length of a particle in a direction orthogonal to the major axis (DL) of the particle.

Subsequently, the average (arithmetic mean) of the measured major axis lengths DL of the 50 particles is simply calculated to obtain an average major axis length DLₐᵥₑ. The average major axis length DLₐᵥₑ obtained as described above is defined as the average particle size of the magnetic powder. Furthermore, the average (arithmetic mean) of the measured minor axis lengths DS of the 50 particles is simply calculated to obtain an average minor axis length DSₐᵥₑ. Then, an average aspect ratio (DLₐᵥₑ/DSₐᵥₑ) of the particles is obtained from the average major axis length DLₐᵥₑ and the average minor axis length DSₐᵥₑ.

The average particle volume of the magnetic powder is preferably 1800 nm³ or less, more preferably 1600 nm³ or less, more preferably 1400 nm³ or less, and still more preferably 1200 nm³ or less, 1100 nm³ or less, or 1000 nm³ or less. The average particle volume of the magnetic powder may be preferably 500 nm³ or more, and more preferably 700 nm³ or more.

In a case where the average particle volume of the magnetic powder is less than or equal to the above-described upper limit (for example, less than or equal to 2000 nm³), the magnetic recording medium 10 with high recording density achieves excellent electromagnetic conversion characteristics (for example, SNR). In a case where the average particle volume of the magnetic powder is greater than or equal to the above-described lower limit (for example, greater than or equal to 500 nm³), the dispersibility of the magnetic powder is further improved, and better electromagnetic conversion characteristics (for example, SNR) are achieved.

In a case where the ε-iron oxide particles have a spherical shape or a nearly spherical shape, the average particle volume of the magnetic powder is obtained as follows. First, the average major axis length DLₐᵥₑ is obtained in a manner similar to the method for calculating the average particle size of the magnetic powder described above. Next, the average particle volume V of the magnetic powder is obtained by the following equation.

$$V = ( Π / 6 ) \times D {L}_{a v {e}^{3}}$$

In a case where the ε-iron oxide particles have a cubic shape, the average particle volume of the magnetic powder is obtained as follows. The magnetic recording medium 10 is thin-sectioned using the focused ion beam (FIB) method or the like. In a case of using the FIB method, as pre-treatment for observing a cross-sectional TEM image to be described below, a carbon film and a tungsten thin film are formed as protective films. The carbon film is formed on the surface of the magnetic recording medium 10 on the magnetic layer side and the surface on the back layer side by vapor deposition, and then, the tungsten thin film is further formed on the surface on the magnetic layer side by vapor deposition or sputtering. The thin sectioning is performed in the length direction (longitudinal direction) of the magnetic recording medium 10. That is, the thin sectioning forms a cross section parallel to both the longitudinal direction and thickness direction of the magnetic recording medium 10.

Using a transmission electron microscope (H-9500 manufactured by Hitachi High-Technologies Corporation), the obtained thin-sectioned sample is observed at an acceleration voltage of 200 kV and a total magnification of 500,000 times such that the entire magnetic layer 13 is included in the thickness direction of the magnetic layer 13, and a TEM image is captured. Note that the magnification and acceleration voltage may be appropriately adjusted according to the type of the device.

Next, 50 particles whose shapes are clearly visible are selected from the captured TEM image, and a side length DC of each particle is measured. Subsequently, the average (arithmetic mean) of the measured side lengths DC of the 50 particles is simply calculated to obtain an average side length DCₐᵥₑ. Next, an average particle volume Vₐᵥₑ (particle volume) of the magnetic powder is obtained from the following equation using the average side length DCₐᵥₑ.

$${V}_{a v e} = D {C}_{a v {e}^{3}}$$

The coercive force Hc of the ε-iron oxide particles is preferably 2500 Oe or more, and more preferably 2800 Oe or more and 4200 e or less.

(Embodiment in which Magnetic Powder Contains Co-Containing Spinel Ferrite)

According to still another preferred embodiment of the present technology, the magnetic powder may contain powder of nanoparticles containing the Co-containing spinel ferrite (hereinafter also referred to as “cobalt ferrite particles”). That is, the magnetic powder may be cobalt ferrite magnetic powder. The cobalt ferrite particles preferably have uniaxial crystal anisotropy. The cobalt ferrite particles have, for example, a cubic shape or a nearly cubic shape. The Co-containing spinel ferrite may further contain one or more selected from the group consisting of Ni, Mn, Al, Cu, and Zn, in addition to Co.

The cobalt ferrite has, for example, an average composition represented by the following formula:

$${Co}_{x} {M}_{y} {Fe}_{2} {O}_{z}$$

where M represents, for example, one or more types of metal selected from the group consisting of Ni, Mn, Al, Cu, and Zn, x represents a value within a range of 0.4≤x≤1.0, y represents a value within a range of 0≤y≤0.3; however, x and y satisfy a relationship of (x+y)≤1.0, z represents a value within a range of 3≤z≤4, and a part of Fe may be replaced with another metal element.

The average particle size of the cobalt ferrite magnetic powder is preferably 21 nm or less, and more preferably 19 nm or less. The coercive force Hc of the cobalt ferrite magnetic powder is preferably 2500 Oe or more, and more preferably 2600 Oe or more and 3500 Oe or less.

In a case where the magnetic powder contains the powder of cobalt ferrite particles, the average particle size of the magnetic powder is preferably 25 nm or less, and more preferably 10 nm or more and 19 nm or less. Since the average particle size of the magnetic powder is as small as described above, the magnetic recording medium 10 with high recording density achieves excellent electromagnetic conversion characteristics (for example, SNR). On the other hand, when the average particle size of the magnetic powder is 10 nm or more, the dispersibility of the magnetic powder is further improved, and better electromagnetic conversion characteristics (for example, SNR) are achieved. In a case where the magnetic powder contains the powder of cobalt ferrite particles, the average aspect ratio and average particle size of the magnetic powder are obtained by the same method as in the case where the magnetic powder contains the ε-iron oxide particles.

The average particle volume of the magnetic powder is preferably 2000 nm³ or less, more preferably 1900 nm³ or less, more preferably 1800 nm³ or less, and still more preferably 1700 nm³ or less, 1600 nm³ or less, or 1500 nm³ or less. The average particle volume of the magnetic powder may be preferably 500 nm³ or more, and more preferably 700 nm³ or more.

In a case where the average particle volume of the magnetic powder is less than or equal to the above-described upper limit (for example, less than or equal to 2000 nm³), the magnetic recording medium 10 with high recording density achieves excellent electromagnetic conversion characteristics (for example, SNR). In a case where the average particle volume of the magnetic powder is greater than or equal to the above-described lower limit (for example, greater than or equal to 500 nm³), the dispersibility of the magnetic powder is further improved, and better electromagnetic conversion characteristics (for example, SNR) are achieved.

### (Binder)

As the binder, resin with a crosslinked structure applied to polyurethane-based resin, vinyl chloride-based resin, or the like is preferable. However, the binder is not limited to such resin, and other resins may be appropriately blended according to physical properties and the like required for the magnetic recording medium 10. The resin to be blended is not particularly limited as long as it is commonly used in the coating-type magnetic recording medium 10.

Examples of the binder include polyvinyl chloride, polyvinyl acetate, a vinyl chloride-vinyl acetate copolymer, a vinyl chloride-vinylidene chloride copolymer, a vinyl chloride-acrylonitrile copolymer, an acrylic acid ester-acrylonitrile copolymer, an acrylic acid ester-vinyl chloride-vinylidene chloride copolymer, an acrylic acid ester-vinylidene chloride copolymer, a methacrylic acid ester-vinylidene chloride copolymer, a methacrylic acid ester-vinyl chloride copolymer, a methacrylic acid ester-ethylene copolymer, polyvinyl fluoride, a vinylidene chloride-acrylonitrile copolymer, an acrylonitrile-butadiene copolymer, polyamide resin, polyvinyl butyral, a cellulose derivative (cellulose acetate butyrate, cellulose diacetate, cellulose triacetate, cellulose propionate, nitrocellulose), a styrene-butadiene copolymer, polyester resin, amino resin, and synthetic rubber.

Furthermore, as the binder, thermosetting resin or reactive resin may be used, and examples thereof include phenol resin, epoxy resin, urea resin, melamine resin, alkyd resin, silicone resin, polyamine resin, and urea formaldehyde resin.

Furthermore, a polar functional group such as —SO₃M, —OSO₃M, —COOM, or P═O(OM)₂ may be introduced into each binder described above for the purpose of improving the dispersibility of the magnetic powder. Here, in the formula, M represents a hydrogen atom or an alkali metal such as lithium, potassium, or sodium.

Furthermore, examples of the polar functional group include side-chain types with terminal —NR1R2 and —NR1R2R3⁺X⁻ groups and main-chain types with >NR1R2⁺X⁻ groups. Here, in the formula, R1, R2, and R3 represents hydrogen atoms or hydrocarbon groups, and X⁻ represents a halogen element ion such as fluorine, chlorine, bromine, or iodine, or an inorganic or organic ion. Furthermore, examples of the polar functional group include —OH, —SH, —CN, and epoxy groups.

In an embodiment of the present technology, the magnetic layer contains a chlorine-containing binder. The chlorine-containing binder may be chlorine-containing resin. The chlorine-containing resin is resin containing a chlorine atom as at least one of elements constituting the resin.

The chlorine-containing binder is, for example, vinyl chloride-based resin. More specific examples of the chlorine-containing binder include polyvinyl chloride, a vinyl chloride-vinyl acetate copolymer, a vinyl chloride-vinylidene chloride copolymer, a vinyl chloride-acrylonitrile copolymer, an acrylic acid ester-vinyl chloride-vinylidene chloride copolymer, an acrylic acid ester-vinylidene chloride copolymer, a methacrylic acid ester-vinylidene chloride copolymer, a methacrylic acid ester-vinyl chloride copolymer, a vinylidene chloride-acrylonitrile copolymer, and synthetic rubber.

The content of the chlorine-containing binder in the magnetic layer may be, for example, preferably 30 parts by mass or more, more preferably 35 parts by mass or more, and still more preferably 40 parts by mass or more per 100 parts by mass of the magnetic powder. Furthermore, the content may be, for example, preferably 70 parts by mass or less, more preferably 65 parts by mass or less, and still more preferably 60 parts by mass or less per 100 parts by mass of the magnetic powder.

The magnetic layer may further contain a chlorine-free binder in addition to the chlorine-containing binder. The chlorine-free binder may be chlorine-free resin. The chlorine-free resin may contain, for example, polyurethane-based resin. The polyurethane-based resin is a polymer containing urethane bonds (—NH—C(═O)—), and may be produced via, for example, the polyaddition reaction between an isocyanate compound and a diol compound. The polyurethane-based resin may be, for example, urethane-modified copolymerized polyester. The urethane-modified copolymerized polyester may be urethane-modified copolymerized polyester with aromatic polyester as a main backbone and urethane components in the side chains, or urethane-modified copolymerized polyester containing a repeating ester unit and a repeating urethane unit in its main backbone.

The content of the chlorine-free binder in the magnetic layer may be, for example, preferably 1 part by mass or more, more preferably 2 parts by mass or more, and still more preferably 3 parts by mass or more per 100 parts by mass of the magnetic powder. Furthermore, the content may be, for example, preferably 10 parts by mass or less, more preferably 9 parts by mass or less, and still more preferably 8 parts by mass or less per 100 parts by mass of the magnetic powder.

### (Lubricant)

The magnetic layer may contain lubricant. The lubricant may contain, for example, one or more selected from a fatty acid and/or a fatty acid ester, and may preferably contain both the fatty acid and the fatty acid ester. The fatty acid may be preferably a compound represented by the following General Chemical Formula (1) or General Chemical Formula (2). For example, either or both of the compound represented by the following General Chemical Formula (1) and the compound represented by the following General Chemical Formula (2) may be contained as the fatty acid.

Furthermore, the fatty acid ester may be preferably a compound represented by the following General Chemical Formula (3), General Chemical Formula (4), or General Chemical Formula (5). For example, as the fatty acid ester, any one of the compound represented by the following General Chemical Formula (3), the compound represented by General Chemical Formula (4), or the compound represented by General Chemical Formula (5) may be contained, or two or more selected from these compounds may be contained.

When the lubricant contains either or both of the compound represented by General Chemical Formula (1) and the compound represented by General Chemical Formula (2), and any one of the compound represented by General Chemical Formula (3), the compound represented by General Chemical Formula (4), or the compound represented by General Chemical Formula (5), or two or more selected from these compounds, an increase in the coefficient of dynamic friction due to repeated recording or reproduction of the magnetic recording medium can be suppressed.

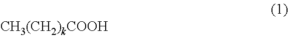

where k represents an integer selected from a range of 14 or more and 22 or less, and more preferably a range of 14 or more and 18 or less.

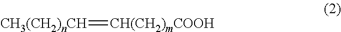

where the sum of n and m is an integer selected from a range of 12 or more and 20 or less, and more preferably a range of 14 or more and 18 or less.

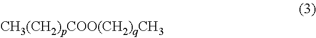

where p represents an integer selected from a range of 14 or more and 22 or less, and more preferably a range of 14 or more and 18 or less, and q represents an integer selected from a range of 2 or more and 5 or less, and more preferably a range of 2 or more and 4 or less.

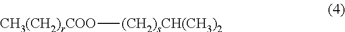

where r represents an integer selected from a range of 14 or more and 22 or less, and s represents an integer selected from a range of 1 or more and 3 or less.

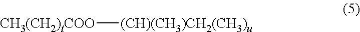

where t represents an integer selected from a range of 14 or more and 22 or less, and u represents an integer selected from a range of 1 or more and 3 or less.

Examples of the lubricant include esters of monobasic fatty acids with 10 to 24 carbon atoms and monohydric to hexahydric alcohols with 2 to 12 carbon atoms, including mixed esters, di-fatty acid esters, and tri-fatty acid esters. Specific examples of the lubricant include lauric acid, myristic acid, palmitic acid, stearic acid, behenic acid, oleic acid, linoleic acid, linolenic acid, elaidic acid, butyl stearate, pentyl stearate, heptyl stearate, octyl stearate, isooctyl stearate, and octyl myristate. The magnetic layer may contain any one or more of these.

The content of the lubricant may be, for example, preferably 1 part by mass or more, and more preferably 2 parts by mass or more per 100 parts by mass of the magnetic powder. Furthermore, the content may be, for example, preferably 10 parts by mass or less, more preferably 8 parts by mass or less, and still more preferably 6 parts by mass or less per 100 parts by mass of the magnetic powder.

### (Additive)

The magnetic layer 13 may further contain, as non-magnetic reinforcing particles, aluminum oxide (α, β, or γ alumina), chromium oxide, silicon oxide, diamond, garnet, emery, boron nitride, titanium carbide, silicon carbide, titanium carbide, and titanium oxide (rutile or anatase type titanium oxide) or the like.

In an embodiment of the present technology, the magnetic layer may contain conductive first particles and second particles with a Mohs hardness of 7 or more. Protrusions may be formed on the surface of the magnetic layer by the first particles and the second particles. For example, the first particles can prevent an increase in frictional force during the traveling of the magnetic recording tape, and exhibits functionality as a solid lubricant component, for example. Furthermore, the second particles can exhibit an abrasive effect (as well as an anchoring effect) for magnetic head cleaning. It is considered that incorporating these two components into the magnetic layer of the magnetic recording tape prevents an increase in frictional force and enables magnetic head cleaning, thereby enhancing traveling performance.

The first particles have conductivity. As the first particles, fine particles containing carbon as a main component can be used, specifically, carbon particles may be preferably used, and examples of such carbon particles include carbon black. As the carbon black, for example, SEAST TA manufactured by Tokai Carbon Co., Ltd., and Asahi #15, #15HS manufactured by Asahi Carbon Co., Ltd., and the like can be used. Alternatively, hybrid carbon with carbon adhered to the surfaces of silica particles may be used.

The average particle size (arithmetic mean particle diameter measured using electron microscopy) of the first particles (particularly, carbon particles such as carbon black) may be, for example, preferably 15 nm or more, more preferably 30 nm or more, and still more preferably 50 nm or more. The average particle size may be, for example, preferably 200 nm or less, more preferably 180 nm or less, still more preferably 150 nm or less, 130 nm or less, or 120 nm or less. The numerical range of the average particle size may be appropriately selected from these upper limits and lower limits, and is, for example, preferably 50 nm to 200 nm, more preferably 50 nm to 180 nm, still more preferably 50 nm to 150 nm, and still more preferably 50 nm to 130 nm.

From the viewpoint of suppressing deformation due to contact with the magnetic head, the Mohs hardness of the second particles may be preferably 7 or more, more preferably 7.5 or more, still more preferably 8 or more, and still more preferably 8.5 or more. From the viewpoint of suppressing head wear, the Mohs hardness of the second particles may be, for example, preferably 10 or less, and more preferably 9.5 or less. That is, the second particles may include a material with such a Mohs hardness.

The second particles may be preferably inorganic particles. Examples of the second particles include α-alumina (the α-conversion rate may be 90% or more), β-alumina, γ-alumina, silicon carbide, chromium oxide, cerium oxide, α-iron oxide, corundum, silicon nitride, titanium carbide, titanium oxide, silicon dioxide, tin oxide, magnesium oxide, tungsten oxide, zirconium oxide, boron nitride, zinc oxide, calcium carbonate, calcium sulfate, barium sulfate, molybdenum disulfide, acicular α-iron oxide obtained by dehydrating and annealing a magnetic iron oxide precursor, those obtained by performing surface treatment thereon with aluminum and/or silica as necessary, and diamond powder or a combination of at least two of these. As the second particles, alumina particles such as α-alumina, β-alumina, and γ-alumina, and silicon carbide are preferably used. The second particles may have any shape such as a needle shape, a spherical shape, and a dice shape, but those having some corners in their shapes are preferable because they have high abrasiveness, for example.

The average particle size (for example, the arithmetic mean particle diameter measured using electron microscopy) of the second particles (particularly, inorganic particles such as alumina) may be, for example, preferably 15 nm or more, more preferably 30 nm or more, and still more preferably 50 nm or more. The average particle size may be, for example, preferably 200 nm or less, more preferably 180 nm or less, still more preferably 150 nm or less, 130 nm or less, or 120 nm or less. The numerical range of the average particle size may be appropriately selected from these upper limits and lower limits, and is, for example, preferably 50 nm to 180 nm, more preferably 60 nm to 150 nm, still more preferably 60 nm to 120 nm.

The second particles (particularly, inorganic particles such as alumina) may be non-conductive. That is, the second particles may be non-conductive, unlike the first particles.

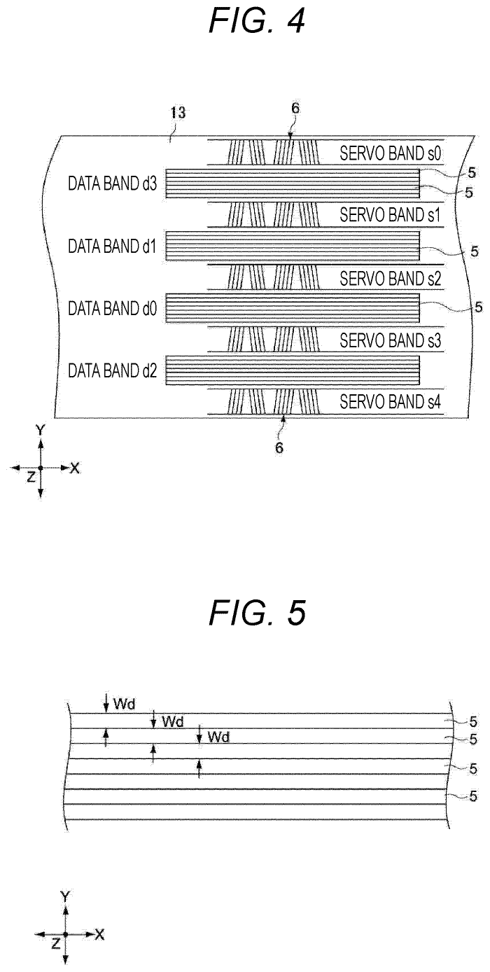

As illustrated in FIG. 4, the magnetic layer 13 includes a plurality of data bands d (data bands d0 to d3) extending in the longitudinal direction (X-axis direction) in which data is written and a plurality of servo bands s (servo bands s0 to s4) extending in the longitudinal direction in which a servo pattern 6 is written. The servo bands s are arranged such that each data band d is sandwiched between the servo bands s in the width direction (Y-axis direction). Note that the magnetic layer 13 preferably has five or more servo bands s.

In the present technology, the ratio of the area of the servo band s to the area of the entire surface of the magnetic layer 13 is typically 4.0% or less. Note that the width of the servo band s is a tape width of ½ inch, and is, for example, 98 μm or less. The ratio of the area of the servo band s to the area of the entire surface of the magnetic layer 13 can be measured, for example, by developing the magnetic recording medium using a developing solution such as a ferricolloid developing solution, and then observing the developed magnetic recording medium with an optical microscope.

In the example illustrated in FIG. 4, four data bands d and five servo bands are provided. Note that the number of data bands d and the number of servo bands s can be adjusted as appropriate.

The data band d is elongated in the longitudinal direction and includes a plurality of recording tracks 5 aligned in the width direction. Each data band d includes, for example, about 1000 to 2500 recording tracks 5. Data is recorded in the recording track 5 along the length of the recording track 5. A 1-bit length in the longitudinal direction of the data recorded in the data band d is, for example, 48 nm or less. The servo band s includes the servo pattern 6 with a predetermined shape recorded by a servo pattern recording device to be described later.

Here, in the magnetic recording medium conforming to the LTO standard, the number of recording tracks 5 increases with each generation, resulting in a significant enhancement of recording capacity. As an example, the number of recording tracks 5 is 384 in the first generation LTO-1, but, from LTO-2 to LTO-8, the number of recording tracks 5 has increased sequentially to 512, 704, 896, 1280, 2176, 3584, and 6656. Similarly, the data recording capacity is 100 GB (gigabyte) in LTO-1, but, from LTO-2 to LTO-8, the data recording capacity has increased sequentially to 200 GB, 400 GB, 800 GB, 1.5 TB (terabyte), 2.5 TB, 6.0 TB, and 12 TB.

In the present embodiment, the number of recording tracks 5 and the recording capacity are not particularly limited, and can be adjusted as needed. However, for example, it is advantageous if the present embodiment is applied to a magnetic recording medium that has a large number of recording tracks 5 and large recording capacity (for example, 6656 or more, 12 TB or more: LTO8 or later generation) and is easily affected by width variations. For example, a magnetic tape with an overall Young's modulus (Young's modulus in the tape longitudinal direction) of 8 GPa or less is applied as the magnetic tape recording medium.

### (Data Band and Servo Band)

FIG. 5 is an enlarged view illustrating an example of the recording track (data track) 5 in the data band d of the magnetic recording medium conforming to the LTO standards up to LT09. As illustrated in FIG. 5, the recording tracks 5 are elongated in the longitudinal direction and aligned in the width direction, and each have a predetermined recording track width (data track width) Wd in the width direction. The recording track width Wd is 2.0 μm or less in LTO-8. The upper limit of the average of the recording track widths (data track widths) Wd is preferably 1200 nm or less, more preferably 1000 nm or less, still more preferably 800 nm or less, and particularly preferably 600 nm or less from the viewpoint of increasing recording track recording density and ensuring high recording capacity. The lower limit of the average of the recording track widths (data track widths) Wd is preferably 20 nm or more with consideration of the magnetic particle size. Note that such a recording track width Wd can be measured, for example, by developing the magnetic layer 13 of the magnetic recording medium 10 using a developing solution such as a ferricolloid developing solution, and then observing the developed magnetic layer 13 of the magnetic recording medium 10 with an optical microscope. Alternatively, as a measurement method using the drive head, the recording track width Wd can be measured from output variations in a case where, to disregard variations during tape traveling, the drive head is set to a Read While Write (reproduction during recording) state and its azimuth is changed. (IEEE_Sept1996_Crosstrack Profiles of Thin Film MR Tape Heads Using the Azimuth Displacement Method)

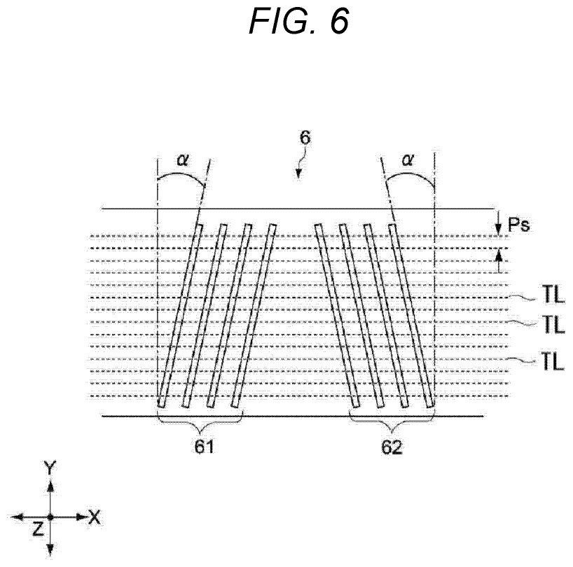

FIG. 6 is an enlarged view illustrating a part of an example of the servo pattern 6 written in the servo band s of the magnetic recording medium conforming to the LTO standards up to LT09. As illustrated in FIG. 6, the servo pattern 6 includes a plurality of stripes inclined at a predetermined azimuth angle α with respect to the width direction (Y-axis direction), which will be described in detail later. The plurality of stripes is classified into a first stripe group 61 inclined clockwise with respect to the width direction (Y-axis direction) and a second stripe group 62 inclined counterclockwise with respect to the width direction. The first stripe group 61 and the second stripe group 62 each typically include four or five stripes. Note that a shape of the servo pattern 6 and the like can be measured, for example, by developing the magnetic layer 13 of the magnetic recording medium 10 using a developing solution such as a ferricolloid developing solution, and then observing the developed magnetic layer 13 of the magnetic recording medium 10 with an optical microscope. Note that the servo band s may be a servo band for tilting the recording/reproducing head of the drive.

In FIG. 6, a servo trace line TL, which is a line traced by a servo read head 132 to be described later on the servo pattern 6, is indicated by a dashed line. The servo trace line TL is set along the longitudinal direction (X-axis direction) and is set at predetermined intervals Ps in the width direction.

The number of servo trace lines TL per servo band s is, for example, about 30 to 60. The intervals Ps between two adjacent servo trace lines TL are the same as the recording track width Wd, and is, for example, 2.0 μm or less. Here, the intervals Ps between two adjacent servo trace lines TL determine the recording track width Wd. That is, when the intervals Ps between the servo trace lines TL are reduced, the recording track width Wd decreases, and the number of recording tracks 5 per data band d increases. As a result, the data recording capacity increases.

### (Underlayer)

The underlayer 12 is a non-magnetic layer containing non-magnetic powder and a binder as main components. The underlayer 12 may further contain at least one additive selected from other particles, lubricant, a hardener, a rust inhibitor, and the like as necessary.

### (Non-Magnetic Powder)

The non-magnetic powder contained in the underlayer 12 contains, for example, at least one selected from inorganic particles and organic particles, and particularly contains at least one selected from inorganic particles. One kind of non-magnetic powder may be used alone, or two or more kinds of non-magnetic powders may be used in combination. The non-magnetic inorganic particles may contain, for example, one or a combination of two or more selected from metal, metal oxide, metal carbonate, metal sulfate, metal nitride, metal carbide, and metal sulfide. More specifically, the inorganic particles may contain, for example, one or more selected from iron oxide, aluminum oxide, carbon black, iron oxyhydroxide, hematite, titanium oxide, silicon oxide, titanium carbide, silicon carbide, diamond, and calcium carbonate. Examples of the shape of the non-magnetic powder include various shapes such as a needle shape, a spherical shape, a cubic shape, and a plate shape, but are not limited to these shapes.

In an embodiment of the present technology, the non-magnetic powder contains at least iron oxide, specifically acicular iron oxide. In this embodiment, the non-magnetic powder may further contain carbon black and/or aluminum oxide.

The average major axis length of iron oxide (specifically, acicular iron oxide) may be, for example, preferably 0.01 μm or more, more preferably 0.04 μm or more, and still more preferably 0.07 μm or more. Furthermore, the average major axis length may be, for example, preferably 0.5 μm or less, more preferably 0.4 μm or less, and still more preferably 0.3 μm or less.

The average particle diameter of the carbon black may be, for example, preferably 10 nm or more, more preferably 12 nm or more, and still more preferably 15 nm or more. Furthermore, the average particle size of the carbon black may be, for example, preferably 250 nm or less, more preferably 150 nm or less, and still more preferably 100 nm or less.

The content of the carbon black may be, for example, preferably 15 parts by mass or more, more preferably 20 parts by mass or more, and still more preferably 25 parts by mass or more per 100 parts by mass of the iron oxide. Furthermore, the content of the carbon black may be, for example, preferably 45 parts by mass or less, more preferably 40 parts by mass or less, and still more preferably 35 parts by mass or less per 100 parts by mass of the iron oxide.

The average particle size of the aluminum oxide may be, for example, preferably 30 nm or more, more preferably 40 nm or more, and still more preferably 60 nm or more. Furthermore, the average particle size of the aluminum oxide may be, for example, preferably 180 nm or less, more preferably 150 nm or less, and still more preferably 120 nm or less.

The content of the aluminum oxide may be, for example, preferably 1 part by mass or more, more preferably 2 parts by mass or more, and still more preferably 3 parts by mass or more per 100 parts by mass of the iron oxide. Furthermore, the content of the aluminum oxide may be, for example, preferably 10 part by mass or less, more preferably 9 parts by mass or less, and still more preferably 8 parts by mass or less per 100 parts by mass of the iron oxide.

### (Binder)

The underlayer contains a binder. The above description regarding the binder contained in the magnetic layer 13 also applies to the binder contained in the underlayer 12.

In the present technology, the underlayer contains at least a chlorine-containing binder. The chlorine-containing binder may be chlorine-containing resin. The chlorine-containing resin is resin containing a chlorine atom as at least one of elements constituting the resin.

The chlorine-containing binder is, for example, vinyl chloride-based resin. More specific examples of the chlorine-containing binder include polyvinyl chloride, a vinyl chloride-vinyl acetate copolymer, a vinyl chloride-vinylidene chloride copolymer, a vinyl chloride-acrylonitrile copolymer, an acrylic acid ester-vinyl chloride-vinylidene chloride copolymer, an acrylic acid ester-vinylidene chloride copolymer, a methacrylic acid ester-vinylidene chloride copolymer, a methacrylic acid ester-vinyl chloride copolymer, a vinylidene chloride-acrylonitrile copolymer, and synthetic rubber.

The underlayer contains a chlorine-containing binder adsorbed onto the non-magnetic powder and a chlorine-containing binder not adsorbed onto the non-magnetic powder. The distribution state of the chlorine-containing binder not adsorbed onto the non-magnetic powder in the underlayer is affected by a solvent contained in the magnetic layer forming coating material and the coating material drying treatment in the magnetic layer forming process in the manufacturing process of the magnetic recording medium. The reliability of the magnetic recording medium can be enhanced by controlling the distribution state according to the present technology.

The content volume of the chlorine-containing binder in the underlayer may be, for example, a volume corresponding to 20 vol % or more, preferably 30 vol % or more, and more preferably 40 vol % or more of the volume of the non-magnetic powder (specifically, the total volume of the non-magnetic powder). Furthermore, the content volume may be, for example, a volume corresponding to 180 vol % or less, preferably 170 vol % or less, and more preferably 160 vol % or less of the volume of the non-magnetic powder (specifically, the total volume of the non-magnetic powder).

For example, in a case where the total volume of the non-magnetic powder is assumed to be 100, the volume of the chlorine-containing binder in the underlayer may be, for example, preferably 20 to 180, more preferably 30 to 170, and still more preferably 40 to 160.

In one embodiment, the underlayer contains iron oxide as the non-magnetic powder. In this embodiment, the content of the chlorine-containing binder in the underlayer may be, for example, preferably 20 parts by mass or more, more preferably 25 parts by mass or more, and still more preferably 30 parts by mass or more per 100 parts by mass of the iron oxide. Furthermore, the content may be, for example, preferably 70 parts by mass or less, more preferably 65 parts by mass or less, and still more preferably 60 parts by mass or less per 100 parts by mass of the iron oxide.

The underlayer may further contain a chlorine-free binder in addition to the chlorine-containing binder. The chlorine-free binder may be chlorine-free resin. The chlorine-free resin may contain, for example, polyurethane-based resin. The polyurethane-based resin is a polymer containing urethane bonds (—NH—C(═O)—), and may be produced via, for example, the polyaddition reaction between an isocyanate compound and a diol compound. The polyurethane-based resin may be, for example, urethane-modified copolymerized polyester. The urethane-modified copolymerized polyester may be urethane-modified copolymerized polyester with aromatic polyester as a main backbone and urethane components in the side chains, or urethane-modified copolymerized polyester containing a repeating ester unit and a repeating urethane unit in its main backbone.

The content volume of the chlorine-free binder in the underlayer may be, for example, a volume corresponding to 0 vol % or more, preferably 10 vol % or more, and more preferably 20 vol % or more of the volume of the non-magnetic powder (specifically, the total volume of the non-magnetic powder). Furthermore, the content volume may be, for example, a volume corresponding to 150 vol % or less, preferably 140 vol % or less, and more preferably 130 vol % or less of the volume of the non-magnetic powder (specifically, the total volume of the non-magnetic powder). The underlayer need not contain the chlorine-free binder.

For example, in a case where the total volume of the non-magnetic powder is assumed to be 100, the volume of the chlorine-containing binder in the underlayer may be, for example, preferably 0 to 150, more preferably 10 to 140, and still more preferably 200 to 130.

In one embodiment, the underlayer contains iron oxide as the non-magnetic powder. In this embodiment, the content of the chlorine-free binder in the underlayer may be, for example, preferably 0 parts by mass or more, more preferably 5 parts by mass or more, and still more preferably 10 parts by mass or more per 100 parts by mass of the iron oxide. Furthermore, the content may be, for example, preferably 30 parts by mass or less, more preferably 25 parts by mass or less, and still more preferably 20 parts by mass or less per 100 parts by mass of the iron oxide.

### (Lubricant)

The underlayer may contain lubricant. The lubricant may contain, for example, one or more selected from fatty acid and/or a fatty acid ester, and the lubricant may be preferably a compound represented by General Chemical Formula (1) or General Chemical Formula (2), or General Chemical Formula (3), General Chemical Formula (4), or General Chemical Formula (5) described above for the magnetic layer. One or more of these compounds may be contained.

Examples of the lubricant include esters of monobasic fatty acids with 10 to 24 carbon atoms and monohydric to hexahydric alcohols with 2 to 12 carbon atoms, including mixed esters, di-fatty acid esters, and tri-fatty acid esters. Specific examples of the lubricant include lauric acid, myristic acid, palmitic acid, stearic acid, behenic acid, oleic acid, linoleic acid, linolenic acid, elaidic acid, butyl stearate, pentyl stearate, heptyl stearate, octyl stearate, isooctyl stearate, and octyl myristate. The magnetic layer may contain any one or more of these.

The content of the lubricant in the underlayer may be, for example, preferably 1 part by mass or more, more preferably 1.5 parts by mass or more, and still more preferably 2 parts by mass or more per 100 parts by mass of the non-magnetic powder (per 100 parts by mass of the total amount of non-magnetic powder). Furthermore, the content may be, for example, preferably 12 parts by mass or less, more preferably 10 parts by mass or less, and still more preferably 8 parts by mass or less per 100 parts by mass of the non-magnetic powder (per 100 parts by mass of the total amount of non-magnetic powder). The above numerical ranges may be applied, for example, in a case where the non-magnetic powder contains iron oxide.

In one embodiment, the underlayer contains iron oxide as the non-magnetic powder. In this embodiment, the content of the lubricant in the underlayer may be, for example, preferably 2 parts by mass or more, more preferably 2.5 parts by mass or more, and still more preferably 3 parts by mass or more per 100 parts by mass of the iron oxide. Furthermore, the content may be, for example, preferably 8 parts by mass or less, more preferably 7 parts by mass or less, and still more preferably 6 parts by mass or less per 100 parts by mass of the iron oxide.

### (Back Layer)

The back layer 14 may contain a binder and non-magnetic powder. The back layer 14 may contain various additives such as lubricant, a hardener, and an antistatic agent as necessary. The above description regarding the binder and the non-magnetic powder contained in the non-magnetic layer 12 also applies to the binder and the non-magnetic powder contained in the back layer 14.

The average particle size of the inorganic particles contained in the back layer 14 is preferably 10 nm or more and 150 nm or less, and more preferably 15 nm or more and 110 nm or less. The average particle size of the inorganic particles is obtained in a similar manner to the average particle size D of the magnetic powder described above.

### (3) Physical Properties

[Thickness of Portion where Chlorine Count is Greater than or Equal to Threshold in Underlayer]

The thickness of the portion where the chlorine count is greater than or equal to the following threshold in the underlayer 12 of the magnetic recording medium 10 is, for example, 130 nm or less as described above.

$$[ Threshold ] = [ Average chlorine count in the underlayer ] + 6 \times [ Standard deviation obtained in calculating the average chlorine count ]$$

The thickness of the portion corresponds to a thickness of a region where a chlorine count determined by measuring the chlorine count in the thickness direction of the underlayer using a scanning transmission electron microscope (STEM) is greater than or equal to the threshold.

A method for measuring the thickness of the portion is as follows.

### (Method for Preparing Sample)

To prepare a sample, a portion of the tape-shaped magnetic recording medium contained in the magnetic recording cartridge, with a length of about 20 m from the outermost edge in the tape longitudinal direction, is used. For example, the magnetic tape T contained in a cartridge such as the cartridge 10A to be described later is unwound, and a portion with a length of about 20 m from the connection portion 221 between the magnetic tape T and the leader tape LT in the longitudinal direction is used for sample preparation. Of the portion, an approximately central portion in the width direction of the magnetic tape T is cut out into an appropriate size (for example, an approximately 1 mm×1 mm square) for preparing a sample for STEM observation. Carbon deposition treatment is performed on the surface of the cut sample to form a carbon deposition film on the magnetic surface. The sample subjected to the treatment is introduced into a focused-ion beam (FIB) processing device equipped with a scanning electron microscope (SEM). From the sample subjected to the treatment, a micro-piece with a size suitable for STEM observation (for example, a square with a side length of 10 μm to 50 μm) is micro-sampled by the processing device. The micro-piece is fixed onto a sample stage of the processing device and thin-sectioned. The thin sectioning is performed to adjust the thickness of the micro-piece in a direction parallel to its magnetic surface to allow the electron beam used in STEM observation to pass through the micro-piece. The sample for STEM observation is prepared as described above. Note that the device and treatment conditions for sample preparation are as follows.

### [Device]

Processing device: Versa3D DualBeam manufactured by FEI Company

### [Treatment Conditions]

Sample pre-treatment: Carbon deposition
Ion species: Gallium ion
Acceleration voltage (voltage applied during rough excavation): 30 kV
Final finishing voltage: 5 kV
Material of sample stage: Mo

### (Method for Observing Sample)

The sample for STEM observation is observed and subjected to EDX analysis by the following STEM device. The observation and analysis conditions are as follows, and details thereof will be described later.

### [Device]

STEM device: TalosF200X (Schottky-FEG) manufactured by FEI company
EDX system: Super-X manufactured by FEI company
EDX detector: four windowless SDD detectors (30 mm², built-in objective lens) manufactured by Bruker Corporation

### [Observation Conditions]

Acceleration voltage: 200 kV
Acquired image: BF STEM image (Bright Field: BF)
HAADF STEM image (High Angle Annular Dark Field: HAADF)
Camera length: 98 mm
Device display magnification: 57000 times

### [Analysis Conditions (Mapping and Line Extraction Conditions for EDX Analysis)]

Acceleration voltage: 200 kV
Device display magnification: 57000 times
Surface analysis resolution: 800 pixels×700 pixels (1 pixel corresponds to about 2.1 nm)
Moving average filter: 3 pixels
Data type: Net count
Integration width for Cl Kα line extraction×length in thickness direction: 700 pixels×650 pixels

Here, the “integration width for Cl Kα line extraction” is a length of a side approximately parallel to the magnetic surface of the magnetic recording medium of a rectangle defining an area where Cl Kα lines are extracted.

The “length in the thickness direction” is a length of a side approximately parallel to the thickness direction of the magnetic recording medium of the rectangle defining the area where Cl Kα lines are extracted.

In this analysis, the net count of Cl Kα lines at a certain position in the thickness direction of the magnetic recording medium corresponds to the Cl amount at the certain position. Therefore, the distribution state of the chlorine content can be identified on the basis of the net count of Cl Kα lines. Note that the energy of characteristic X-ray Kα lines generated when Cl is exposed to electron beams is 2.62 keV.

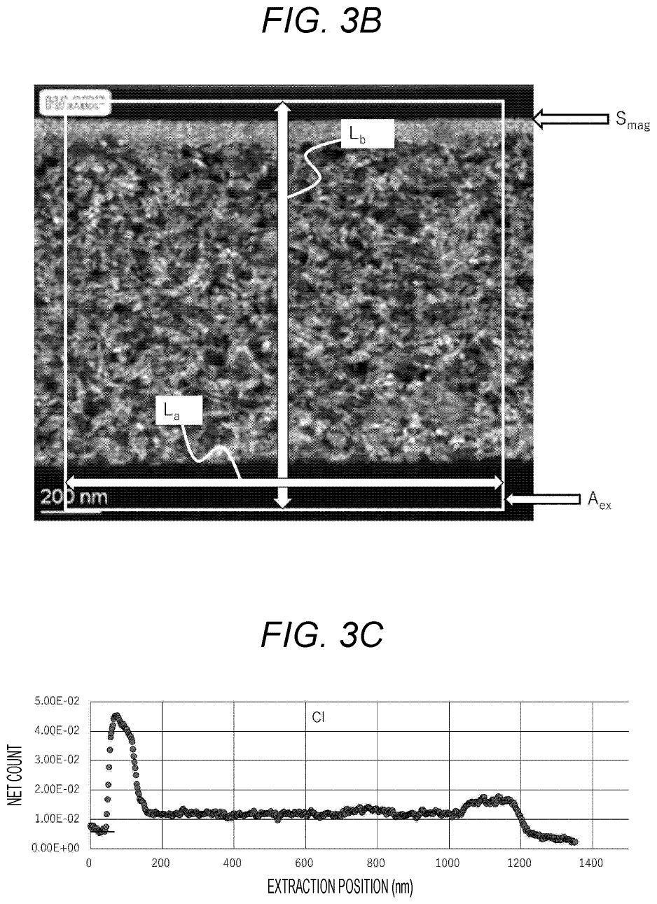

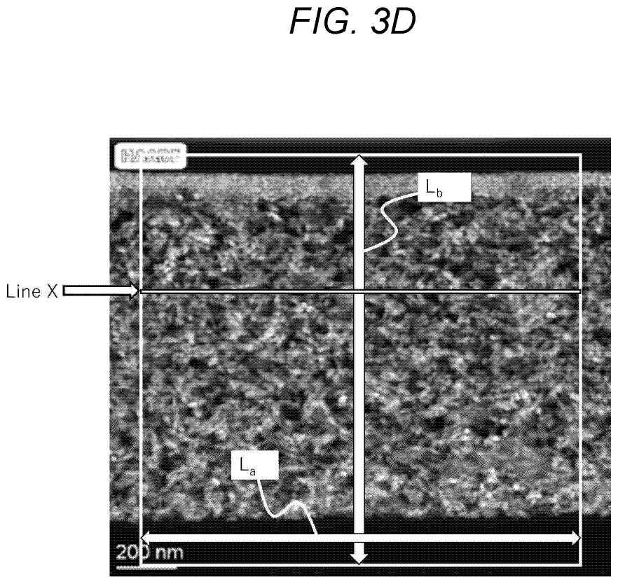

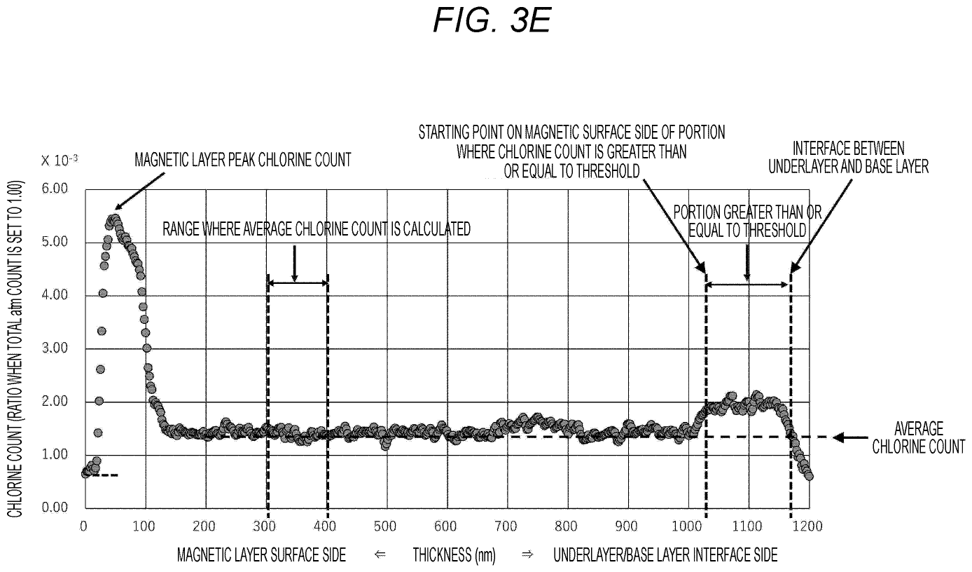

Under the above-described observation conditions, the HAADF STEM image of the sample for STEM observation in a direction parallel to the magnetic surface is acquired. FIG. 3A illustrates an example of the acquired HAADF STEM image. As shown in the drawing, the magnetic layer M and the underlayer U can be identified from the image.

In this observation, the STEM cross-sectional image is verified to ensure that there is no region in the underlayer cross-section that exhibits a state clearly different from the normal state of the underlayer. Such a region includes, for example, coarse inorganic particles, voids, or non-dispersed binder, and analysis is performed on the cross-section where no such a region exists.

By performing EDX analysis under the analysis conditions, the distribution state of chlorine atoms at each position in the HAADF image can be identified. Specifically, the identification is performed in the following procedure.

### (i) Setting of Chlorine Count Extraction Area in Acquired HAADF STEM Image

For example, for the HAADF image shown in FIG. 3A, as illustrated in FIG. 3B, a Kα line extraction area Aₑₓ (area enclosed by a while rectangular outline) is set. As illustrated in the drawing, the Kα line extraction area is a rectangle, specifically a long rectangle.

The length of the horizontal side of the long rectangle is 700 pixels, which is the “integration width for Cl Kα line extraction” described above, that is, the length of the rectangular area in which Cl Kα lines are extracted in the direction approximately parallel to the magnetic surface of the magnetic recording medium. For example, in the drawing, the width indicated by the double-headed arrow Lₐ is the integration width for Cl Kα line extraction.

The length of the vertical side of the long rectangle is 650 pixels, which is the “length in the thickness direction”. For example, in the drawing, the length indicated by the double-headed arrow L_{b} is the length in the thickness direction.

As described above with reference to FIG. 3A, the magnetic layer and the underlayer can be identified through visual observation of the HAADF image. The rectangle set as the Cl Kα line extraction area is set such that a side corresponding to the integration width for Cl Kα line extraction is approximately parallel to the surface of the visually identified magnetic layer, and the rectangle covers the carbon deposition film, the magnetic layer, the underlayer, and the base layer. Note that, in the actual setting, it is not necessary to draw a white line as illustrated in the drawing.

### (ii) Acquiring Chlorine Distribution Data Based on Result of the EDX Analysis.

Cl Kα lines are counted over the entire integration width for Cl Kα line extraction for each pixel position in the thickness direction. For the count, as illustrated in FIG. 3D, it is assumed that a line (Line X) approximately parallel to the magnetic surface corresponds to a certain pixel position X in the thickness direction. Throughout this line, the Cl Kα lines are counted. The total sum of the counted Cl Kα lines is the net count.

The net count is calculated for all the lines at pixel positions in the thickness direction. As described above, the net count in the line at each pixel position, that is, the net count at each position in the thickness direction is calculated.

By plotting the calculated net count against the pixel position in the thickness direction, a plot as illustrated in FIG. 3C is obtained, for example. In the drawing, the “extraction position” on the horizontal axis corresponds to the pixel position in the thickness direction.

(iii) Normalization Processing

Normalization processing is performed on the net count data acquired in the above (ii). Specifically, the normalization processing is performed with the total sum of the acquired net counts over the entire length in the thickness direction (that is, the entire Kα line extraction area) set to 1. Then, a value obtained by performing the normalization processing on the net count at each pixel position is defined as a chlorine count.

### (iv) Identification of Surface of Magnetic Layer

On the basis of the fact that the carbon deposition film does not contain chlorine, the surface of the magnetic layer in the chlorine count extraction area is identified.

To identify the surface of the magnetic layer, first, a portion corresponding to the carbon deposition film is identified. The portion corresponding to the carbon deposition film can be roughly identified from the plot. For example, the peak on the left side of the plot in FIG. 3C corresponds to the magnetic layer portion, a portion with a lower net count appearing on the left side of the magnetic layer portion corresponds to the carbon deposition film. Then, the average (simple average) of the net counts in the first 6 nm segment where the net count starts from zero is identified as a background value.

Next, a position (pixel position in the thickness direction) where the net count exceeding the background value is recorded in the plot generated in the above (ii) is defined as the position of the surface of the magnetic layer. For example, in FIG. 3C, as moving rightward from the 0 nm point on the extraction position axis, there is an extraction position data point at which the background value is recorded. An extraction position at the data point to the right of the extraction position data point is the position of the surface of the magnetic layer.

### (v) Calculation of Average Chlorine Count in Underlayer and Standard Deviation

The average and standard deviation of the chlorine counts (values after the normalization processing in the above (iii)) in the range of 300 nm to 400 nm in the thickness direction from the surface of the magnetic layer identified in the above (iv) are calculated. The average is a simple average, and the standard deviation is calculated using the n−1 method. The average is the “average chlorine count in the underlayer” in the present specification, and the standard deviation is the “standard deviation obtained in calculating the average chlorine count” in the present specification.

FIG. 3E shows data obtained by plotting the chlorine counts after the normalization processing against the positions in the thickness direction. As shown in the drawing, the range of 300 nm to 400 nm is adopted as a data range from which the average chlorine count and the standard deviation are calculated.

### (vi) Calculation of Threshold

The threshold is calculated by the following equation using the “average chlorine count in the underlayer” and the “standard deviation obtained in calculating the average chlorine count” calculated in the above (v).

$$[ Threshold ] = [ Average chlorine count in the underlayer ] + 6 \times [ Standard deviation obtained in calculating the average chlorine count ]$$

(vii) Identification of Thickness of Portion where Chlorine Count is Greater than or Equal to Threshold in Underlayer

First, for each pixel position, a moving average of chlorine counts over 10 lines is obtained. The 10 lines include a line corresponding to the pixel position over which the moving average is calculated, lines corresponding to five pixel positions located closer to the back layer relative to the pixel position, and lines corresponding to four pixel positions located closer to the magnetic surface relative to the pixel position.

In a case where, after moving from the range of 300 nm to 400 nm toward the base layer, the first position of the 6 nm segment where the moving average equals or exceeds the threshold continuously is defined as a “starting point on the magnetic surface side of the portion where the chlorine count is greater than or equal to the threshold”. An example of the starting point is shown in FIG. 3E.

Next, an interface between the underlayer and the base layer is identified. As moving further toward the base layer from the starting point, the chlorine count starts to decrease. Moreover, as moving toward the base layer, the first position where the chlorine count falls below the “average chlorine count in the underlayer” is defined as the “interface between the base layer and the underlayer”. An example of the position of the interface is also shown in FIG. 3E.

Note that, in a case where the base layer includes a chlorine-free material, the position of the interface may be identified as the first position where the chlorine count falls below the average chlorine count in the underlayer as described above. On the other hand, it is also assumed that the base layer includes a chlorine-containing material. In this case, in a case where the chlorine count in the base layer is different from the net count of the chlorine Kα lines in the average portion of the underlayer, the position of the interface may be identified on the basis of the difference.

A length from the “starting point on the magnetic surface side of the portion where the chlorine count is greater than or equal to the threshold” to the “interface between the underlayer and the base layer” identified as described above is defined as a “thickness of the portion where the chlorine count is greater than or equal to the threshold in the underlayer”. An example of the portion is also shown in FIG. 3E.

### (Other Data Obtained on the Basis of the Plot)

Using the “thickness of the portion where the chlorine count is greater than or equal to the threshold in the underlayer” identified as described above, a ratio of the thickness of the portion where the chlorine count is greater than or equal to the threshold in the underlayer to the thickness of the underlayer is obtained by the following equation.

(Ratio (%) of the thickness of the portion where the chlorine count is greater than or equal to the threshold in the underlayer to the thickness of the underlayer)=(the thickness of the portion where the chlorine count is greater than or equal to the threshold in the underlayer)/(the thickness of the underlayer)×100

Furthermore, as shown in FIG. 3E, a peak portion corresponding to the magnetic layer can be observed on the left side of the plot in FIG. 3E. The maximum value of the chlorine count in this peak portion is defined as a “peak chlorine count in the magnetic layer”.

### [Average Width Variation AA]

The absolute value of the average width variation ΔA of the magnetic recording medium 10 before and after the magnetic recording medium 10 is left for 40 hours in an environment with a temperature of 50° C. and a relative humidity of 40% RH with a tension of 0.55 N applied in the longitudinal direction to each half an inch of the width of the magnetic recording medium 10 is 170 ppm or less, preferably 140 ppm or less, more preferably 70 ppm or less, and still more preferably 40 ppm or less.

The absolute value of the average width variation ΔA of the magnetic recording medium (hereinafter, referred to as “magnetic tape”) wound into the magnetic recording cartridge is obtained as follows. First, the magnetic tape T with a width of ½ inch contained in the cartridge 10A is unwound, and the magnetic tape T is cut to a length of 250 mm from each of a range of 10 m to 20 m, a range of 30 m to 40 m, and a range of 50 m to 60 m in the longitudinal direction, starting from the connection portion 221 between the magnetic tape T and the leader tape LT to prepare three samples.

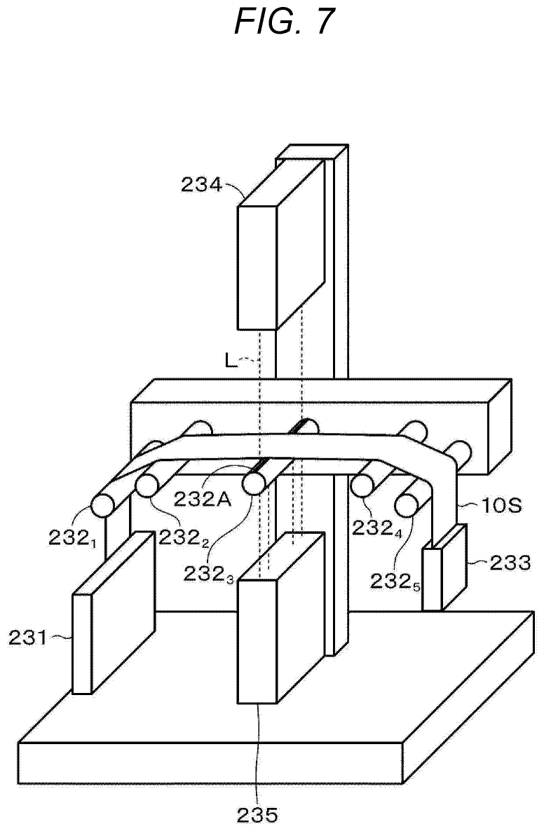

Next, the absolute value of the width variation DA of each of the three samples is obtained as follows. First, a measuring device illustrated in FIG. 7 equipped with a digital dimension measuring instrument LS-7000 manufactured by Keyence Corporation is prepared, and a sample 10S is set in the measuring device. Specifically, the elongated sample (magnetic tape T) 10S has one end fixed by a fixing portion 231. Next, as illustrated in FIG. 7, the sample 10S is placed on five approximately cylindrical and rod-shaped support members 2321 to 2325. The sample 10S is placed on the five support members 2321 to 2325 such that its back surface is in contact with the five support members 2321 to 2325. The five support members 2321 to 2325 (specifically, their surfaces) all include stainless steel SUS304, and have a surface roughness Rz (maximum height) ranging from 0.15 μm to 0.3 μm.

The arrangement of the five rod-shaped support members 2321 to 2325 will be described with reference to FIG. 7. As illustrated in FIG. 7, the sample 10S is placed on the five support members 2321 to 2325. Hereinafter, the five support members 2321 to 2325 will be referred to as a “first support member 2321”, a “second support member 2322”, a “third support member 2323” (having a slit 232A), a “fourth support member 2324”, and a “fifth support member 2325” (nearest to a weight 233) arranged from the fixing portion 231 side. The five first to fifth support members 2321 to 2325 all have a diameter of 7 mm. A distance d1 between the first support member 2321 and the second support member 2322 (specifically, a distance between the central axes of these support members) is 20 mm. A distance d2 between the second support member 2322 and the third support member 2323 is 30 mm. A distance d3 between the third support member 2323 and the fourth support member 2324 is 30 mm. A distance d4 between the fourth support member 2324 and the fifth support member 2325 is 20 mm.

Furthermore, the second support member 2322, the third support member 2323, and the fourth support member 2324 are arranged such that a portion of the sample 10S placed on these three support members 2322 to 2324 forms a plane approximately perpendicular to the direction of gravity. Furthermore, the first support member 2321 and the second support member 2322 are arranged such that the sample 10S forms an angle of θ1=30° with respect to the approximately perpendicular plane between the first support member 2321 and the second support member 2322. Furthermore, the fourth support member 2324 and the fifth support member 2325 are arranged such that the sample 10S forms an angle of θ2=30° with respect to the approximately perpendicular plane between the fourth support member 2324 and the fifth support member 2325. Among the five first to fifth support members 2321 to 2325, the third support member 2323 is fixed to prevent rotation, but the other four first, second, fourth, and fifth support members 2321, 2322, 2324, and 2325 are rotatable. Since the support member 2323 is fixed to prevent rotation as described above, to reduce friction between the support 2323 and the sample 10S, the contact angle between the support 2323 and the sample 10S is made shallower.

The sample 10S is held on the support members 2321 to 2325 to prevent movement of the sample 10S in the width direction. Note that, among the support members 2321 to 2325, the support member 2323 located between a light emitter 234 and a light receiver 235 and located approximately at the center between the fixing portion 231 and a load-applying portion has the slit 232A. Light L is emitted from the light emitter 234 to the light receiver 235 through the slit 232A. The slit 232A has a slit width of 1 mm, and the light L can pass through the slit 232A without being blocked by the frame of the slit 232A.

Subsequently, after the measuring device is placed in a chamber with a room temperature environment (temperature: 25° C., relative humidity: 50% RH), the weight 233 for applying a load of 0.55 N per ½ inch of width of the sample 10S is attached to the other end of the sample 10S. That is, the load applied to the sample 10S is set to 0.55 N in a case where the width is ½ inch, and a load proportional to the width is set in a case where the width is not ½ inch. After attaching the weight 233, the sample 10S is left in the room temperature environment for 30 minutes. After being left for 30 minutes, the temperature in the chamber is increased, and the measurement of the width of the sample 10S starts upon reaching the specified environment (temperature: 50° C., relative humidity: 40% RH) in the chamber. The measurement of the width of the sample 10S continues for more than 40 hours from its start while maintaining the chamber in the specified environment (temperature: 50° C., relative humidity: 40% RH).

The measuring device emits the light L from the light emitter 234 toward the light receiver 235 with the load of 0.55 N applied in the specified environment to measure the width of the sample 10S to which the load is applied in the longitudinal direction. The width is measured with the sample 10S in a non-curled state. The light emitter 234 and the light receiver 235 are provided in the digital dimension measuring instrument LS-7000.

Next, using the measurement result of the width of the sample 10S acquired as described above, the absolute value of the width variation ΔA of the sample 10S after a lapse of 40 hours from the start of the measurement is calculated with reference to the width of the sample 10S after a lapse of 1 hour from the start of the measurement (that is, after a lapse of 1 hour from reaching the specified environment in the chamber). That is, an absolute value of the width variation ΔA of the sample 10S is obtained by subtracting the width of the sample 10S after a lapse of 1 hour from the width of the sample 10S after a lapse of 40 hours. The sign of the width variation ΔA of the sample 10S indicates the direction of the width variation. A positive width variation DA indicates that the width of the sample 10S has varied in an increasing direction, and a negative width variation ΔA indicates that the width of the sample 10S has varied in a decreasing direction. Next, the absolute value of the average width variation ΔA of the magnetic tape T is obtained by calculating the arithmetic mean of the absolute values of the width variations ΔA of the three samples 10S calculated as described above.

### (Average Thickness (Average Total Thickness) t_{T} of Magnetic Recording Medium)

The average thickness t_{T} of the magnetic recording medium 10 (hereinafter also referred to as magnetic tape T) is obtained as follows. First, for example, the magnetic tape T contained in a cartridge such as the cartridge 10A to be described later is unwound and is cut to a length of 250 mm at a position 30 m in the longitudinal direction from the connection portion 221 between the magnetic tape T and the leader tape LT to prepare a sample. Next, the thickness of the sample is measured at five points using a laser hologauge (LGH-110C) manufactured by Mitutoyo Corporation as a measuring device, and the average (arithmetic mean) of the measured values is simply calculated to obtain the average thickness t_{T} [μm]. Note that the above-described five measurement positions are randomly selected from the sample so as to be different points in the longitudinal direction of the magnetic tape T.

### (Average Thickness of Underlayer (Non-Magnetic Layer))

The average thickness of the underlayer 12 is obtained as follows. First, for example, the magnetic tape T contained in a cartridge such as the cartridge 10A to be described later is unwound and is cut to a length of 250 mm at three positions 10 m, 30 m, and 50 m in the longitudinal direction from the connection portion 221 between the magnetic tape T and the leader tape LT to prepare three samples. Subsequently, each sample is thin-sectioned using the FIB method or the like. In a case of using the FIB method, as pre-treatment for observing a cross-sectional TEM image to be described below, a carbon layer and a tungsten layer are formed as protective films. The carbon layer is formed on both the magnetic layer 13 side and the back layer 14 side of the magnetic tape T by vapor deposition, and then, the tungsten layer is further formed on the magnetic layer 13 side by vapor deposition or sputtering. The thin sectioning is performed along the longitudinal direction of the magnetic tape T. That is, the thin sectioning forms a cross section parallel to both the longitudinal direction and the thickness direction of the magnetic tape T.

The above-described cross section of each thin-sectioned sample thus obtained is observed under the following conditions using a transmission electron microscope (TEM).
Device: TEM (H9000NAR manufactured by Hitachi, Ltd.)
Acceleration voltage: 300 kV
Magnification: 100,000 times

Next, using the obtained TEM image, the thickness of the underlayer 12 is measured at 10 or more points in the longitudinal direction of the magnetic tape T, and then the simple average (arithmetic mean) of the measured values is calculated to obtain the average thickness (nm) of the underlayer 12.

### (Average Thickness of Base Layer)

The average thickness of the base layer 11 is obtained as follows. First, for example, the magnetic tape T contained in a cartridge such as the magnetic recording cartridge 10A to be described later is unwound and is cut to a length of 250 mm at a position 30 m in the longitudinal direction from the connection portion 221 between the magnetic tape T and the leader tape LT to prepare a sample. In the present specification, the “longitudinal direction” in the case of the “longitudinal direction from the connection portion between the magnetic tape T and the leader tape LT” refers to a direction from one end adjacent to the leader tape LT toward the other end.

Subsequently, the layers other than the base layer 11 of the sample (that is, the non-magnetic layer (underlayer) 12, the magnetic layer 13, and the back layer 14) are removed with a solvent such as methyl ethyl ketone (MEK) or dilute hydrochloric acid. Next, the thickness of the sample (base layer 11) is measured at five positions using a laser hologauge (LGH-110C) manufactured by Mitutoyo Corporation as a measuring device, and the simple average (arithmetic mean) of the measured values is calculated to obtain the average thickness of the base layer 11. Note that the above-described five measurement positions are randomly selected from the sample so as to be different points in the longitudinal direction of the magnetic tape T.

### (Average Thickness t_{b} of Back Layer)

The average thickness t_{b} of the back layer 14 is obtained as follows. First, the average thickness (average total thickness) t_{T} of the magnetic tape T is measured. The method for measuring the average thickness t_{T} (average total thickness) is as described above. Subsequently, for example, the magnetic tape T contained in a cartridge such as the cartridge 10A is unwound and is cut to a length of 250 mm at a position 30 m in the longitudinal direction from the connection portion 221 between the magnetic tape T and the leader tape LT to prepare a sample. Next, the back layer 14 of the sample is removed with a solvent such as methyl ethyl ketone (MEK) or dilute hydrochloric acid. Next, the thickness of the sample is measured at five positions using a laser hologauge (LGH-110C) manufactured by Mitutoyo Corporation, and the simple average (arithmetic mean) of the measured values is calculated to obtain the average thickness t_{B} [μm]. Thereafter, the average thickness t_{b}[μm] of the back layer 14 is obtained by the following equation. Note that the above-described five measurement positions are randomly selected from the sample so as to be different points in the longitudinal direction of the magnetic tape T.

$${t}_{b} [ μm ] = {t}_{T} [ μm ] - {t}_{B} [ μm ]$$

### (Average Thickness tₘ of Magnetic Layer)

The average thickness tₘ of the magnetic layer 13 is obtained as follows. First, for example, the magnetic tape T contained in a cartridge such as the cartridge 10A is unwound and is cut to a length of 250 mm at three positions 10 m, 30 m, and 50 m in the longitudinal direction from the connection portion 221 between the magnetic tape T and the leader tape LT to prepare three samples. Subsequently, each sample is thin-sectioned using the FIB method or the like. In a case of using the FIB method, as pre-treatment for observing a cross-sectional TEM image to be described below, a carbon layer and a tungsten layer are formed as protective films. The carbon layer is formed on both the magnetic layer 13 side and the back layer 14 side of the magnetic tape T by vapor deposition, and then, the tungsten layer is further formed on the magnetic layer 13 side by vapor deposition or sputtering. The thin sectioning is performed along the longitudinal direction of the magnetic tape T. That is, the thin sectioning forms a cross section parallel to both the longitudinal direction and the thickness direction of the magnetic tape T.

The above-described cross section of each thin-sectioned sample thus obtained is observed under the following conditions using a transmission electron microscope (TEM). Note that the magnification and acceleration voltage may be appropriately adjusted according to the type of the device.
Device: TEM (H9000NAR manufactured by Hitachi, Ltd.)
Acceleration voltage: 300 kV
Magnification: 100,000 times

Next, the thickness of the magnetic layer 13 is measured at 10 positions of each thin-sectioned sample using the TEM image of each thin-sectioned sample thus obtained. Note that 10 measurement positions of each thin-sectioned sample are randomly selected from the sample so as to be different points in the longitudinal direction of the magnetic tape T. An average value obtained by calculating the simple average (arithmetic mean) of the measured values (thicknesses of the magnetic layer 13 at 30 positioned in total) of each thin-sectioned sample is defined as the average thickness tₘ [nm] of the magnetic layer 13.

### (Squareness Ratio Rs1 in Longitudinal Direction)

A squareness ratio Rs1 of the magnetic tape T measured in the longitudinal direction is preferably 35% or less, more preferably 30% or less, still more preferably 25% or less, particularly preferably 20% or less, and most preferably 15% or less. When the squareness ratio Rs1 is 35% or less, the vertical orientation of the magnetic powder is sufficiently high, achieving a better SNR. Therefore, better electromagnetic conversion characteristics can be obtained. Furthermore, the servo signal shape is improved, making control on the drive side easier.

The squareness ratio Rs1 of the magnetic tape in the longitudinal direction is obtained as follows. First, the magnetic tape contained in the cartridge is unwound and is cut into six pieces at positions 30 m to 40 m in the longitudinal direction from one end of the magnetic tape on the outer circumferential side. At this time, marking is performed with an arbitrary ink having no magnetism so that the longitudinal direction (traveling direction) of the magnetic tape can be recognized. Next, three cut pieces of the magnetic tape are layered together with a double-sided tape such that the longitudinal directions of the three cut pieces are the same, and then punched out with a D6.39 mm punch to prepare a measurement sample. Next, an M-H loop of the measurement sample (the entire magnetic tape) along the longitudinal direction of the magnetic tape (the longitudinal direction of the magnetic tape) is measured using a vibrating sample magnetometer (VSM). Next, the coating films (the underlayer, the magnetic layer, the back layer, and the like) of the remaining three cut pieces of the magnetic tape are removed with acetone, ethanol, or the like to leave only the base layer. Then, the obtained three pieces of the base layer are layered together with a double-sided tape, and then punched out with a φ6.39 mm punch to prepare a background correction sample (hereinafter, simply referred to as a “correction sample”). Thereafter, an M-H loop of the correction sample (base layer) along the longitudinal direction of the base layer (the longitudinal direction of the magnetic tape) is measured using a VSM.

In the measurement of the M-H loop of the measurement sample (the entire magnetic tape) and the M-H loop of the correction sample (base layer), a highly sensitive vibrating sample magnetometer “VSM-P7-15” manufactured by Toei Industry Co., Ltd. is used. The measurement conditions are as follows: measurement mode: full loop, maximum magnetic field: 15 kOe, magnetic field step: 40 bits, time constant of locking amp: 0.3 sec, waiting time: 1 sec, and MH average number: 20.

After the M-H loop of the measurement sample (the entire magnetic tape) and the M-H loop of the correction sample (base layer) are obtained, background correction is performed by subtracting the M-H loop of the correction sample (base layer) from the M-H loop of the measurement sample (the entire magnetic tape), and an M-H loop after the background correction is obtained. For the calculation of the background correction, a measurement/analysis program included with “VSM-P7-15” is used. Note that it is assumed that both M-H loops described above are measured at 25° C.+2° C. and 50% RH±5% RH. Furthermore, it is assumed that “demagnetizing field correction” in measuring the M-H loop in the longitudinal direction of the magnetic tape is not performed. Furthermore, depending on the sensitivity of the VSM in use, a plurality of samples may be layered together for M-H loop measurement.

The squareness ratio Rs1(%) is calculated by substituting saturation magnetization Ms (emu) and residual magnetization Mr (emu) of the obtained M-H loop after the background correction into the following equation. Note that for this calculation, the measurement and analysis program included with “VSM-P7-15” is used.

$$Squareness ratio Rs 1 ( \% ) = ( Mr / Ms ) \times 100$$

### (4) Method for Manufacturing Magnetic Recording Medium

Next, a method for manufacturing the magnetic recording medium 10 having the above-described configuration will be described. First, an underlayer (non-magnetic layer) forming coating material is prepared by kneading and/or dispersing non-magnetic powder, a binder, and the like in a solvent. Next, a magnetic layer forming coating material is prepared by kneading and/or dispersing magnetic powder, non-magnetic particles, a binder, and the like in a solvent. For the preparation of the magnetic layer forming coating material and the underlayer (non-magnetic layer) forming coating material, for example, the following solvent, dispersing device, and kneading device can be used.

Examples of the solvent used for preparing the above-described coating materials include: ketone-based solvents such as acetone, methyl ethyl ketone, methyl isobutyl ketone, and cyclohexanone; alcohol-based solvents such as methanol, ethanol, and propanol; ester-based solvents such as methyl acetate, ethyl acetate, butyl acetate, propyl acetate, ethyl lactate, and ethylene glycol acetate; ether-based solvents such as diethylene glycol dimethyl ether, 2-ethoxyethanol, tetrahydrofuran, and dioxane; aromatic hydrocarbon-based solvents such as benzene, toluene, and xylene; and halogenated hydrocarbon-based solvents such as methylene chloride, ethylene chloride, carbon tetrachloride, chloroform, and chlorobenzene. One of the above solvents may be used, or a mixture of two or more of the solvents may be used.

As the kneading device used for preparing the above-described coating materials, for example, kneading devices such as a continuous twin-screw kneader, continuous twin-screw kneader capable of performing dilution in multi-stages, a kneader, a pressure kneader, and a roll kneader can be used, but the kneading device is not particularly limited to these devices. Furthermore, as the dispersing device used for preparing the above-described coating materials, for example, dispersing devices such as a bead mill, a roll mill, a ball mill, a horizontal sand mill, a vertical sand mill, a spike mill, a pin mill, a tower mill, a pearl mill (for example, “DCP mill” manufactured by Nippon Eirich Co., Ltd.), a homogenizer, and an ultrasonic dispersion machine can be used, but the dispersing device is not particularly limited to these devices.

Next, the underlayer forming coating material is applied to one of the primary surfaces of the base layer 11 and dried to form the underlayer 12. Subsequently, the magnetic layer forming coating material is applied onto the underlayer 12 and dried to form the magnetic layer 13 on the non-magnetic layer 12.

The thickness and/or position of the portion where the chlorine count is greater than or equal to the following threshold can be adjusted by the method for forming the magnetic layer and/or the under layer and/or through the adjustment of the composition of the magnetic layer forming coating material and/or the underlayer forming coating material.

For example, the thickness and/or position of the portion where the chlorine count is greater than or equal to the following threshold can be adjusted, for example, by adjusting the drying temperatures of the magnetic layer forming coating material and/or the underlayer forming coating material. For example, by lowering the drying temperature, the thickness can be further increased, and on the contrary, by increasing the drying temperature, the thickness can be positioned on the base layer side and further reduced.

Furthermore, the thickness and/or position of the portion can be adjusted by modifying the non-magnetic powder contained in the underlayer forming coating material with a surface modifier. For example, the amount of the binder adsorbed onto the non-magnetic powder can be adjusted through the modification with the surface modifier. Examples of the modifier include polycarboxylic acid. By increasing the adsorption amount, the thickness can be further reduced.

Furthermore, the thickness and/or position of the portion can be adjusted by adjusting the time from the drying of the underlayer forming coating material to the application of the magnetic layer forming coating material. For example, by increasing the time, the binder exhibits reduced mobility in the underlayer during the application of the magnetic layer forming coating material, and the thickness further increases. On the other hand, by reducing the time, the binder exhibits increased mobility in the underlayer during the application of the magnetic layer forming coating material, and the thickness can be positioned on the base layer side and further reduced.

Furthermore, the thickness of the portion can also be adjusted by the concentration of solid content in the magnetic layer forming coating material and/or the underlayer forming coating material. For example, when the concentration of solid content in the magnetic layer forming coating material is high, the amount of solvent that penetrates into the underlayer during the application of the magnetic layer forming coating material decreases, and the thickness of the portion increases. On the other hand, when the concentration of solid content is low, the thickness of the portion decreases.

Furthermore, the thickness of the portion can also be adjusted by the ratio between the non-magnetic powder and the binder in the underlayer forming coating material. For example, by increasing the amount of binder, the binder that does not adsorb onto the non-magnetic powder increases, and the thickness of the portion increases. On the other hand, by reducing the amount of binder, the thickness of the portion can be reduced.

Note that during drying, the magnetic powder is magnetically oriented in the thickness direction of the base layer 11 by, for example, a solenoid coil. Furthermore, during drying, for example, the magnetic powder may be magnetically oriented in the longitudinal direction (traveling direction) of the base layer 11 by a solenoid coil, and then magnetically oriented in the thickness direction of the base layer 11. Performing such magnetic field orientation treatment allows for a decrease in the ratio Hc2/Hc1 of the vertical holding force “Hc1” to the longitudinal holding force “Hc2”, and the vertical orientation degree of the magnetic powder can be improved. After the magnetic layer 13 is formed, the back layer 14 is formed on the other primary surface of the base layer 11. As a result, the magnetic recording medium 10 is obtained.

The ratio Hc2/Hc1 is set to a desired value by adjusting, for example, the strength of the magnetic field to be applied to the coating film of the magnetic layer forming coating material, the concentration of solid content in the magnetic layer forming coating material, and the drying conditions (drying temperature and drying time) of the coating film of the magnetic layer forming coating material. The strength of the magnetic field to be applied to the coating film is preferably 2 times or more and 3 times or less the holding force of the magnetic powder. Furthermore, in order to further increase the ratio Hc2/Hc1, it is also effective to magnetize the magnetic powder at the stage before the magnetic layer forming coating material enters an orientation device for magnetically orienting the magnetic powder. Note that the methods for adjusting the ratio Hc2/Hc1 may be used individually or in combination of two or more.

Thereafter, the obtained magnetic recording medium 10 is rewound around a large-diameter core and is subjected to curing treatment. Finally, the magnetic recording medium 10 is subjected to calendering treatment and then cut into a predetermined width (for example, ½ inch wide). As a result, the intended elongated magnetic recording medium 10 is obtained.

Next, after the magnetic recording medium 10 is demagnetized as necessary, a plurality of servo patterns adjacent to each other in the width direction of the magnetic recording medium 10 may be written in the magnetic layer 13 of the magnetic recording medium 10. Note that the plurality of servo patterns may be written in the magnetic layer 13 by a plurality of recording units of a servo write head by making the magnetic recording medium 10 travel and individually controlling the temperatures of the plurality of recording units.

### (5) Tape Drive Device

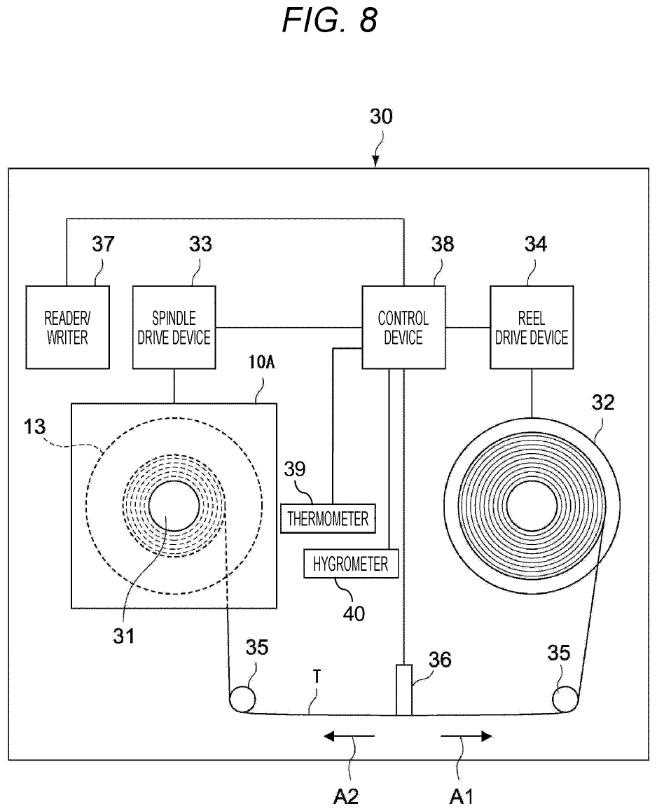

FIG. 8 is a diagram illustrating a tape drive device 30. The tape drive device 30 is a data recording/reproducing device capable of recording data on the magnetic tape T or reproducing data recorded on the magnetic tape T.

As illustrated in FIG. 8, the tape drive device 30 is capable of loading the cartridge 10A. The tape drive device 30 is configured to allow the loading of one cartridge 10A, but may be configured to allow the loading of a plurality of cartridges 10A at the same time.

The tape drive device 30 includes a spindle 31, a take-up reel 32, a spindle drive device 33, a reel drive device 34, a plurality of guide rollers 35, a drive head 36, a reader/writer 37, and a control device 38. The tape drive device 30 may further include a thermometer 39, a hygrometer 40, and the like.

The spindle 31 has a head portion that engages with a chucking gear of a tape reel 13 through an opening 14 formed in a lower shell 11b of the cartridge 10A. The spindle 31 raises the tape reel 13 a predetermined distance against spring force produced by a reel spring 16 to disable the reel lock function of a reel lock member 17. As a result, the tape reel 13 is rotatably supported inside a cartridge case 11 by the spindle 31.

The spindle drive device 33 rotates the spindle 31 in accordance with a command from the control device 38. The take-up reel 32 is capable of securing a tip (leader pin 220) of the magnetic tape T pulled out from the cartridge 10A via a tape loading mechanism (not illustrated).

The plurality of guide rollers 35 guides the travel of the magnetic tape T such that a tape path formed between the cartridge 10A and the take-up reel 32 has a predetermined relative positional relationship with the drive head 36. The reel drive device 34 rotates the take-up reel 32 in accordance with a command from the control device 38.

When recording/reproducing data on/from the magnetic tape T, the spindle drive device 33 and the reel drive device 34 rotate the spindle 31 and the take-up reel 32, respectively, to make the magnetic tape T travel. The magnetic tape T can travel both in a forward direction indicated by an arrow A1 in FIG. 8 (an unwinding direction from the tape reel 13 toward the take-up reel 32) and a reverse direction indicated by an arrow A2 (a winding direction from the take-up reel 32 toward the tape reel 13).

In the present embodiment, tension in the magnetic tape T in the longitudinal direction (X-axis direction) during data recording/reproducing can be adjusted by controlling the rotation of the spindle 31 by the spindle drive device 33 and the rotation of the take-up reel 32 by the reel drive device 34. The adjustment of the tension in the magnetic tape T may be performed through control of the movement of the guide roller 35, a tension control unit including a dancer roller, or the like, instead of (alternatively, in addition to) the control of the rotation of the spindle 31 and the take-up reel 32.

Furthermore, since the tape drive device 30 is configured to enable tension adjustment, it is also possible to accommodate variations in the width dimension of the magnetic tape T due to internal distortion or changes over time. Specifically, the tension is adjusted to be higher than reference tension in a case where the width of the magnetic tape T has varied in an increasing direction, and the tension is adjusted to be lower than the reference tension in a case where the servo band pitch has varied in a decreasing direction. Information regarding the reference tension during servo pattern recording, the width dimension of the magnetic tape T under the reference tension, and the like is stored in a cartridge memory 211.

The reader/writer 37 is capable of recording management information in the cartridge memory 211 in accordance with a command from the control device 38. Furthermore, the reader/writer 37 is capable of reading the management information from the cartridge memory 211 in accordance with a command from the control device 38. Examples of the management information include product information regarding the tape cartridge 10A and the magnetic tape T, usage history information, an overview of information recorded on the magnetic tape T, and the like. The product information includes manufacturing information and unique information such as the number of recording tracks 5 of the magnetic tape T and an ID. The usage history information includes access date and time, address information, communication history with the reader/writer 37, presence or absence of abnormalities during loading/unloading into/from the tape drive device 30, and the like. As a communication method between the reader/writer 37 and the cartridge memory 211, for example, the ISO14443 standard is adopted.

The control device 38 includes, for example, a control unit, a storage unit, a communication unit, and the like. The control unit includes, for example, a central processing unit (CPU) or the like, and centrally controls each unit of the tape drive device 30 in accordance with a program stored in the storage unit.

The storage unit includes a non-volatile memory in which various data and various programs are recorded, and a volatile memory used as a work area of the control unit. The various programs may be read from a portable recording medium such as an optical disc or a semiconductor memory, or may be downloaded from a server device on a network. The storage unit stores transitorily or non-transitorily information read from the cartridge memory 211 by the reader/writer 37, outputs of the thermometer 39 and the hygrometer 40, and the like. The communication unit is capable of communicating with other devices such as a personal computer (PC) and a server device.

The drive head 36 is capable of recording data on the magnetic tape T in accordance with a command from the control device 38. Furthermore, the drive head 36 is capable of reproducing data written on the magnetic tape T in accordance with a command from the control device 38.

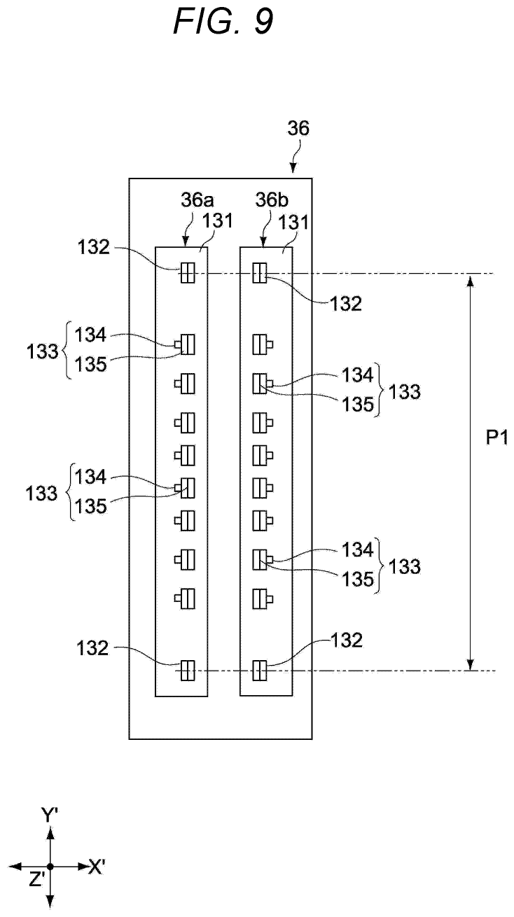

The drive head 36 includes, for example, a head unit including two servo read heads, a plurality of data write/read heads, and the like. FIG. 9 is a diagram schematically illustrating the drive head 36 as viewed from below (tape traveling surface).

As illustrated in FIG. 9, the drive head 36 includes a first drive head unit 36a and a second drive head unit 36b. The first drive head unit 36a and the second drive head unit 36b are arranged symmetrically in an X′-axis direction (the traveling direction of the magnetic tape MT (X-axis direction in FIG. 4)). The first drive head unit 36a and the second drive head unit 36b are movable in a Y′-axis direction (the width direction of the magnetic tape T (Y-axis direction in FIG. 4)).

The first drive head unit 36a is a drive head used when the magnetic tape T is traveling in the forward direction (A1 direction in FIG. 8). On the other hand, the second drive head unit 36b is a drive head used when the magnetic tape T is traveling in the reverse direction (A2 direction in FIG. 8). Since the first drive head unit 36a and the second drive head unit 36b have basically similar configurations, a representative description will be provided with reference to the first drive head unit 36a.

The first drive head unit 36a includes a head body 131, two servo read heads 132, and a plurality of data write/read heads 133.

The servo read head 132 is capable of reproducing a servo signal by reading magnetic flux generated from magnetic information recorded in the servo band s of the magnetic tape T with a magneto resistive (MR) element or the like. That is, the servo read head 132 reproduces the servo signal by reading the servo pattern 6 recorded in the servo band s.

The servo read head 132 is provided at each of both ends in the width direction (Y′-axis direction in FIG. 9) of the head body 131. Examples of the MR element include an anisotropic magneto resistive effect (AMR) element, a giant magneto resistive effect (GMR) element, a tunnel magneto resistive effect (TMR) element, and the like. A servo read head pitch P1 corresponding to an interval in the width direction (Y′-axis direction) between the two servo read heads 132 is set to a central value (2858.8 μm) of the specified distance (servo band pitch) between two adjacent servo bands s of the magnetic tape T.

The data write/read heads 133 are arranged at equal intervals along the width direction (Y′-axis direction). Furthermore, the data write/read heads 133 are arranged between the two servo read heads 132. The number of the data write/read heads 133 is, for example, about 20 to 70, but the number is not particularly limited, and is 32 (32 channels) in the present embodiment.

The data write/read head 133 includes a data write head 134 and a data read head 135. The data write head 134 is capable of recording a data signal in the data band d of the magnetic tape T using a magnetic field generated from the magnetic gap. Furthermore, the data read head 135 is capable of reproducing the data signal by reading a magnetic field generated from the magnetic information recorded in the data band d of the magnetic tape T with an MR element or the like. Examples of the MR element include an anisotropic magneto resistive effect (AMR) element, a giant magneto resistive effect (GMR) element, a tunnel magneto resistive effect (TMR) element, and the like.

In the first drive head unit 36a, each data write head 134 is arranged on the left side of the corresponding data read head 135 (upstream side in a case where the magnetic tape T travels in the forward direction). On the other hand, in the second drive head unit 36b, each data write head 134 is arranged on the right side of the corresponding data read head 135 (upstream side in a case where the magnetic tape T travels in the reverse direction). Note that the data read head 135 can reproduce a data signal immediately after the data write head 134 writes the data signal on the magnetic tape T. Alternatively, the data read head 135 of the second drive head unit 36b may reproduce the data signal written by the data write head 134 of the first drive head unit 36a.

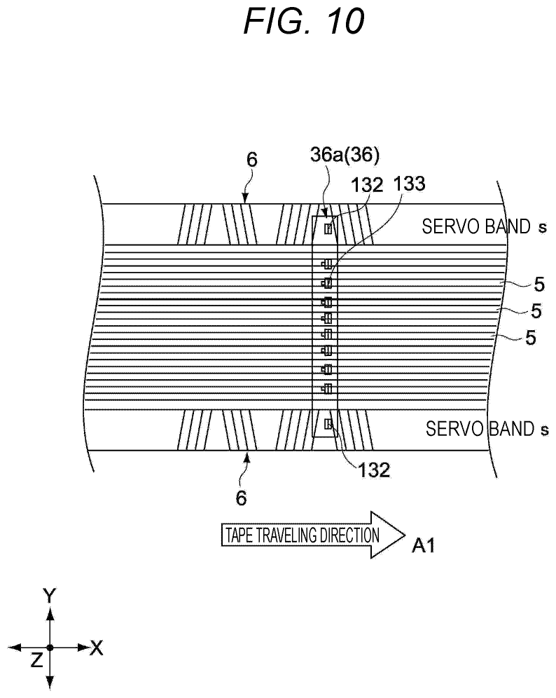

FIG. 10 is a diagram illustrating a state in which the first drive head unit 36a records/reproduces the data signal. Note that the example in FIG. 10 illustrates a state in which the magnetic tape T is traveling in the forward direction (Al direction).

As illustrated in FIG. 10, when the first drive head unit 36a records/reproduces the data signal, one of the two servo read heads 132 is located on one of the two adjacent servo bands s and reads the servo pattern 6 on the servo band s. Furthermore, the other of the two servo read heads 132 is located on the other of the two adjacent servo bands s and reads the servo pattern 6 on the servo band s.

The control device 38 determines whether or not the servo read head 132 is accurately tracing the intended servo trace line TL (see FIG. 6) on the basis of the reproduced waveform of the servo pattern 6.

This principle will be described below. As illustrated in FIG. 6, the first stripe group 61 and the second stripe group 62 in the servo pattern 6 are inclined in opposite directions relative to the width direction (Y-axis direction). Therefore, on the upper servo trace lines TL, a distance in the longitudinal direction (X-axis direction) between the first stripe group 61 and the second stripe group 62 is relatively short. On the other hand, on the lower servo trace lines TL, a distance in the longitudinal direction (X-axis direction) between the first stripe group 61 and the second stripe group 62 is relatively long. Therefore, by obtaining a difference between the time when the reproduced waveform of the first stripe group 61 is detected and the time when the reproduced waveform of the second stripe group 62 is detected, it is possible to identify the current position of the servo read head 132 in the width direction (Y-axis direction) relative to the magnetic tape T.

The control device 38 can therefore determine whether or not the servo read head 132 is accurately tracing the intended servo trace line TL on the basis of the reproduced waveform of the servo pattern 6. Then, in a case where the servo read head 132 is not accurately tracing the intended servo trace line TL, the control device 38 moves the drive head 36 in the width direction (Y′-axis direction) to adjust the position of the drive head 36 or tracking. Note that a method for measuring the servo trace line TL traced by the servo read head 132 will be described later.

Return to FIG. 10, in a case where the magnetic tape T moves in the width direction during traveling, the data write/read head 133 adjusts its position to follow the servo trace line TL and records the data signal in the recording track 5.

When all the magnetic tape T is pulled out of the tape cartridge 10A, the magnetic tape T travels in the reverse direction (A2 direction). At this time, the second drive head unit 36b is used as the drive head 36. The servo trace line TL adjacent to the previously used servo trace line TL is used. In this case, the drive head 36 is moved by the interval Ps between the servo trace lines TL (=recording track width Wd) in the width direction (Y′-axis direction). In this case, the data signal is recorded by the data write head 134 of the second drive head unit 36b in a recording track 5 adjacent to the recording track 5 where the data signal was previously recorded.

As described above, the data signal is recorded in the recording track 5 while the magnetic tape T is moved back and forth in the forward direction and the reverse direction. For example, it is assumed that the number of servo trace lines TL is 100 and the number of data write/read heads 133 included in the first drive head unit 36a (alternatively, the second drive head unit 36b) is 32. In this case, the number of recording tracks 5 included in each data band d is 100×32, that is, 3200, and, to record the data signal inn all the recording tracks 5, the magnetic tape T is moved back and forth 50 times.

### (Servo Pattern)

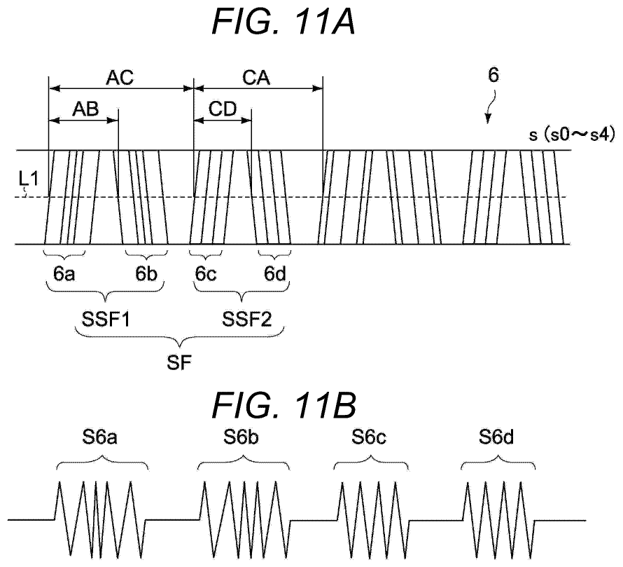

Next, the servo pattern 6 will be described in detail. The servo pattern 6 has a data structure conforming to the “ECMA-319 standard”. FIG. 11(A) is a schematic plan view illustrating an arrangement example of the servo pattern 6, and FIG. 11(B) is a diagram illustrating a reproduced waveform of the servo pattern 6.

In the head tracking servo based on timing servo method, the servo pattern includes a plurality of azimuthal slope patterns with two or more different shapes. The position of the servo read head 132 is recognized on the basis of a time interval between when two inclined patterns with different shapes are read and a time interval between when two inclined patterns with the same shape are read. On the basis of the position of the servo read head 132 thus recognized, the position of the drive head 36 in the width direction (Y-axis direction) of the magnetic tape T is controlled (see FIGS. 9 and 10).

As illustrated in FIG. 11(A), the servo pattern 6 forms a servo frame SF including a first servo subframe SSF1 and a second servo subframe SSF2. The servo frames SF are arranged in the longitudinal direction of the magnetic tape T at predetermined intervals along the tape longitudinal direction. Each servo frame SF encodes a single bit as either “1” or “0”. That is, one servo frame SF corresponds to one bit.

The first servo subframe SSF1 includes an A burst 6a and a B burst 6b. The A burst 6a includes five linear patterns (corresponding to the first stripe group 61 in FIG. 6) inclined in a first direction relative to the tape longitudinal direction, and the B burst 6b includes five linear patterns (corresponding to the second stripe group 62 in FIG. 6) inclined in a second direction, opposite to the first direction, relative to the tape longitudinal direction.

On the other hand, the second servo subframe SSF2 includes a C burst 6c and a D burst 6d. The C burst 6c includes four linear patterns (corresponding to the first stripe group 61 in FIG. 6) inclined in the first direction, and the D burst 6d includes four linear patterns (corresponding to the second stripe group 62 in FIG. 6) inclined in the second direction.

The lengths of the servo frame SF and the servo sub-frames SSF1 and SSF2, the arrangement intervals between the inclined portions of the bursts 6a to 6d, and the like can be set as desired according to the type, specification, and the like of the magnetic tape.

The reproduced waveform of the servo pattern 6 typically shows a burst waveform as shown in FIG. 11 (B), and a signal S6a corresponds to the A burst 6a, a signal S6b corresponds to the B burst 6b, a signal S6c corresponds to the C burst 6c, and a signal S6d corresponds to the D burst 6d.

In the head tracking servo based on timing servo method, the servo pattern 6 on two servo bands adjacent to one data band is read to generate a position error signal (PES), and the recording/reproducing head is appropriately positioned relative to the recording track in the data band. Typically, the servo pattern 6 is read from the magnetic tape T traveling at a predetermined speed, a ratio between a distance (time interval) AC between the A burst 6a and the C burst 6c, which correspond to an array of inclined patterns with similar shapes, and a distance (time interval) AB between the A burst 6a and the B burst 6b, which correspond to an array of inclined patterns with mutually different shapes (alternatively, a ratio between a distance CA between the C burst 6c and the A burst 6a and a distance CD between the C burst 6c and the D burst 6d), is calculated, and the drive head 36 is moved in the tape width direction (Y′-axis direction) such that the ratio equals a value specified for each recording track (see FIG. 10).

### (Identification of Data Band)

In each servo band s (s0 to s4), different combinations of servo band identification information are written for each data band. For example, a combination of servo band identification information obtained from the two servo bands s2 and s3 adjacent to the data band d0 is different from a combination of servo band identification information obtained from the servo bands s1 and s2 adjacent to the data band d1, a combination of the servo band identification information obtained from the servo bands s3 and s4 adjacent to the data band d2, and a combination of the servo band identification information obtained from the two servo bands s0 and s1 adjacent to the data band d3. As described above, differentiating the servo band identification information obtained from two servo bands adjacent to one data band and the servo band identification information obtained from two servo bands adjacent to the other data band enables the identification of each data band.

In the present embodiment, two types of servo bands are used to identify the data bands d0 to d4 to be recorded/reproduced. As described above, the servo band identification information is embedded in the servo band. The servo band identification information is information represented in a plurality of bits and is typically information represented in 4 bits, 8 bits, or a plurality of bits other than 4 bits and 8 bits.

In the present embodiment, the two types of servo bands include a first servo band in which first servo band identification information is recorded and a second servo band in which second servo band identification information is recorded. The first servo band identification information is information represented in 4 bits (for example, “1001”), and the second servo band identification information is information represented in 4 bits (for example, “0111”) different from the first servo band identification information.

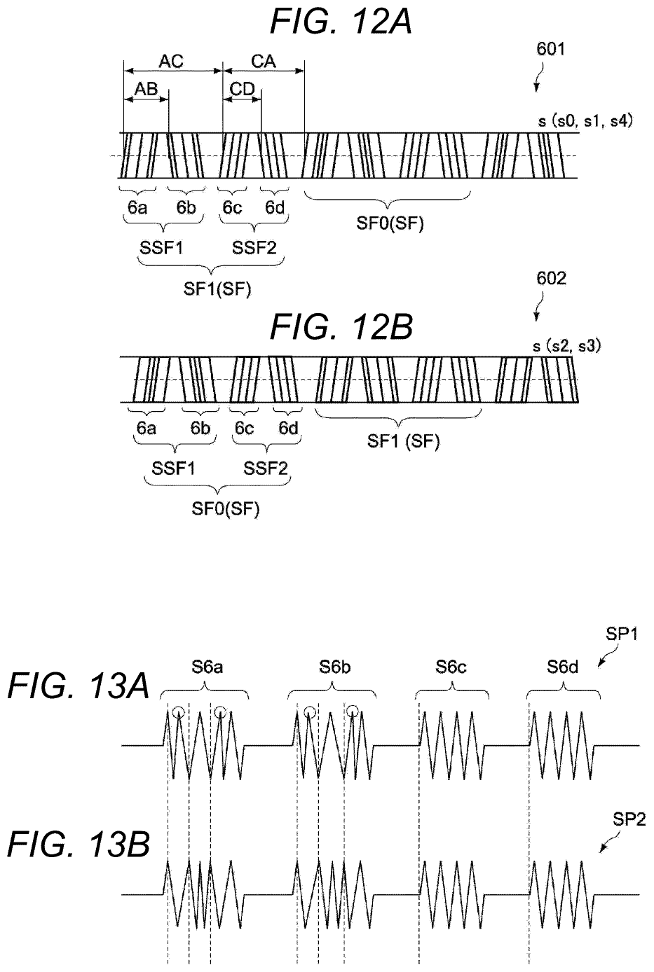

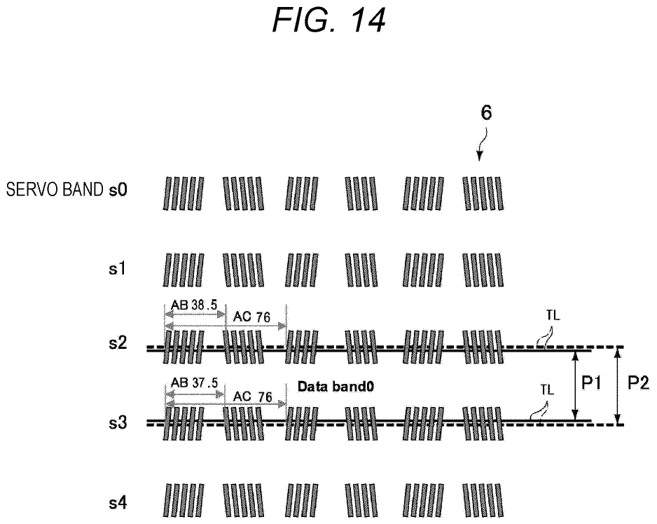

The combination of symbols “0” and “1” constituting the first and second servo band identification information is identified from the reproduced waveform of the servo pattern 6. That is, the reproduced waveform of the servo pattern 6 corresponds to a modulated wave of the symbols “0” and “1”, and the first and second servo band identification information are read by demodulating the reproduced waveform and combining, for example, 4 bits. Hereinafter, the first and second servo band identification information will be described with reference to FIGS. 12 and 13.

FIGS. 12(A) and (B) are schematic diagrams illustrating configuration examples of a servo pattern in which the first servo band identification information is embedded (hereinafter, also referred to as a first servo pattern 601) and a servo pattern in which the second servo band identification information is embedded (hereinafter, also referred to as a second servo pattern 602). As illustrated in the drawings, the first servo pattern 601 and the second servo pattern 602 each include a combination of two types of servo frames SF including a servo frame SF1 representing one symbol (for example, “1”) and a servo frame SF0 representing the other symbol (for example, “0”). The servo frames SF1 and SF0 are structurally identical in that each servo frame includes the servo frame SF including the first servo subframe SSF1 and the second servo subframe SSF2, but include different first servo subframes SSF1 (A bursts 6a and B bursts 6b).

As illustrated in FIG. 12(A), in the servo frame SF1 representing the symbol “1”, when five inclined patterns constituting each of the A burst 6a and the B burst 6b are defined as a first inclined portion, a second inclined portion, a third inclined portion, a fourth inclined portion, and a fifth inclined portion from the left side in the drawing, the second and fourth inclined portions are arranged closer to the first and fifth inclined portions, respectively. On the other hand, as illustrated in FIG. 12(B), in the servo frame SF0 representing the symbol “0”, the arrangement intervals between some of the inclined patterns constituting the A burst 6a and the B burst 6b are different from those of the servo frame SF1. In the illustrated example, in the five inclined patterns constituting each of the A burst 6a and the B burst 6b, the second and fourth inclined portions are arranged closer to the third inclined portion. Therefore, for the A burst 6a and the B burst 6b in the servo frame SF0, the intervals between the second inclined portion and the third inclined portion and the intervals between the third inclined portion and the fourth inclined portion are the smallest, and the intervals between the first inclined portion and the second inclined portion and the intervals between the fourth inclined portion and the fifth inclined portion are the largest.

FIGS. 13(A) and (B) illustrate reproduced waveforms SP1 and SP2 of the first servo pattern 601 and the second servo pattern 602, respectively. The reproduced waveform of each of the servo frames SF1 and SF0 includes burst signals with peak positions corresponding to the inclined portions of each of the burst portions 6a to 6d. As described above, since the configurations of the A burst 6a and the B burst 6b in the servo frame SF0 are different from those of the A burst 6a and the B burst 6b in the servo frame SF1, the peak positions of the burst signals S6a and S6b are shifted according to the intervals between the different inclined portions. Therefore, it is possible to read the information written in the servo frame SF by detecting the portion where the peak positions are shifted, the shift amount, and the shift direction. Here, for example, the servo frame SF1 illustrated in FIG. 13(A) represents one bit “1”, and the servo frame SF0 illustrated in FIG. 13(B) represents the other bit “0”. It is possible to form the first and second servo band identification information by freely combining the two servo frames SF1 and SF0, for example, 4 bits.

### (Method for Measuring Servo Band Pitch)

Next, a method for measuring the servo band pitch of the magnetic tape T will be described. Here, the servo band pitch is an index indicating the distance between two servo bands (servo bands s2, s3) adjacent to one data band (for example, data band d0). More specifically, the servo band pitch refers to a distance between the center of the servo pattern recorded in one of the two servo bands and the center of the servo pattern recorded in the other servo band. Furthermore, in the following description, the servo band pitch may be used as a difference from the servo read head pitch P1 (see FIG. 9). In the present embodiment, an average of differences between two adjacent servo band pitches for the plurality of servo bands over the entire length of the magnetic tape T is 100 nm or less, preferably 95 nm or less, more preferably 90 nm or less, and still more preferably 85 nm or less.

The servo band pitch is measured by the tape drive device 30. Here, as illustrated in FIG. 14, an example in which the drive head 36 tracks the data band d0 positioned between the servo band s2 and the servo band s3 will be described.

As described above, in the method for measuring the servo band pitch using the tape drive device 30, the tape drive device 30 makes the magnetic tape T travel, measures the servo trace line TL on each of the servo bands for the two servo read heads 132, and measures the servo band pitch from a position of each measured servo trace line TL relative to the servo pattern 6.

An interval between the servo trace lines TL indicated by a solid line in FIG. 14 indicates a servo band pitch (servo read head pitch P1 which is an arrangement interval between two servo read heads 132 of the drive head 36) when there is no variation in the width of the magnetic tape T. Furthermore, an interval between the servo trace lines TL indicated by a dashed line in FIG. 14 corresponds to a servo band pitch (P2) when the width of the magnetic tape T increases.

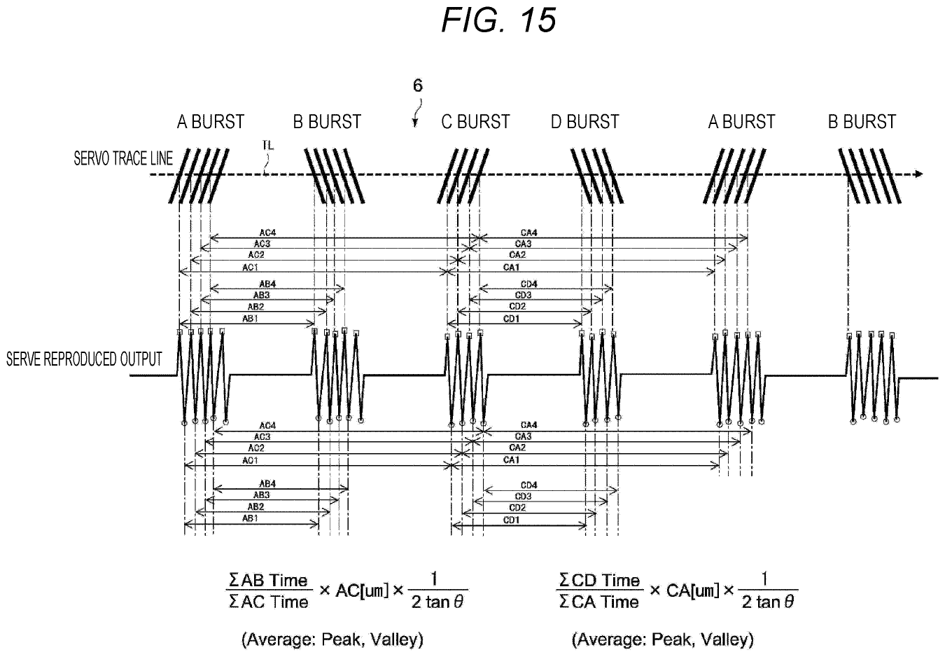

FIG. 15 is a diagram for describing a method for measuring the servo trace line TL. The tape drive device 30 outputs a servo reproduced signal having a waveform corresponding to the position of the servo trace line TL relative to the servo pattern 6 (see FIG. 13). Typically, the distance AC between the A burst and the C burst, which correspond to an array of inclined patterns with similar shapes, and the distance AB between the A burst and the B burst, which correspond to an array of inclined patterns with mutually different shapes, are calculated, and the position of the servo trace line TL for each servo read head 132 is measured by the following [Math. 2]. Note that 0 represents an azimuth angle of each of the inclined patterns corresponding to the angle α in FIG. 6, and is 12° in the present example.

$$\frac{\sum AB Time}{\sum AC Time} \times AC [ um ] \times \frac{1}{2 tan θ} \qquad [ Math . 2 ]$$

Here, the distance AC may be a distance AC1 between the first inclined portions of the A burst and the C burst, a distance AC2 between the second inclined portions, a distance AC3 between the third inclined portions, or a distance AC4 between the fourth inclined portions. These distances AC (AC1 to AC4) refer to a distance between positions (upper peak positions) each indicating the positive maximum amplitude in the servo reproduced waveform.

Similarly, the distance AB may be a distance AB1 between the first inclined portions of the A burst and the B burst, a distance AB2 between the second inclined portions, a distance AB3 between the third inclined portions, or a distance AB4 between the fourth inclined portions. Typically, the distance AB1 is adopted in a case where the distance AC1 is adopted, the distance AB2 is adopted in a case where the distance AC2 is adopted, the distance AB3 is adopted in a case where the distance AC3 is adopted, and the distance AB4 is adopted in a case where the distance AC4 is adopted.

Then, the servo band pitch is obtained from a difference between numerical values representing the positions of the servo trace lines TL on the servo pattern obtained from the ratio between the distance AB and the distance AC calculated using the above [Math. 2]. Here, a difference between the measurement value of the servo band (servo band s2) on the tape center side from the measurement value of the servo band (servo band s3) on the tape edge side of the two servo bands to be measured is obtained. The sign of the value indicates a direction of variations in the tape width, and the positive sign corresponds to a decrease in the servo band pitch, and the negative sign corresponds to an increase in the servo band pitch. A zero difference indicates that the tape width remains unchanged.

The servo band pitch is preferably obtained from differences between a large number of servo frames, and may be, for example, the average of measured values calculated from differences between 100 to 100000 servo frames. As the tape tension during measurement, tension during the recording of the servo pattern 6 (reference tension, e.g., 0.55 N) is used, and measurement is performed under constant tension over the entire length of the magnetic tape T.

Note that the method for measuring the servo trace line TL is not limited to the above example, and for example, after the distance CA between the C burst and the A burst and the distance CD between the C burst and the D burst are calculated, the position of the servo trace line TL may be measured by the following [Math.3].

$$\frac{\sum CD Time}{\sum CA Time} \times CA [ um ] \times \frac{1}{2 tan θ} \qquad [ Math . 3 ]$$

Here, the distance CA may be a distance CA1 between the first inclined portions of the A burst and the C burst, a distance CA2 between the second inclined portions, a distance CA3 between the third inclined portions, or a distance CA4 between the fourth inclined portions. These distances CA (CA1 to CA4) refer to a distance between positions each indicating the positive maximum amplitude in the servo reproduced waveform.

Similarly, the distance CD may be a distance CD1 between the first inclined portions of the C burst and the D burst, a distance CD2 between the second inclined portions, a distance CD3 between the third inclined portions, or a distance CD4 between the fourth inclined portions. Typically, the distance CD1 is adopted in a case where the distance CA1 is adopted, the distance CD2 is adopted in a case where the distance CA2 is adopted, the distance CD3 is adopted in a case where the distance CA3 is adopted, and the distance CD4 is adopted in a case where the distance CA4 is adopted.

Moreover, for the measurement of the servo band pitch, the average of the measurement value using [Math. 2] and the measurement value using [Math. 3] may be used. Furthermore, as the distances AC and AB in [Math. 2] and the distances CA and CD in [Math. 3], a distance between positions (lower peak positions) each indicating the maximum negative amplitude in the servo reproduced waveform may be adopted. Alternatively, as the distances AC and AB in [Math. 2] and the distances CA and CD in [Math. 3], an average of the distance between the positions (upper peak positions) each indicating the positive maximum amplitude and the distance between the positions (lower peak positions) each indicating the negative maximum amplitude in the servo reproduced waveform may be adopted.

As illustrated in FIG. 14, in a case where the servo trace line TL is located at the position indicated by the dashed line, the distance AB is 38.5 μm and the distance AC is 76 μm in the servo band s2, and the distance AB is 37.5 μm and the distance AC is 76 μm in the servo band s3.

In the servo band s2,

$$( 38.5 / 76 ) \times ( 76 / 2 tan 12 ° ) = 90.5641 [ μm ] ,$$

$$in the servo band s 3 ,$$

$$( 37.5 / 76 ) \times ( 76 / 2 tan 12 ° ) = 88.2118 [ μm ] .$$

A difference between these values is:

$$88.2118 - 90.5641 = - 2 \text{.3523} [ μm ] .$$

Therefore, the servo band pitch P2 in this case is obtained as a value greater than the servo read head pitch P1 by 2.3523 μm.

As illustrated in FIG. 14, in a case where the servo trace line TL is located at the position indicated by the solid line, the distance AB is 38 μm and the distance AC is 76 μm in both the servo band s2 and the servo band s3. In this case, both the servo band s2 and the servo band s3, have 89.3880 [μm], and the difference therebetween is 0 [μm]. That is, the servo band pitch in this case is the same as the servo read head pitch P1.

### (Head Azimuth Angle Control)

Furthermore, in the tape drive device 30, the longitudinal direction (Y′-axis direction) of the drive head 36 may be at a predetermined angle θ (azimuth angle θ) with respect to the width direction (Y-axis direction) of the magnetic tape T. The azimuth angle θ of the drive head 36 is adjusted to accommodate variations in the width of the magnetic tape T. Typically, when the magnetic tape T becomes relatively wider, the azimuth angle θ of the drive head 36 is decreased, and, on the other hand, when the magnetic tape T becomes relatively narrower, the azimuth angle θ of the drive head 36 is increased. The control device 38 acquires information regarding the width of the magnetic tape T from a width measurement unit (not illustrated) (alternatively, estimates the width of the magnetic tape T from the servo signal), and adjusts the azimuth angle θ of the drive head 36 using an angle adjustment unit (not illustrated) on the basis of the information regarding the width of the magnetic tape T.

### (6) Configuration of Servo Pattern Recording Device

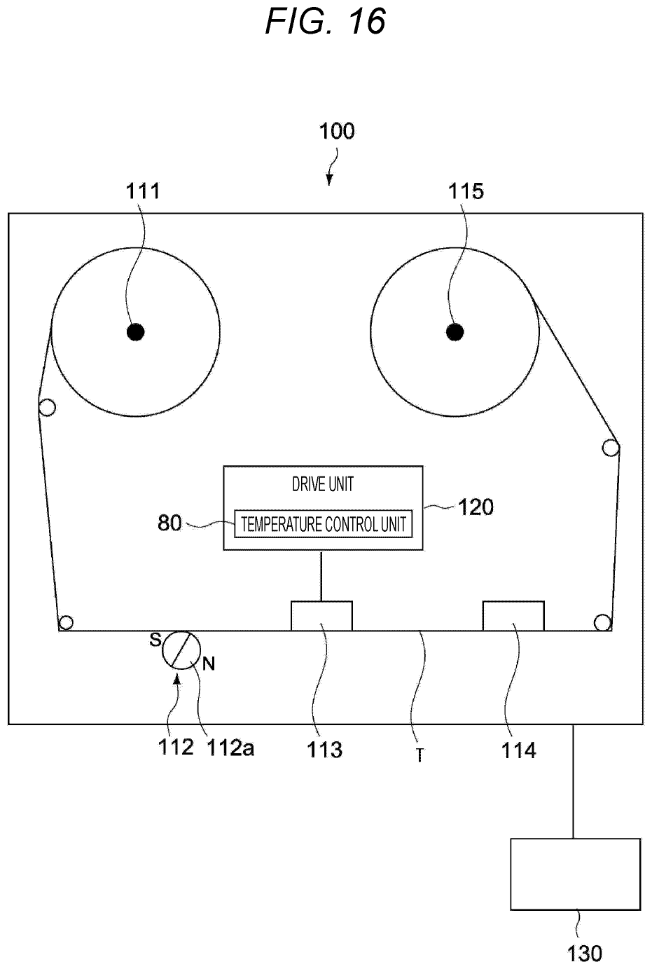

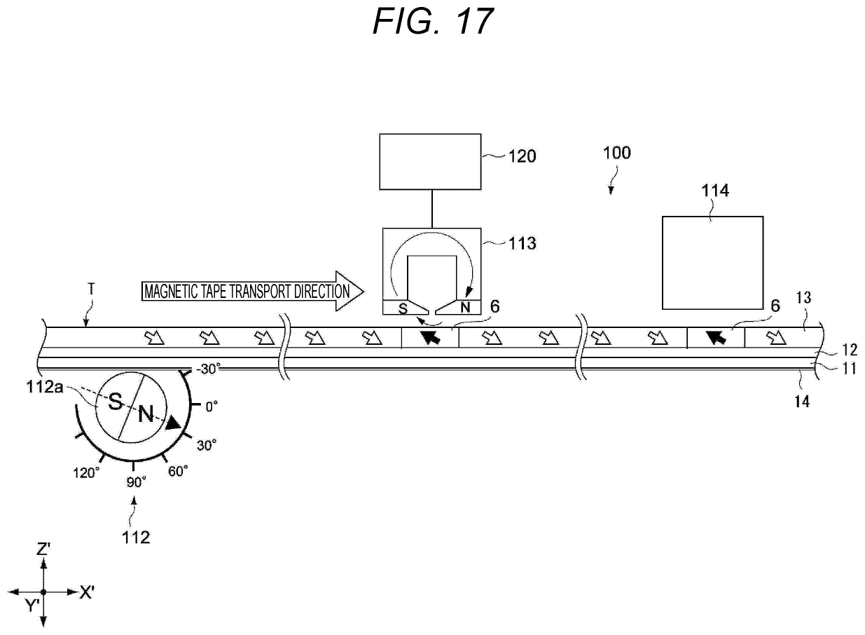

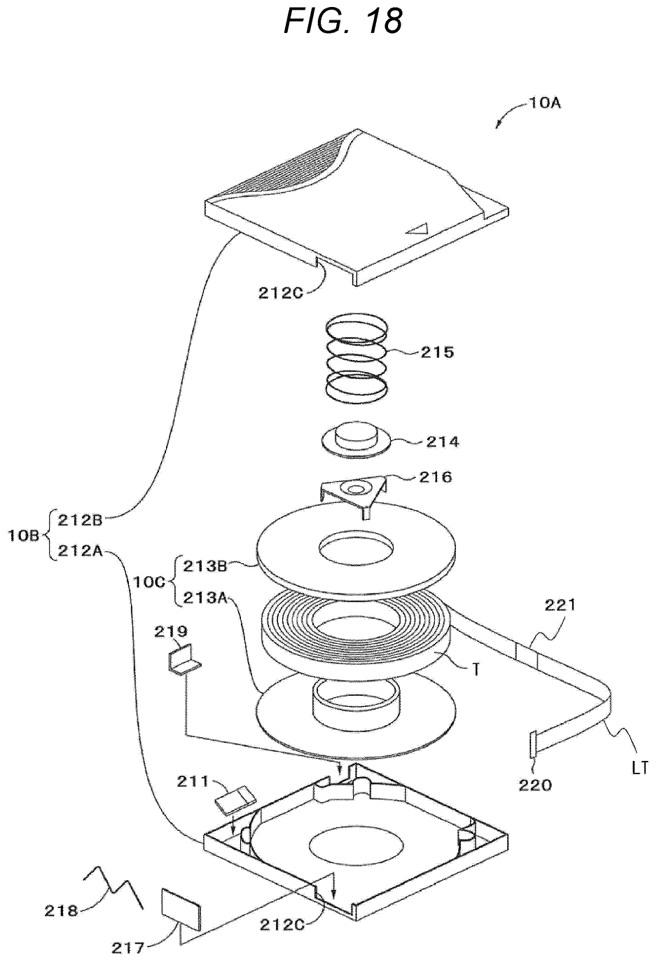

Next, a configuration of the servo pattern recording device that records the servo pattern 6 in the servo band s of the magnetic tape T will be described. FIG. 16 is a schematic front view illustrating a servo pattern recording device 100 according to an embodiment of the present technology. FIG. 17 is a partially enlarged view illustrating a part of the servo pattern recording device 100.

The servo pattern recording device 100 includes a feed roller 111, a pre-treatment unit 112, a servo write head 113, a reproducing head unit 114, and a take-up roller 115 in this order from the upstream side in the transport direction of the magnetic tape T. The servo pattern recording device 100 further includes a drive unit 120 and a controller 130. The controller 130 includes a control unit that centrally controls each unit of the servo pattern recording device 100, a storage unit that stores various programs and data necessary for the control unit to perform processing, a display unit that displays data, an input unit that inputs data, and the like.

The feed roller 111 can rotatably support the roll-shaped magnetic tape T (before the servo pattern 6 is recorded). The feed roller 111 is rotated in response to the drive of a drive source such as a motor and feeds the magnetic tape T toward the downstream side in response to the rotation.

The take-up roller 115 can rotatably support the roll-shaped magnetic tape T (after the servo pattern 6 is recorded). The take-up roller 115 is rotated in synchronization with the feed roller 111 in response to the drive of a drive source such as a motor, and takes up the magnetic tape T on which the servo pattern 6 is recorded in response to the rotation. The feed roller 111 and the take-up roller 115 can move the magnetic tape T at a constant speed on the transport path.

The servo write head 113 is arranged, for example, above (on the magnetic layer 13 side of) the magnetic tape T. The servo write head 113 may be arranged below (on the base layer 11 side of) the magnetic tape T. The servo write head 113 generates a magnetic field at a predetermined timing in response to a rectangular pulse signal, and applies the magnetic field to a part of the magnetic layer 13 (after pre-treatment) included in the magnetic tape T.

As a result, the servo write head 113 magnetizes the part of the magnetic layer 13 in the first direction to record the servo pattern 6 on the magnetic layer 13 (for the magnetization direction, see the black arrow in FIG. 17). The servo write head 113 can record the servo pattern 6 in each of the five servo bands s0 to s4 when the magnetic layer 13 passes under the servo write head 113.

The first direction, which is the magnetization direction of the servo pattern 6, includes a component in a direction perpendicular to the upper surface of the magnetic layer 13. That is, in the present embodiment, since the magnetic layer 13 contains the vertically oriented or unoriented magnetic powder, the servo pattern 6 recorded on the magnetic layer 13 includes a perpendicular magnetization component.

The pre-treatment unit 112 is arranged on the upstream side of the servo write head 113 and below (on the base layer 11 side of) the magnetic tape T, for example. The pre-treatment unit 112 may be arranged above (on the magnetic layer 13 side of) the magnetic tape T. The pre-treatment unit 112 includes a permanent magnet 112a rotatable about the Y′-axis direction (the width direction of the magnetic tape T) in FIG. 13. The shape of the permanent magnet 112a is, for example, a cylindrical shape or a polygonal prism shape, but is not limited to such a shape.

Before the servo pattern 6 is recorded by the servo write head 113, the permanent magnet 112a applies a magnetic field to the entire magnetic layer 13 using a DC magnetic field to demagnetize the entire magnetic layer 13. As a result, the permanent magnet 112a can magnetize the magnetic layer 13 in advance in the second direction opposite to the magnetization direction of the servo pattern 6 (refer to the white arrow in FIG. 17). As described above, by making the two magnetization directions opposite to each other, the servo signal reproduced waveform obtained by reading the servo pattern 6 can be made symmetrical in the vertical direction (+)

Note that, as a method for adjusting the second direction, for example, after the rotation angle of the permanent magnet 112a is set arbitrary, and the servo pattern 6 is recorded on the magnetic layer 13 after the entire magnetic layer 13 is demagnetized, the rotation angle of the permanent magnet 112a about the width direction of the magnetic tape T may be adjusted on the basis of the slope of the reproduced waveform.

The reproducing head unit 114 is arranged on the downstream side of the servo write head 113 and above (the magnetic layer 13 side of) the magnetic tape T. From the magnetic layer 13 of the magnetic tape T that has been subjected to pre-treatment by the pre-treatment unit 112 and on which the servo pattern 6 has been recorded by the servo write head 113, the reproducing head unit 114 reads the servo pattern 6. The reproduced waveform of the servo pattern 6 read by the reproducing head unit 114 is displayed on the screen of the display unit. Typically, the reproducing head unit 114 detects magnetic flux generated from the surface of the servo band s when the magnetic layer 13 passes under the reproducing head unit 114. The magnetic flux detected at this time becomes the reproduced waveform of the servo pattern 6 as a servo signal.

### 3. SECOND EMBODIMENT

### (1) Embodiment of Magnetic Recording Cartridge

The present technology further provides a magnetic recording cartridge (also referred to as a tape cartridge) including the magnetic recording medium according to the present technology. In the magnetic recording cartridge, the magnetic recording medium may be wound around a reel, for example. The magnetic recording cartridge may include, for example, a communication unit that communicates with a recording/reproducing device, a storage unit, and a control unit that stores information received from the recording/reproducing device via the communication unit in the storage unit, reads the information from the storage unit in response to a request from the recording/reproducing device, and transmits the information to the recording/reproducing device via the communication unit. The information may include adjustment information for adjusting the tension applied to the magnetic recording medium in the longitudinal direction.

An example of the configuration of the magnetic recording cartridge 10A including the magnetic recording medium T having the above-described configuration will be described with reference to FIG. 18.

FIG. 18 is an exploded perspective view illustrating an example of the configuration of the magnetic recording cartridge 10A. The magnetic recording cartridge 10A conforms the linear tape-open (LTO) standards, and includes, inside a cartridge case 10B including a lower shell 212A and an upper shell 212B, a reel 10C around which the magnetic tape (tape-shaped magnetic recording medium) T is wound, a reel lock 214 and a reel spring 215 for locking the rotation of the reel 10C, a spider 216 for unlocking the reel 10C in the locked state, a slide door 217 that opens and closes a tape outlet port 212C provided in the cartridge case 10B across the lower shell 212A and the upper shell 212B, a door spring 218 that biases the slide door 217 toward a closed position of the tape outlet port 212C, a write protect 219 for preventing accidental erasure, and a cartridge memory 211. The reel 10C has an approximately disk shape with an opening at its center, and includes a reel hub 213A and a flange 213B, both including a rigid material such as plastic. The magnetic tape T has one end connected to the leader tape LT. A leader pin 220 is provided at a distal end of the leader tape LT.

The cartridge memory 211 is provided in the vicinity of one corner of the magnetic recording cartridge 10A. In a state where the magnetic recording cartridge 10A is loaded in a recording/reproducing device 80, the cartridge memory 211 faces a reader/writer (not illustrated) of the recording/reproducing device 80. The cartridge memory 211 communicates with the recording/reproducing device 30, specifically, the reader/writer (not illustrated) using a wireless communication protocol conforming to the LTO standards.

### (2) Modification of Magnetic Recording Cartridge

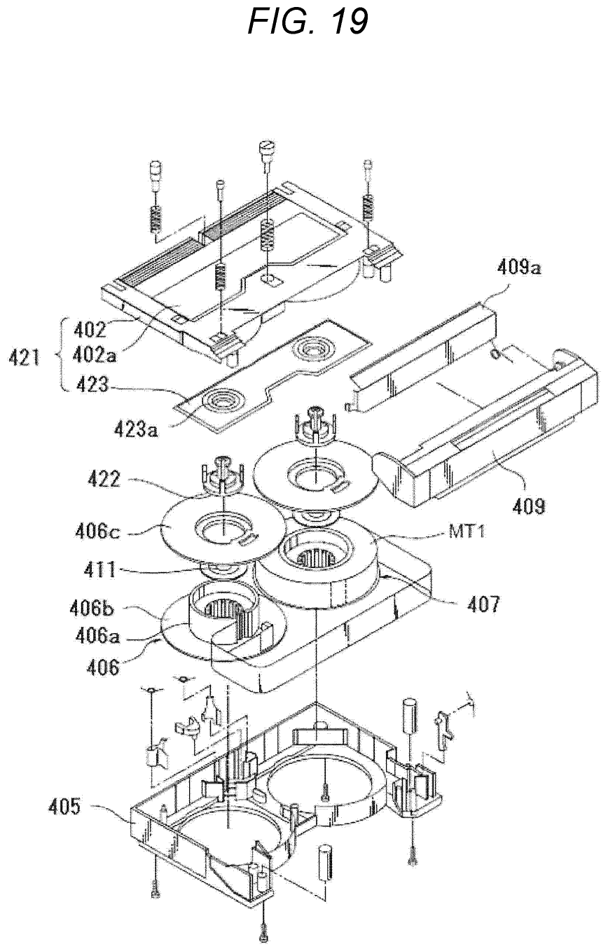

In the above-described embodiment of the magnetic recording cartridge, a case where the magnetic tape cartridge is a one-reel-type cartridge has been described, but the magnetic recording cartridge of the present technology may be a two-reel-type cartridge. That is, the magnetic recording cartridge of the present technology may have one or a plurality of (for example, two) reels around which the magnetic tape is wound. Hereinafter, an example of the magnetic recording cartridge of the present technology having two reels will be described with reference to FIG. 19.

FIG. 19 is an exploded perspective view illustrating an example of a configuration of a two-reel-type cartridge 421. The cartridge 421 includes an upper half 402 including synthetic resin, a transparent window member 423 fitted and fixed to a window portion 402a opened on the upper surface of the upper half 402, a reel holder 422 fixed to the inside of the upper half 402 to prevent reels 406 and 407 from lifting, a lower half 405 corresponding to the upper half 402, the reels 406 and 407 contained in a space formed by combining the upper half 402 and the lower half 405, a magnetic tape MT1 wound around the reels 406 and 407, a front lid 409 closing a front opening formed by combining the upper half 402 and the lower half 405, and a back lid 409A protecting the magnetic tape MT1 exposed on the front opening.

The reel 406 includes a lower flange 406b having a cylindrical hub portion 406a around which the magnetic tape MT1 is wound at its center, an upper flange 406c having approximately the same size as the lower flange 406b, and a reel plate 411 sandwiched between the hub portion 406a and the upper flange 406c. The reel 407 has a configuration similar to that of the reel 406.

The window member 423 is provided with attachment holes 423a for assembling the reel holder 422, which is a reel holding means that prevents the reels from lifting, at positions corresponding to the reels 406 and 407. The magnetic tape MT1 is similar to the magnetic tape T in the first embodiment.

The present technology may also adopt the following configurations.

[1]

A magnetic recording medium including:
a magnetic layer; an underlayer; and a base layer in this order, in which
the underlayer contains a chlorine-containing binder,
a portion where a chlorine count is greater than or equal to a following threshold in the underlayer has a thickness of 130 nm or less, and
an average width variation of the magnetic recording medium before and after the magnetic recording medium is left for 40 hours in an environment with a temperature of 50° C. and a relative humidity of 40% RH with a tension of 0.55 N applied in a longitudinal direction is less than or equal to 170 ppm.

$$[ Threshold ] = [ average chlorine count in the underlayer ] + 6 \times [ standard deviation obtained in calculating the average chlorine count ]$$

[2]

The magnetic recording medium according to [1], in which the portion greater than or equal to the threshold in the underlayer is located adjacent to the base layer.

[3]

The magnetic recording medium according to [1] or [2], in which the portion greater than or equal to the threshold in the underlayer is located within 200 nm of an interface between the underlayer and the base layer.

[4]

The magnetic recording medium according to any one of [1] to [3], in which the portion greater than or equal to the threshold in the underlayer is located within 130 nm of an interface between the underlayer and the base layer.

[5]

The magnetic recording medium according to any one of [1] to [4], in which the magnetic layer and the underlayer have a combined thickness of 1000 nm or less.

[6]

The magnetic recording medium according to any one of [1] to [5], in which the magnetic layer has a thickness of 80 nm or less.

[7]

The magnetic recording medium according to any one of [1] to [6], in which the underlayer contains non-magnetic powder.

[8]

The magnetic recording medium according to any one of [1] to [7], in which the magnetic recording medium has an average thickness t_{T} of 5.5 μm or less.

[9]

The magnetic recording medium according to any one of [1] to [8], in which the magnetic layer contains magnetic powder.

[10]

The magnetic recording medium according to [9], in which the magnetic powder contains hexagonal ferrite, ε-iron oxide, or Co-containing spinel ferrite.

[11]

A magnetic recording medium including:
a magnetic layer; an underlayer; and a base layer in this order, in which
the underlayer contains a chlorine-containing binder,
a portion where a chlorine count is greater than or equal to a following threshold in the underlayer has a thickness of 12% or less of a thickness of the underlayer, and
an average width variation of the magnetic recording medium before and after the magnetic recording medium is left for 40 hours in an environment with a temperature of 50° C. and a relative humidity of 40% RH with a tension of 0.55 N applied in a longitudinal direction is less than or equal to 170 ppm.

$$[ Threshold ] = [ a verage chlorine count in the underlayer ] + 6 \times [ s tandard deviation obtained in calculating the average chlorine count ]$$

[12]

The magnetic recording medium according to any one of [1] to [11], in which the average width variation is less than or equal to 140 ppm.

[13]

The magnetic recording medium according to any one of [1] to [12], in which the base layer contains polyesters.

[14]

The magnetic recording medium according to [13], in which the polyesters includes at least one selected from the group consisting of polyethylene terephthalate and polyethylene naphthalate.

[15]

The magnetic recording medium according to any one of [1] to [14], in which the base layer has an average thickness of 4.4 μm or less.

[16]

The magnetic recording medium according to any one of [1] to [15], in which the magnetic layer has a squareness ratio of 35% or less in the longitudinal direction of the magnetic recording medium.

[17]

The magnetic recording medium according to any one of [1] to [16], in which the magnetic layer has five or more servo bands.

[18]

The magnetic recording medium according to any one of [1] to [17], in which the magnetic layer is configured to allow formation of a plurality of data tracks, and each of the data tracks has a width of 1200 nm or less.

[19]

A magnetic recording cartridge including the magnetic recording medium according to any one of [1] to [18], the magnetic recording medium being wound around a reel and contained in a case.

### 4. EXAMPLES

Hereinafter, the present technology will be specifically described with reference to examples, but the present technology is not limited to these examples. Note that various parameters values appearing in the examples are obtained by the measurement methods described above unless otherwise specified.

A magnetic tape was obtained as described in the following Examples 1 to 4 and Comparative Example 1 to 4.

### Example 1

### (Process of Preparing Magnetic Layer Forming Coating Material)

A magnetic layer forming coating material was prepared as follows. First, a first composition having the following formulation was kneaded with an extruder. Next, the kneaded first composition and a solvent were added to a stirring tank equipped with a disper, and premixing was performed. Subsequently, a second composition and a third composition having the following formulations were added, dyno mill mixing was performed, and filter treatment was performed to prepare the magnetic layer forming coating material.

### (First Composition)

Barium ferrite (BaFe₁₂O₁₉) magnetic powder (hexagonal plate shape, average aspect ratio 2.6, average particle volume 1200 nm³): 100 parts by mass
Vinyl chloride-based resin (cyclohexanone solution 30% by mass): 15 parts by mass
(Degree of polymerization 300, Mn=10000, containing OSO₃K=0.07 mmol/g, and secondary OH=0.3 mmol/g as a polar group)
Polyurethane resin (resin solution: blending amount of polyurethane resin 30% by mass, blending amount of cyclohexanone 70% by mass): 40 parts by mass
(Polyurethane resin: number average molecular weight Mn=25000, Tg 110° C.)
Citric acid: 3 parts by mass
Methyl ethyl ketone: 130.0 parts by mass
Toluene: 130.0 parts by mass
Cyclohexanone: 170.0 parts by mass

### (Second Composition)

Aluminum oxide powder: 3.0 parts by mass (α-Al₂O₃, average particle size 0.1 μm)
Vinyl chloride-based resin (cyclohexanone solution 30% by mass): 3.0 parts by mass
(Degree of polymerization 300, Mn=10000, containing OSO₃K=0.07 mmol/g, and secondary OH=0.3 mmol/g as a polar group)
Cyclohexanone: 10.0 parts by mass
Mixing for 10 hours using paint shaker

### (Third Composition)

Carbon black: 2.0 parts by mass (manufactured by Tokai Carbon Co., Ltd., trade name: SEAST S, arithmetic mean particle size 70 nm)
Vinyl chloride-based resin (cyclohexanone solution 30% by mass): 4.0 parts by mass
(Degree of polymerization 300, Mn=10000, containing OSO₃K=0.07 mmol/g, and secondary OH=0.3 mmol/g as a polar group)
Cyclohexanone: 18.5 parts by mass
Mixing for 10 hours using paint shaker

Finally, 1.8 parts by mass of polyisocyanate (trade name: Coronate L, manufactured by TOSOH CORPORATION) as a curing agent and 2.0 parts by mass of stearic acid were added to the magnetic layer forming coating material prepared as described above.

### (Process of Preparing Underlayer Forming Coating Material)

First, a fourth composition having the above formulation was kneaded with an extruder. Next, the kneaded fourth composition and a fifth composition having the following formulation were added to a stirring tank equipped with a disper, and premixing was performed. Subsequently, mixing was further performed using a bead mill ECM-PRO (SHINMARU ENTERPRISES CORPORATION) at a circulation flow rate of 500 L/h to 2000 L/h for a duration of in-bead mill treatment of 30 to 150 minutes, and filter treatment was performed to prepare the underlayer forming coating material.

### (Fourth Composition)

Acicular iron oxide powder: 100 parts by mass
(α-Fe₂O₃, average major axis length 0.15 μm)
Aluminum oxide powder: 5.0 parts by mass
(α-Al₂O₃, average particle diameter: 80 nm, trade name: HIT82, manufactured by Sumitomo Chemical Co., Ltd., Mohs hardness: 9)
Vinyl chloride-based resin: 50.6 parts by mass
(Resin solution: resin content 30% by mass, cyclohexanone 70% by mass)

### (Fifth Composition)

Carbon black: 30 parts by mass
(Average particle size 20 nm)
Polyurethane resin (resin solution: blending amount of polyurethane resin 30% by mass, blending amount of cyclohexanone 70% by mass): 50 parts by mass
n-butyl stearate: 2.0 parts by mass
Methyl ethyl ketone: 150.0 parts by mass
Toluene: 150.0 parts by mass
Cyclohexanone: 125.0 parts by mass

Finally, polyisocyanate (trade name: Coronate L, manufactured by TOSOH CORPORATION): 3.0 parts by mass as a curing agent and stearic acid: 2 parts by mass were added to the underlayer forming coating material prepared as described above.

### (Process of Preparing Back Layer Forming Coating Material)

A back layer forming coating material was prepared as follows. The following raw materials were mixed in a stirring tank equipped with a disper, and filter treatment was performed to prepare the back layer forming coating material. Carbon black (trade name: #80, manufactured by Asahi Carbon Co., Ltd.): 100.0 parts by mass
Polyester polyurethane: 150 parts by mass
(Resin solution: blending amount of polyurethane resin 30% by mass, blending amount of cyclohexanone 70% by mass)
(Trade name: N-2304, manufactured by Nippon Polyurethane Industry Co., Ltd.)
Methyl ethyl ketone: 500 parts by mass
Toluene: 300 parts by mass
Cyclohexanone: 160 parts by mass
Polyisocyanate (trade name: Coronate L, manufactured by TOSOH CORPORATION): 9 parts by mass

### (Film Forming Process)

A magnetic tape was prepared as described below using the coating materials prepared as described above.

First, as a support acting as the base layer of the magnetic tape, a reinforced PET film (base film) having an elongated shape, an average thickness of 4.00 μm, an average storage modulus of 3.9 GPa in the longitudinal direction at a temperature of 50° C., and an average Young's modulus of 4.6 GPa in the longitudinal direction was prepared. Next, the underlayer forming coating material, the magnetic layer forming coating material, and the back layer forming coating material were applied in this order onto one of the primary surfaces of the reinforced PET film to achieve a final thickness shown in Table 1, and dried. Then, the reinforced PET film on which the underlayer, the magnetic layer, and the back layer were formed was subjected to curing treatment. Thereafter, calendering treatment was performed, and after the calendering treatment, strain relief treatment was performed at 65° C. for 48 hours.

The surface of the magnetic layer was smoothed.

### (Cutting Process)

The magnetic tape obtained as described above was cut into a width of ½ inch (12.65 mm). This resulted in a magnetic tape with an elongated shape.

The magnetic tape having a width of ½ inch was wound around a reel provided in a cartridge case to obtain a magnetic recording cartridge with multiple windings.

A servo signal was recorded on the magnetic tape by a servo track writer. The servo signal includes an array of inverted V-shaped magnetic patterns, and two or more arrays of the magnetic patterns are recorded in advance in parallel in the longitudinal direction at known intervals (hereinafter, referred to as “known intervals between arrays of magnetic patterns when being recorded in advance”).

For the magnetic recording cartridge, as described in the above 2. “(3) Physical properties”, various values related to chlorine distribution such as the chlorine count in the underlayer and the thickness of the portion where the chlorine count is greater than or equal to the threshold were measured. These measurement results are shown in Table 1 below. As shown in the table, the average chlorine count Cₐᵥₑ in the underlayer was 1.100. Furthermore, the standard deviation σ was 0.040. Therefore, the threshold (Cₐᵥₑ+6σ) was 1.340.

The thickness of the portion greater than or equal to the threshold in the underlayer was 85 nm. The portion greater than or equal to the threshold was located in contact with the interface between the underlayer and the base layer, that is, located within a range of 200 nm from the interface.

The ratio of the “thickness of the portion greater than or equal to the threshold” to the “thickness of the underlayer” was 7.6%.

Furthermore, the peak chlorine count number in the magnetic layer (maximum chlorine count in the magnetic layer) Cₘₚ was 6.506, and “the peak chlorine count Cₘₚ in the magnetic layer”/“the average chlorine count Cₐᵥₑ in the underlayer” was 5.91.

For the magnetic recording cartridge, as described in the above 2. “(3) Physical properties”, the average width variation of the magnetic recording medium before and after the magnetic recording medium is left for 40 hours in an environment with a temperature of 50° C. and a relative humidity of 40% RH with a tension of 0.55 N applied in the longitudinal direction was measured. The measurement results are shown in Table 1 below. As shown in the table, the average width variation was −27.7 ppm.

### Example 2

The same magnetic layer forming coating material, underlayer forming coating material, and back layer forming coating material as in Example 1 were used. A magnetic tape was obtained by the same method as in Example 1 except that, by reducing the thicknesses of the magnetic layer and the underlayer and making the drying temperature after the application of the magnetic layer higher than that in Example 1, the volatilization rate of the solvent from the surface of the magnetic layer was increased, by transferring the binder once transferred toward the base layer toward the surface of the magnetic layer together with the volatile solvent, the amount of the binder remaining on the base layer side was reduced, a PEN film having an average thickness of 4.0 μm, an average storage modulus of 5.5 GPa in the longitudinal direction in an environment with a temperature of 50° C., and an average Young's modulus of 6.3 GPa in the longitudinal direction was used as the base layer, and strain relief treatment was further performed at 70° C. for 48 hours after calendering treatment. Furthermore, as in Example 1, a magnetic recording cartridge containing the magnetic tape was obtained.

For the magnetic recording cartridge, various values related to chlorine distribution and the average width variation were measured as in Example 1. The measurement results are shown in Table 1 as in Example 1.

### Example 3

A magnetic tape was obtained by the same method as in Example 1 except that, during the preparation of the underlayer forming coating material, by reducing the duration of in-bead mill treatment to 0.9 times the duration of in-bead mill treatment in Example 1 to slightly degrade the dispersion, the adsorption amount of the binder was reduced, the amount of the binder transferred toward the interface between the underlayer and the base layer due to the solvent penetrating during the application of the magnetic layer forming coating material was increased, and the duration of the strain relief treatment was set to 24 hours. Furthermore, as in Example 1, a magnetic recording cartridge containing the magnetic tape was obtained.

For the magnetic recording cartridge, various values related to chlorine distribution and the average width variation were measured as in Example 1. The measurement results are shown in Table 1 as in Example 1.

### Example 4

A magnetic tape was obtained by the same method as in Example 2 except that the temperature of the strain relief treatment after the calendering treatment was 60° C. Furthermore, as in Example 1, a magnetic recording cartridge containing the magnetic tape was obtained.

For the magnetic recording cartridge, various values related to chlorine distribution and the average width variation were measured as in Example 1. The measurement results are shown in Table 1 as in Example 1.

### Comparative Example 1

A magnetic tape was obtained by the same method as in Example 1 except that, during the preparation of the underlayer forming coating material, by reducing the duration of in-bead mill treatment to 0.8 times the duration of in-bead mill treatment in Example 1 to slightly degrade the dispersion, the adsorption amount of the binder was reduced, the amount of the binder transferred toward the interface between the underlayer and the base due to the solvent penetrating during the application of the magnetic layer forming coating material was increased, a PEN film having an average thickness of 4.0 μm, an average storage modulus of 5.5 GPa in the longitudinal direction in an environment with a temperature of 50° C., and an average Young's modulus of 6.3 GPa in the longitudinal direction was used as the base layer, and no strain relief treatment was performed. Furthermore, as in Example 1, a magnetic recording cartridge containing the magnetic tape was obtained.

For the magnetic recording cartridge, various values related to chlorine distribution and the average width variation were measured as in Example 1. The measurement results are shown in Table 1 as in Example 1.

### Comparative Example 2

A magnetic tape was obtained by the same method as in Example 1 except that the same underlayer forming coating material as in Comparative Example 1 was used, the thicknesses of the magnetic layer and the underlayer were reduced, a reinforced PET film having an average thickness of 4.0 μm, an average storage modulus of 3.9 GPa in the longitudinal direction in an environment with a temperature of 50° C., and an average Young's modulus of 4.6 GPa in the longitudinal direction was used as the base layer, the average thickness of the magnetic layer after the calendering treatment was set to 0.08 μm, the average thickness of the underlayer after the calendering treatment was set to 0.8 μm, and the strain relief treatment was performed at 55° C. for 24 hours. Furthermore, as in Example 1, a magnetic recording cartridge containing the magnetic tape was obtained.

For the magnetic recording cartridge, various values related to chlorine distribution and the average width variation were measured as in Example 1. The measurement results are shown in Table 1 as in Example 1.

### Comparative Example 3

A magnetic tape was obtained by the same method as in Example 1 except that the same underlayer forming coating material as in Comparative Example 1 was used, the drying temperature after the application of the underlayer forming coating material was made lower than that in Comparative Example 1, and a PET film having an average thickness of 4.0 μm, an average storage modulus of 3.9 GPa in the longitudinal direction in an environment with a temperature of 50° C., and an average Young's modulus of 4.7 GPa in the longitudinal direction was used as the base layer. Furthermore, as in Example 1, a magnetic recording cartridge containing the magnetic tape was obtained.

For the magnetic recording cartridge, various values related to chlorine distribution and the average width variation were measured as in Example 1. The measurement results are shown in Table 1 as in Example 1.

### Comparative Example 4

A magnetic tape was obtained by the same method as in Example 2 except that a PET film having an average thickness of 4.0 μm, an average storage modulus of 3.9 GPa in the longitudinal direction in an environment with a temperature of 50° C., and an average Young's modulus of 4.7 GPa in the longitudinal direction was used. Furthermore, as in Example 1, a magnetic recording cartridge containing the magnetic tape was obtained.

For the magnetic recording cartridge, various values related to chlorine distribution and the average width variation were measured as in Example 1. The measurement results are shown in Table 1 as in Example 1.

### [Reliability Evaluation]

Using the magnetic recording cartridges manufactured in Examples 1 to 4 and Comparative Examples 1 to 4, the reliability of the magnetic tape contained in each cartridge was evaluated. The evaluation was performed as follows.

The magnetic recording cartridges of Examples 1 to 4 and Comparative Examples 1 to 4 were inserted into an LTO8 drive immediately after a cleaning tape is made to travel, and one round-trip pass of recording processing was performed after the insertion. This operation was performed on the magnetic recording cartridges with multiple windings of Examples 1 to 4 and Comparative Examples 1 to 4. In a case where the recording processing was sequentially performed on a magnetic recording cartridge with 25 windings (25 round trip-passes), and the recording processing on each winding was completed successfully, the reliability was determined to be “good”.

When Rewrite occurred twice at any point before the completion of the recording processing on the 25 windings, the reliability was determined to be “poor”. Furthermore, the number of windings on which Rewrite occurred twice was also recorded. The evaluation results for each magnetic tape are shown in Table 1 below.

For each of the magnetic recording tapes of Examples 1 to 4 and Comparative Examples 1 to 4, the servo band pitch difference was measured by the measurement method described in the above 2.(5). Furthermore, for each of the magnetic recording tapes of Examples 1 to 4 and Comparative Examples 1 to 4, the estimated width variation after 10 years and the movement angle of the drive head arranged at an angle were calculated. These calculation methods will be described below.

[Method for Calculating Estimated Width Variation after 10 Years]

In accordance with the method for measuring the average width variation ΔA described in the above 2.(3), the width variation 1 hour after the start of width measurement and the width variation 40 hours after the start of width measurement were measured for the three samples acquired from the magnetic tape. The arithmetic mean of the width variations of the three samples after 1 hour was calculated to obtain an average width variation 1 hour after the start of measurement. Furthermore, the arithmetic mean of the width variations of the three samples after 40 hours was calculated to obtain an average width variation 40 hours after the start of measurement. Using a logarithmic time axis X, the width variation after 10 years was estimated through extrapolation from the average width variation 1 hour after the start of measurement (this is defined as an initial value 0) and the average width variation 40 hours after the start of measurement.

### [Method for Calculating Movement Angle of Drive Head Arranged at an Angle]

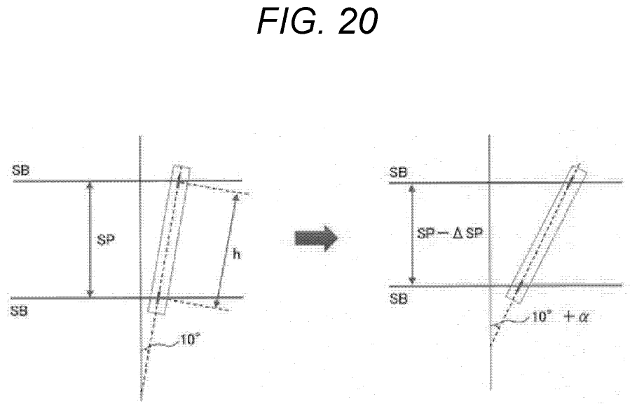

FIG. 20 is a schematic diagram for describing the method for calculating the movement angle of the drive head arranged at an angle. The movement angle refers to a movement angle of the drive head necessary for accommodating the estimated width variation after 10 years.

The left side of FIG. 20 illustrates an interval (h) between two servo read heads of the drive head, a servo band pitch (SP), and a tilt angle (10°) of the drive head in the initial magnetic tape (before width variation). In the left side of FIG. 20, Cos 10°=SP/h.

The right side of FIG. 20 illustrates a servo band pitch (SP−ΔSP), a movement angle (α) of the drive head, and a tilt angle (10°+α) after the movement of the drive head in the magnetic tape after the servo band pitch is reduced (after width variation). In the right side of FIG. 20, Cos(10°+α)=(SP−ΔSP)/h. From this equation, the movement angle (α) of the drive head is calculated as follows.

$$10 ° + α = Cos - 1 [ ( SP - Δ SP ) / h ]$$

$$α = Cos - 1 [ ( SP - Δ SP ) / h ] - 10 °$$

These calculation results are shown in Table 1.

TABLE 1

| | | | | | | | | | | | Proportion |
|---|---|---|---|---|---|---|---|---|---|---|---|
| | | | Total | | | | | | | Thick- | of thick- |
| | | | thick- | | | | | Standard | | ness of | ness of |
| | | | ness of | | | | Average | deviation | | portion | portion |
| | Thick- | Thick- | magnetic | Thick- | Thick- | Total | chlorine | obtained in | | greater | greater |
| | ness of | ness of | layer and | ness | ness | thick- | count in | calculating | Thresh- | than or | than or |
| | magnetic | under- | under- | of base | of back | ness of | under- | average | old | equal to | equal to |
| | layer | layer | layer | layer | layer | tape tₜ | layer | chlorine | (cₐᵥₑ + | threshold | threshold |
| | [nm] | [nm] | [nm] | [μm] | [μm] | [μm] | Cₐᵥₑ | count σ | 6σ) | (nm) | (%) |
| Example 1 | 80 | 1120 | 1200 | 4.00 | 0.30 | 5.50 | 1.100 | 0.040 | 1.340 | 85 | 7.6 |
| Example 2 | 70 | 880 | 950 | 4.00 | 0.30 | 5.25 | 1.071 | 0.039 | 1.305 | 77 | 8.8 |
| Example 3 | 80 | 1120 | 1200 | 4.00 | 0.30 | 5.50 | 1.110 | 0.052 | 1.422 | 121 | 10.8 |
| Example 4 | 70 | 880 | 950 | 4.00 | 0.30 | 5.25 | 1.071 | 0.039 | 1.305 | 77 | 8.8 |
| Compar- | 80 | 1120 | 1200 | 4.00 | 0.30 | 5.50 | 1.161 | 0.063 | 1.539 | 143 | 12.8 |
| ative | | | | | | | | | | | |
| Example 1 | | | | | | | | | | | |
| Compar- | 60 | 640 | 700 | 4.20 | 0.30 | 5.20 | 1.011 | 0.067 | 1.413 | 154 | 24.0 |
| ative | | | | | | | | | | | |
| Example 2 | | | | | | | | | | | |
| Compar- | 80 | 1120 | 1200 | 4.00 | 0.30 | 5.50 | 1.112 | 0.062 | 1.484 | 148 | 13.2 |
| ative | | | | | | | | | | | |
| Example 3 | | | | | | | | | | | |
| Compar- | 70 | 880 | 950 | 4.00 | 0.30 | 5.25 | 1.071 | 0.039 | 1.305 | 77 | 8.8 |
| ative | | | | | | | | | | | |
| Example 4 | | | | | | | | | | | |

| | | | | | | | Movement |
|---|---|---|---|---|---|---|---|
| | | | | | Absolute | | angle of |
| | | | Square- | | value of | | drive head |
| | | Magnetic | ness | 50° C. | estimated | | arranged |
| | | layer | ratio in | Average | width | | at an |
| | | peak | longitu- | width | variation | | angle |
| | | chlorine | dinal | variation | after 10 | Reliability | (initial |
| | | count | direction | ΔA | years | evaluation | angle |
| | Cₘₚ/cₐᵥₑ | Cₘₚ | (%) | (ppm) | (ppm) | result | 10°) |
| Example 1 | 5.91 | 6.506 | 34 | 27.7 | 85.9 | No | 0.028 |
| | | | | | | occurrence | |
| | | | | | | throughout | |
| | | | | | | 25 windings | |
| Example 2 | 7.43 | 7.956 | 32 | 97.7 | 302.9 | No | 0.098 |
| | | | | | | occurrence | |
| | | | | | | throughout | |
| | | | | | | 25 windings | |
| Example 3 | 6.01 | 6.675 | 34 | 138.2 | 428.3 | No | 0.138 |
| | | | | | | occurrence | |
| | | | | | | throughout | |
| | | | | | | 25 windings | |
| Example 4 | 7.43 | 7.956 | 32 | 142.8 | 442.7 | No | 0.143 |
| | | | | | | occurrence | |
| | | | | | | throughout | |
| | | | | | | 25 windings | |
| Compar- | 4.64 | 5.393 | 38 | 220.0 | 682.0 | Second | 0.219 |
| ative | | | | | | Rewrite | |
| Example 1 | | | | | | occurred | |
| | | | | | | on 17^{th} | |
| | | | | | | winding | |
| Compar- | 6.27 | 6.342 | 32 | 180.7 | 560.2 | Second | 0.190 |
| ative | | | | | | Rewrite | |
| Example 2 | | | | | | occurred | |
| | | | | | | on 10^{th} | |
| | | | | | | winding | |
| Compar- | 5.44 | 6.045 | 34 | 206.2 | 639.2 | Second | 0.206 |
| ative | | | | | | Rewrite | |
| Example 3 | | | | | | occurred | |
| | | | | | | on 13^{th} | |
| | | | | | | winding | |
| Compar- | 7.43 | 7.956 | 34 | 198.2 | 614.4 | No | 0.198 |
| ative | | | | | | occurrence | |
| Example 4 | | | | | | throughout | |
| | | | | | | 25 windings | |

As shown in Table 1, for the magnetic tapes of Examples 1 to 4, in a case where the magnetic recording cartridges each having 25 windings undergo one round-trip pass, the second Rewrite did not occur on any of the windings of the magnetic recording cartridges. On the other hand, for the magnetic tapes of Comparative Examples 1 to 3, the second Rewrite occurred on the 17th, 10th, and 13th windings of the magnetic recording cartridge. These results reveal that the magnetic recording medium according to the present technology and the magnetic recording cartridge containing the magnetic recording medium have improved reliability during traveling.

The results shown in Table 1 reveal that the smaller the thickness of the portion where the chlorine count is greater than or equal to the threshold in the underlayer, the higher the reliability during traveling. From the results shown in the table, it is considered that, when the thickness of the portion greater than or equal to the threshold is, for example, 130 nm or less, 125 nm or less, or 123 nm or less, and more preferably 120 nm or less, 110 nm or less, 100 nm or less, or 90 nm or less, the reliability of the magnetic tape during traveling becomes higher.

Furthermore, the results shown in Table 1 further reveal that, the smaller the proportion of the thickness of the portion where the chlorine count is greater than or equal to the threshold in the underlayer, the higher the reliability during traveling. From the results shown in the table, it is considered that, when the proportion of the thickness of the portion greater than or equal to the threshold is, for example, 12% or less, 11.5% or less, or 11% or less, and more preferably 10% or less, 9.5% or less, or 9% or less, the reliability of the magnetic tape during traveling becomes higher.

Furthermore, from the results shown in Table 1, the peak chlorine count Cₘₚ in the magnetic layer is preferably, for example, 6.4 or more, or 6.5 or more. Furthermore, “the peak chlorine count Cₘₚ in the magnetic layer”/“the average chlorine count Cₐᵥₑ in the underlayer” is preferably 5.5 or more, or 5.7 or more, for example.

Furthermore, as shown in Table 1, comparing the results of Examples 1 to 4 with the results of Comparative Examples 1 to 4, it is considered that, when the average width variation ΔA is 170 ppm or less, the movement angle of the drive head arranged at an angle can be less than or equal to 0.15°, so that the estimated width variation after 10 years can be accommodated by adjusting the angle of the drive head.

When the absolute value of the estimated width variation after 10 years exceeds 500 ppm (when the absolute value of the width variation exceeds 500 ppm), there is a possibility that the movement angle of the drive head becomes excessively large in a case where all factors other than creep deformation that causes the width variation (for example, temperature and humidity variations) are taken into account. That is, when an attempt is made to accommodate the width variation after 10 years caused by creep deformation and the other factors (for example, temperature and humidity variations) by adjusting the angle of the drive head, there is a possibility that the movement angle of the drive head becomes too large. If the movement angle becomes too large, the followability of the drive head deteriorates, and there is a possibility that it is not possible to sufficiently accommodate the width variation of the magnetic tape.

Furthermore, as shown in Table 1, comparing the results of Examples 1 to 4 with the results of Comparative Examples 1 to 4, when the average width variation ΔA is 170 ppm or less, the absolute value of the estimated width variation after 10 years is 500 ppm or less. Therefore, it is considered that the movement angle of the drive head arranged at an angle can be set to 0.15° or less, and the estimated width variation after 10 years can be accommodated by adjusting the angle of the drive head.

Although the embodiments and examples of the present technology have been specifically described above, the present technology is not limited to the above-described embodiments and examples, and various modifications based on the technical idea of the present technology are possible.

For example, the configurations, the methods, the processes, the shapes, the materials, the numerical values, and the like described in the embodiments and examples described above are merely examples, and different configurations, methods, processes, shapes, materials, numerical values, and the like may be used as needed. The chemical formulas of compounds and the like are representative ones, and are not limited to the valences and the like described herein as long as the compounds with the same general names are employed.

Furthermore, the configurations, methods, processes, shapes, materials, numerical values, and the like of the above-described embodiments and examples can be combined with each other without departing from the gist of the present technology.

Furthermore, in the present specification, a numerical range indicated by using “to” indicates a range including numerical values described before and after “to” as the minimum value and the maximum value, respectively. In the numerical ranges described in stages in the present specification, the upper limit value or the lower limit value of a numerical range of a certain stage may be replaced with the upper limit value or the lower limit value of a numerical range of another stage. The materials exemplified in the present specification can be used alone or in combination of two or more unless otherwise specified.

### REFERENCE SIGNS LIST

10 Magnetic recording medium
11 Base layer
12 Underlayer
13 Magnetic layer
14 Back layer

What is claimed is:

1. A magnetic recording medium comprising:
a magnetic layer; an underlayer; and a base layer in this order, wherein
the underlayer contains a chlorine-containing binder,
a portion where a chlorine count is greater than or equal to a following threshold in the underlayer has a thickness of 130 nm or less, and
an average width variation of the magnetic recording medium before and after the magnetic recording medium is left for 40 hours in an environment with a temperature of 50° C. and a relative humidity of 40% RH with a tension of 0.55 N applied in a longitudinal direction is less than or equal to 170 ppm.
$$[ Threshold ] = [ a verage chlorine count in the underlayer ] + 6 \times [ s tandard deviation obtained in calculating the average chlorine count ] .$$

2. The magnetic recording medium according to claim 1, wherein the portion greater than or equal to the threshold in the underlayer is located adjacent to the base layer.

3. The magnetic recording medium according to claim 1, wherein the portion greater than or equal to the threshold in the underlayer is located within 200 nm of an interface between the underlayer and the base layer.

4. The magnetic recording medium according to claim 1, wherein the portion greater than or equal to the threshold in the underlayer is located within 130 nm of an interface between the underlayer and the base layer.

5. The magnetic recording medium according to claim 1, wherein the magnetic layer and the underlayer have a combined thickness of 1000 nm or less.

6. The magnetic recording medium according to claim 1, wherein the magnetic layer has a thickness of 80 nm or less.

7. The magnetic recording medium according to claim 1, wherein the underlayer contains non-magnetic powder.

8. The magnetic recording medium according to claim 1, wherein the magnetic recording medium has an average thickness t_{T} of 5.5 μm or less.

9. The magnetic recording medium according to claim 1, wherein the magnetic layer contains magnetic powder.

10. The magnetic recording medium according to claim 9, wherein the magnetic powder contains hexagonal ferrite, ε-iron oxide, or Co-containing spinel ferrite.

11. A magnetic recording medium comprising:
a magnetic layer; an underlayer; and a base layer in this order, wherein
the underlayer contains a chlorine-containing binder,
a portion where a chlorine count is greater than or equal to a following threshold in the underlayer has a thickness of 12% or less of a thickness of the underlayer, and
an average width variation of the magnetic recording medium before and after the magnetic recording medium is left for 40 hours in an environment with a temperature of 50° C. and a relative humidity of 40% RH with a tension of 0.55 N applied in a longitudinal direction is less than or equal to 170 ppm.
$$[ Threshold ] = [ a verage chlorine count in the underlayer ] + 6 \times [ s tandard deviation obtained in calculating the average chlorine count ] .$$

12. The magnetic recording medium according to claim 1, wherein the average width variation is less than or equal to 140 ppm.

13. The magnetic recording medium according to claim 1, wherein the base layer contains polyesters.

14. The magnetic recording medium according to claim 13, wherein the polyesters includes at least one selected from the group consisting of polyethylene terephthalate and polyethylene naphthalate.

15. The magnetic recording medium according to claim 1, wherein the base layer has an average thickness of 4.4 μm or less.

16. The magnetic recording medium according to claim 1, wherein the magnetic layer has a squareness ratio of 35% or less in the longitudinal direction of the magnetic recording medium.

17. The magnetic recording medium according to claim 1, wherein the magnetic layer has five or more servo bands.

18. The magnetic recording medium according to claim 1, wherein the magnetic layer is configured to allow formation of a plurality of data tracks, and each of the data tracks has a width of 1200 nm or less.

19. A magnetic recording cartridge comprising the magnetic recording medium according to claim 1, the magnetic recording medium being wound around a reel and contained in a case.
